(19) United States
(12) Patent Application Publication
(10) Pub. No.: US 2006/0235670 A1
(43) Pub. Date: Oct. 19, 2006

(54) Method and system for selecting therapeutic targets using molecular interaction dynamic networks

(75) Inventor: Todor Vujasinovic, Paris (FR)

Correspondence Address: BIRCH STEWART KOLASCH & BIRCH, PO BOX 747, FALLS CHURCH, VA, 22040-0747, US

(73) Assignee: HELIOS BIOSCIENCES, Creteil (FR)

(21) Appl. No.: 11/342,707

(22) Filed: Jan. 31, 2006

Related U.S. Application Data
(63) Continuation of application No. PCT/FR04/02064, filed on Jul. 30, 2004.

(30) Foreign Application Priority Data
Aug. 1, 2003 (FR) 0309557

(51) Int. Cl. G06G 7/48; G06G 7/58

(52) U.S. Cl. 703/11

(57) ABSTRACT

The present invention concerns the field of integrative analysis of molecular interactions in a biological system. In particular, it pertains to a method for obtaining a dynamic model of a molecular interaction network in a biological system that allows analysis of said interactions when a stimulus is applied to the dynamic model, with a view in particular of hierarchizing biological molecules or selecting therapeutic targets in respect of a given biological problem, in particular to define a therapeutic action to be applied to said molecules. The invention also pertains to an informatics system for producing a dynamic model of a molecular interaction network in a biological system, and analyzing said molecular interactions when a stimulus is applied to the dynamic model, the informatics system comprising at least one central data processing unit connected to at least one quantitative experimental database.

The present invention relates to the field of integrative analysis of molecular interactions in a biological system. In particular, it relates to methods for obtaining and analyzing biological molecular interaction networks which, starting from the production of experimental data, can identify and describe the finctions of these interactions both (i) between molecules interacting in pairs, (ii) as resultants of interactions being exerted on a given molecule, and (iii) on the level of the entire network of interactions under consideration. More particularly again, this method of analysis can, once the functions of these interactions have been described, predict the consequences over the whole of the molecular interaction network under consideration of activatory or inhibitory actions of the molecules forming said network. It can hence identify potential therapeutic targets and allow the mechanisms of the actions of xenobiotics to be understood.

One of the major preoccupations of biotechnological and pharmaceutical enterprises is the development of novel drugs which are more effective against the majority of diseases, in particular (but not solely) chronic diseases of multi-factorial origin which cause most of the morbidity and mortality in developed countries: cardio-vascular diseases, cancer, psychiatric diseases and neurological diseases, immuno-allergic diseases, endocrine diseases (diabetes, etc), etc. Current treatments for the majority of such diseases have purely symptomatic effects, which are often insufficient even from the purely symptomatic viewpoint, and have no notable action on the progress of such diseases, and often have major undesirable effects. Further, there is currently no genuinely effective treatment for certain syndromes or diseases which represent major health problems, such as neurodegenerative disease. The principal reason for this situation is the current lack of understanding of the physio-pathological mechanisms which result in the pathological conditions concerned, and in particular a lack of understanding of molecular physio-pathological mechanisms.

The majority of existing drugs were developed using a “pharmacological” (henceforth conventional) technique consisting, in outline, of testing and selecting potential therapeutic molecules (a large number of them being obtained by artificial organic synthesis methods, in particular of the combinatorial chemistry type) on cellular and/or animal physio-pathological models. Such models are considered to reproduce all or some of the symptoms or modifications observed in the pathology. However, an understanding of physiological mechanisms, and in particular molecular mechanisms, used in such models is not required in order to use them. That approach, based on large scale screening of small synthesized molecules, thus has the advantage of depending relatively little on a deep comprehension of the physio-pathological processes involved in the diseases concerned. However, it has a major limitation which has become progressively more apparent over the past two decades: it is dependent on the physio-pathological models used, and we are now running out of generic models. This is linked to the fact that the majority of such models were developed using a reciprocal interdependence logic between the observation of the effects of therapeutic molecules and progressive analysis of the pharmacological (molecular) actions of such molecules. Thus, those models are primarily dependent on initially observed pharmacological effects, and can only allow the development of drugs with effects close to those already in existence. That approach has progressively led to the high costs linked to a high failure rate in the development of novel drugs.

The development of animal models by transgenesis has not, up to now, solved this problem of the exhaustion of physio-pathological models: it appears firstly that genes modified by transgenesis are not generally themselves therapeutic targets, and secondly, in order to be used effectively, screening small synthesized molecules necessitates, orientation of the synthesis either by analogy with existing molecules (which usually does not lead to major therapeutic innovation) or by prior knowledge of the target molecule(s) to which transgenic models do not provide direct access. Further, in the case of knock-out type transgenic animal models, the fact that a possible therapeutic target gene has been eliminated prevents any screening of potentially active pharmacological molecules on that gene or the protein encoded thereby.

For this reason, the approach which is becoming more and more popular for the development of novel pharmaceutical treatments is another approach known as the “physiological” or “comprehensive” approach, which consists of exploring and understanding physio-pathological mechanisms, and in particular molecular physio-pathological mechanisms resulting in the pathology concerned, in order to define molecules of the affected organism, which are the target molecules (or “therapeutic targets”) for chemical treatments. Identifying such target molecules can then, in a second step, allow potential synthesized therapeutic molecules to be screened to identify those which will directly modify the biological activity of said therapeutic targets, or to carry out orientated synthesizes of such therapeutic molecules when the steric structure of the target molecules is known.

Briefly, in this second approach, the emphasis is on comprehending physiological and physio-pathological molecular mechanisms which underlie the disease. This approach is also old, as it started with organic chemistry techniques and methods for identifying and analyzing intracellular molecules (for example: the description of the Krebs cycle) and was developed by integrating molecular biological techniques and methods over about 15-20 years (nucleic acid sequencing, cloning, transgenesis, etc). Thus, it does not use a cellular model or physio-pathological animal to screen small synthesized molecules in the search for a therapeutic effect, but firstly analyzes the pathological process in those models (or, when possible, directly in man) to determine the cascades of molecular events which result in the pathological state to identify potential therapeutic targets. The step for synthesizing novel therapeutic molecules is thus only carried out in a second step.

This “comprehensive” approach also allowed the development of drugs, but long ago it hit a major hurdle: until the middle of the 1990s, it was extremely difficult to study more than one or two molecules at the same time. As a result, the cascades of molecular events described only included a few tens of molecules in the best cases, while several tens of thousands of different molecules are present in a given eukaryotic cell. This approach thus cannot be used to study pathological processes by integrating the complexity of these methods, particularly as regards diseases with multi-factorial determinism. Finally, its logic tended towards identifying single therapeutic targets which were poorly suited to curing diseases in which action on a single target is not sufficient. In fact, in the majority of these diseases, focusing treatments on limited pharmacological actions is accompanied by a concomitant increase in the number of drugs prescribed to one patient (hence, the majority of cardiovascular diseases, psychiatric diseases etc are currently treated by polytherapy, often with insufficient effects and drug interactions which are difficult to manage and sometimes dangerous). The advances made by this approach are essentially concerned with reducing the side effects of treatments (those having more targeted molecular actions) without in any way being accompanied by a notable improvement in the therapeutic effects (one example is the development of fluoxetin (Prozac(®).

In this context, it was crucial to be able to move from an analysis of pathological processes molecule by molecule to a parallel analysis of the set of molecules involved, which is the only thing that can accommodate the complexity of these pathological processes.

This has been rendered partially possible since the end of the 1990s by two methods in tandem: firstly, the identification of a large portion of the constituent molecules of living organisms such as man and certain animal models (sequencing of whole genomes, identification under way of the set of genes present in said genomes, deduction under way of the corresponding proteins), and secondly, the development of molecular biological techniques which allow a large number of different molecules to be studied in the same tissue. The most significant of these techniques, cited here by way of example, is that of DNA arrays allowing parallel analysis of virtually all of the messenger RNA present in a cell type or a given tissue (Schena et al, 1995, Quantitative monitoring of gene expression patterns with a complementary DNA array, Science 270, 467-470; Lockhort et al, 1996, Expression monitoring by hybridization to high-density oligonucleotide arrays, Nature Biotechnology 14: 1675-1680; Blanchard et al, 1996, Sequence to array: Probing the genome's secrets, Nature Biotechnology 14, 1649; U.S. Pat. No. 5 569 588, published ₂₉th October 1996, Ashby et al, for Methods for Drug Screening). Large scale protein analysis methods were also developed, such as the use of hybrids in yeast, 2D electrophoresis—mass spectrography coupling, etc (McCormack et al, 1997, Direct analysis and identification of proteins in mixtures by LC, MS, MS and database searching at the low-femtomole level, Anal Chem, 69(4), 767-776; Chait, Trawling for proteins in the post-genome era, Nature Biotechnology 14, 1544) or are currently being developed (in particular large scale co-precipitation of proteins on micro-colurns).

However, currently, such technological developments have led to the generation of a huge, ever increasing quantity of biological data, but satisfactory techniques and methods for analysis and exploitation of such data have not been developed. This has led to the development of integrative biological tools to interpret them and select pertinent therapeutic targets from the vast amount of experimental data which has been generated.

Integrative biological processes aim to analyze the role of molecules present in the affected organism accommodating (and thus integrating) in this analysis other molecules with which they interact. Their aim is thus to produce models of cascades (or networks) of molecular interactions in the organism, in particular those involved in pathological processes. In the context of selecting therapeutic targets, such models are aimed at being applied to selecting these targets. More precisely, such an application must be able to predict the consequences of activatory or inhibitory actions of molecules of the network, to identify those which will have a therapeutic effect. It is envisaged that such predictions on the large scale can only be produced in a sufficiently reliable manner if the model can carry out systematic simulations of the effects of the inhibitory or activatory actions of molecules of the cascade.

Currently proposed modeling methods are on the one hand, methods producing static models and on the other hand, methods producing dynamic models.

Modeling methods producing static models consist of constructing static graphs representing cascades of biomolecular interactions from data in the scientific literature (publications in reviews, analysis of molecular expression profiles, sequence data trawling, etc). The resulting graph may be represented in the form of a diagram, usually in two dimensions, the nodes (or vertices) of which are the molecules, and in which these nodes are connected by lines or arrows (or arcs, or edges of the graph) representing the interactions between the molecules. Examples of static graphs are those constructed in various public databases such as the KEGG database (M Kanehisa and S Goto: KEGG: Kyoto Encyclopedia of Genes and Genomes, Nucleic Acids Research 28(1), 27-30, 2000).

This modeling method produces purely qualitative results. It is not sufficient to be able to use quantitative and dynamic simulations to predict the effects of actions on potential therapeutic targets. This limitation is the source of a very high error rate in selecting targets. Further, it is extremely difficult for an expert biologist to coherently analyze a graph of more than a few tens of molecules, and this becomes impossible for graphs with more than a hundred molecules. As a result, the cascades of molecular interactions which are analyzed are very reduced in size compared with actual cascades occurring in living organisms, and thus are highly incomplete, and this method means that targets cannot be sought out in an exhaustive manner. When taken alone, it is thus inadequate in the face of the preoccupations mentioned above.

In methods producing dynamic models, static graphs representing cascades of molecular interactions are used to create dynamic models of such graphs, reproducing as far as possible the dynamic behavior of the biological cascade (or biological pathway) being studied. Methods used until now to produce such models are:

Qualitative Methods:
the Boolean network method;
the generalized logical formalism method;
the formalism method based on rules (rule based or knowledge based).

Probabilistic Methods:
the stochastic equation method;
the Bayes network method.

Differential Equations Methods:
the ordinary non linear differential equations method;
the piecewise linear differential equations method;
the partial differential equations and spatial distribution models method.

Mixed Methods:

the qualitative differential equations method. The principles underlying these various methods are summarized in Table 1 below.

TABLE 1
Comparison of modeling methods: underlying principles

| | (1) | | | | |
|---|---|---|---|---|---|
| | Integration | | | | |
| | of | | (3) | (4) | (5) |
| | quantitative | (2) | Variables | Continuous | Deterministic |
| Method | data | Formalism | used | functions | model |
| Qualitative | | | | | |
| methods | | | | | |
| Boolean | Partial | On/off | Discretisation | No | No |
| networks | | | of xᵢ | | |
| Generalized | Partial | Discretisation of | Discretisation | No | No |
| logical | | variables | of xᵢ | | |
| formalisms | | | | | |
| Rule-based | No | On/off | Non | No | No |
| formalisms | | | quantitative | | |
| | | | variables | | |
| Probabilistic | | | | | |
| methods | | | | | |
| Stochastic | Yes | Probability of | xᵢ | Yes | No |
| equations | | chemical reaction | | | |
| Bayes | Yes | Probability of | xᵢ | Yes | No |
| networks | | chemical reaction | | | |
| Differential | | | | | |
| equations | | | | | |
| method | | | | | |
| Ordinary | Yes | Synthesis/degradation/ | xᵢ | Yes | Yes |
| non linear | | diffusion | | | |
| differential | | | | | |
| equations | | | | | |
| Linear | Yes | Synthesis/degradation | xᵢ | Yes | Yes |
| differential | | | | | |
| equations | | | | | |
| Partial | Yes | Synthesis/degradation | xᵢ | Yes | Yes |
| differential | | | | | |
| equations | | | | | |
| Mixed | | | | | |
| methods | | | | | |
| Qualitative | Yes | Synthesis/degradation | Discretisation | No | No |
| differential | | and discretisation of | of xᵢ | | |
| equations | | variables | | | |

This table must be read together with the following elements:

(1) Integration of quantitative data: Certain methods are not designed to use and analyze quantitative experimental biological data (Rule-based formalisms), or modify them to a 5 great extent when they impose discretisation of variables (Boolean networks, etc), hence the note “partial” integration. These methods were all initially designed to be free from such data. This limits them as regards reliability and their possibility of application to the systematic search for therapeutic targets in large networks. (2) Formalism: This concerns principles of representation of biological interactions used in the method. On/off: the molecules are either present or absent, with no intermediate state. Discretisation of variables: the number of molecules may take a limited number of finite values; this is a refinement of the preceding formalism, but is a poor representation of biological reality where the number of molecules varies continuously. Probability of chemical reaction: specific to probabilistic methods where network evolution is linked to the estimated probability of individual molecular events. Synthesis/degradation: the effects of interactions are represented as limited to synthesis reactions or degradation of molecules, these representations being those of elementary chemical reactions, in general limited to the law of mass action (elementary expression: if A+B→C, at equilibrium: [C]=k1 [A][B]). Diffusion: the diffusion of molecules in the biological system under study or outside the biological system under study (for example a cell) is also accommodated, as equivalent to a synthesis or a degradation (respectively) within the system.

(3) Variables used: All of the existing methods define the variables as being the amount or concentration or the total quantity of molecules, denoted xi here, for the molecule i, and not the proportion of its variation with respect to a standard state x*₀.

(4) Continuous functions: For a continuous function, the variables change continuously (as is the case in real biological systems) and not discretely.

(5) Deterministic model: Once the model is computed, the network cannot move from one state to another except via a single path (unique sequence of intermediate states). The fact that a model is deterministic allows the quantity of computations during simulations to increase linearly. In contrast, in non deterministic models, the quantity of computations required during simulations tends to increase exponentially with the size of the network, possibly resulting in large networks being impossible to operate.

Because of their characteristics summarized in Table 1, these various methods necessitate pre-requisites and can be used in applications as summarized in Table 2 below:

TABLE 2
Comparison of prior art modeling methods: pre-requisites and possible
applications

| | Pre-requisite | | | | |
|---|---|---|---|---|---|
| | (1) | | Applications | | |
| | Required | | | | (5) |
| | level of | | | (4) | Use for |
| | functional | (2) | (3) | Applicable | systematic |
| | knowledge | Growth in amount of | Maximum | to networks | identification |
| | of | computation required | size of | of 1000 to | of |
| | biological | as function of | network | 100000 | therapeutic |
| Method | network | network size | employed | molecules | targets |
| Qualitative | | | | | |
| methods | | | | | |
| Boolean | C | C | <100 | No | No |
| networks | | | molecules | | |
| Generalized | C | C | <100 | No | No |
| logical | | | molecules | | |
| formalisms | | | | | |
| Rule-based | C | B | <100 | No | No |
| formalisms | | | molecules | | |
| Probabilistic | | | | | |
| methods | | | | | |
| Stochastic | B | C | <100 | No | No |
| equations | | | molecules | | |
| Bayes | A | C | <100 | No | No |
| networks | | | molecules | | |
| Differential | | | | | |
| equations | | | | | |
| method | | | | | |
| Ordinary | C | B | <100 | No | No |
| non linear | | | molecules | | |
| differential | | | | | |
| equations | | | | | |
| Linear | C | A | <100 | No | No |
| differential | | | molecules | | |
| equations | | | | | |
| Partial | C | C | <50 | No | No |
| differential | | | molecules | | |
| equations | | | | | |
| Mixed | | | | | |
| methods | | | | | |
| Qualitative | C | C | <100 | No | No |
| differential | | | molecules | | |
| equations | | | | | |

Table 2 should be read in combination with the following elements:

(1) Funtional knowledge of biological network

Level A

Knowledge of existence per se of molecular interactions, and at least in part their orientations and in part the effects of interactions (activatory/inhibitory or synthesis/degradation). Only level A knowledge is currently widely available. As a result, only one method requiring only a knowledge at level A may be applied to extended networks.

Level B

Level A with all orientations of interactions and all effects of interactions.

Level C

Extended functional knowledge of network, i.e. level B plus other data such as: rate constants of chemical reations, description of threshold effects, description of allosteric effects, etc. Currently, regardless of the living organism under consideration, level C knowledge is not available for the majority of molecules of molecular interaction networks. A detailed functional description of the biological network is necessary to implementing the method when level C knowledge is required. Because of the lack of availability of level C knowledge for the majority of molecules, any method requiring this type of knowledge for its operation may only be applied to very small well studied networks (maximum of a few tens of molecules) and is de facto unsuitable for application to large networks (of more than 100 to 150 molecules).

(2) Computational power

Level A

Linear growth with the network size (as a number of molecules) of the quantity of computation required. This corresponds to the possibility of carrying it out on a standard power server (publicly available). Methods using computations the quanity of which grows linearly with network size may be applied to extended networks (provided that there are no other limits to this application).

Level B

Intermediate computation growth between cases A and C. Methods using computations the quantity of which increases in a manner which is intermediate between A and C are theoretically applicable to extended networks, but at a high or very high cost (and provided that there are no other limits to this application).

Level C

Exponential growth with network size (as a number of molecules) of the quantity of computation required. Any method using computations the quantity of which grows exponentially with network size requires a very large computational power. As an example, certain applications of Bayes networks necessitate about 30 minutes computation time on a server equipped with a 1.2 gigahertz method or for an 8 network: for a 32 molecule network, the computation time on the same computer would in this case be more than one and a half years. In practice, even with the most powerful existing computers, methods exhibiting exponential growth in the computation time are not applicable to large or very large networks (several thousand to several tens of thousands of molecules or more; certain thereof are not even applicable to networks of a few hundred molecules).

(3) Maximum size of network employed: thisis the maximum size of networks on which the method has currently been used successfully.

(4) Applicability to networks of 1000 to 100000 molecules: this application possibility is linked (i) to the intrinsic principles of the method (for example Bayes networks, which are linear networks and thus not suited to large biological networks comprising feedback loops which cannot be applied to large networks), (ii) at level A, B or C of functional knowledge of the required biological network, the necessity of level C knowledge rendering the method unsuitable for large networks, and the necessity of level B knowledge rendering it very difficult to apply to such networks, and (iii) to the computation power required (levels A, B or C), an increase in the computation time for level C being de facto incompatible with use in large networks, and level B growth rendering the method very difficult to apply to such networks.

(5) Use for systematic identification of therapeutic targets: this is the effective use of the method in a systematic search for targets within the network. None of the current existing methods have been able to be used for this application.

All of these methods are of low reliability as regards their predictions once the network exceeds about fifty molecules. Thus, they are poorly suited to producing proper dynamic models of molecular interaction networks of living organisms whichhave the following characteristics:
a large number of different molecular types are involved: from a few hundred to a few tens or hundreds of thousands;
cascades involving feedback loops with circuit redundancy;
the propagation rates of molecular activations/inhibitions in the networks are different depending on the circuits (i.e. the propagation pathways within the network);
extremely complex networks which are difficult to model.

In order to be genuinely applicable to using genomic, transcriptomic and proteomic data produced on a large scale, with the aim of systematically identifying therapeutic targets, the dynamic models constructed must allow molecular interaction cascades as described above to be modeled.

The fact of producing a model of the dynamics of a biological molecular interaction network is not in itself sufficient to be able to select novel therapeutic targets in a reliable and rational manner. To this day, all of the methods which have been developed have only been able to be applied to a simple description of molecular methods in small biological netowrks (at most a few tens of molecules) and to a few simulations aimed at reproducing known modifications of the network. None have been applied to the systematic selection of therapeutic targets from the ensemble of the molecules of the network, including small networks, and especially in large networks. In fact, such an application requires the use of a suitable simulation strategy, as described in the invention, which has not been described with existing methods (and for some them, it is not applicable even to small networks).

This application, namely the selection of therapeutic targets from dynamic models of large scale molecular interaction networks effectively occuring in pathological processes, has thus not been achieved by current know methods.

The present invention aims to provide a method for producing dynamic models of molecular interaction networks in a biological system, which renders this type of application possible.

A certain number of terms will now be described to aid clarity of the text.

The term molecular interaction between two (or more) biological molecules as used here means an interaction where one (or more) molecule activates or inhibits another molecule (or more molecules). The case in which a molecule of a given type interacts with another molecule of the same type is only a particular case of this general definition. Two molecules are defined here as being of the same type if they have the same chemical formula.

Activation (or, respectively, inhibition) is defined here as the increase (or, respectively, reduction) in the biological activity of the molecules(s) on which the interaction under consideration is exerted. This increase (or, respectively, reduction) in biological activity may correspond either to an increase (or, respectively, reduction in the number of molecules of a given type present in the biological system under analysis, each retaining the same biological activity (or function), or an increase (or, respectively, reduction) in the activity of molecules of a given type, their number remaining constant, or a combination of these two mechanisms, or the resultant of these two mechanisms. The activation (or, respectively, reduction) may also be the consequence of an increae (or, respectively, reduction) in the number of molecules associated with a reduction (or, respectively, increase) in their biological ativity, if the overall resultant is an overall increase (or an overall reduction) in the activity, and vice versa.

The activation (or, respectively, inhibition) may be non-zero or zero depending on the molecules under consideration and the biological system under consideration. It may vary with time. The fact that certain interactions of the molecular interaction network under consideration correspond to a zero activation (or, respectively inhibition) is only a particular case of the field of the invention.

The biological activity of one (or more) biological molecules under consideration corresponds to any capacity of the molecules(s) under consideration to have a chemical and/or physical interaction with any other molecule of another type (or with another molecule of the same type). This chemical and/or physical interaction may or may not result in acquisition (or loss) by one of the interacting molecules of capacity to have a chemical and/or physical interaction with any other molecule of another type (or with another molecule of the same type). The chemical interactions are any interaction between two (or more) molecules causing a chemical reaction (which may be represented by a modification in the chemical formula of a molecule, or the systhesis or degradation of a molecule). Physical interactions are any interaction between two (or more) molecules causing the formation of a stable or unstable complex between these molecules. Non-exclusive examples of biological activities of molecules and corresponding molecular interactions are: the activation activity for transcription of a given gene (molar interaction: protein (transcription factor)—DNA), the processing activity of a chemical reaction (molecular interaction: protein (enzyme)—molecule (substrate), allowing the transformation of the molecule-substrate into molecule-chemical reaction product), the activity of formation of a molecular protein complex itself having its own biological activity (molecular interaction: protein (complex sub-unit)—protein (complex sub-unit)), etc.

The term biological molecule as used here means any molecule, whatever its complexity, present in the biological system under consideration.

Ther term biological system as used here means any living organism, whether prokaryotic or eukaryotic, monocellular or pluricellular, and whether that biological system corresponds to the organism in its entirety or to a part of that organism. Examples which may be cited are:

Whole organisms:
a cell (prokaryotic or eukaryotic) in its entirety:
an assembly of cells interacting directly or indirectly between themselves or not interacting between themselves;
   all of the cells in culture in a Petri dish;
   all of the cells forming an organ or part of that organ; for example the amygdalian region of a mamalian brain;
a multicellular living being;
the various examples plus their environment.

Part of an organism:
an organelle of a cell, such as a mitochrondrium;
a set of molecules participating in a given biological function, such a set of molecules participating in cell respiration, or a set of molecules participating in cell death, whether athat set of molecules is constituted by all molecules participating in said biological function or only part thereof.

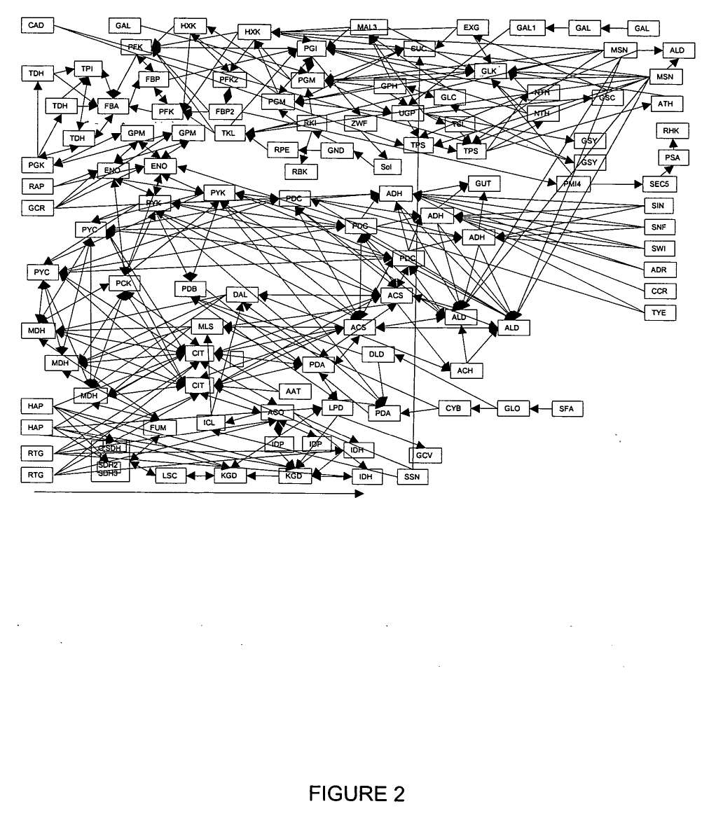

The set of molecules forming the molecular interaction network as described in the form of a static graph in FIG. 2 is an example of a biological system.

Many static graphs are, for example, available in the KEGG public database (M Kanehisa and S Goto: KEGG: Kyoto Encyclopedia of Genes and Genomes, Nucleic Acids Research 28(1), 27-30,2000)

Any biological system is constituted by molecules, said molecules interacting with each other in a more or less stable and variable manner over time and environmental effects of this system on the biological system itself. As an example, apoptosis (the mechanism of cel death) is the resultant of the interaction of multiple molecules (hormones, proteins, second messengers, etc), some of which have physical or chemical interactions which are more or less stable over time.

The term molecular interaction network as used here means the set of molecules analyzed by the method of the invention associated with the set (or part of this set) of their possible biological interactions. The network may comprise all molecules of the biological system concerned, or only part of these molecules. For greater clarity, the network may be represented visually in the form of a graph (an example is given in the description below). This type of visual representation is the origin of the use of the term “network”. Such a representation is not, however, a pre-requisite of the invention. The network may also be represented by a table (or matrix) wherein, for example, each row corresponds to one of the molecules of the network and the columns correpond to characteristics of the possible biological interactions of these molecules (or a portion of these interactions or their characteristics).

A graph as used here is a representation of a molecular interaction network in the form of a graph the vertices (or nodes) of which correspond to molecules of the molecular interaction network represented and the edges (or arcs) of which connecting the vertices correspond to molecular interactions of the molecular interaction network shown. In the remainder of the text, reference will often be made to such a graph, although its physical production is not obligatory. Given that it is only a symbolic representation of a network, a reference to a graph actually corresponds to a reference to a network.

The term variable associated with a vertex of a graph as used here means a quantitative variable in the mathematical sense of the term, which may take numerical values, wherein the value at a given graph state represents the state of the corresponding vertex as regards a quantity with respect to a molecule of the biological system under consideration. Depending on the case, this quantity may be a level of expression of a gene expressed in a biological system (for example the abundance of messenger RNA, measurable by the DNA array technique), the abundance of a protein, an activity level of a protein, the abundance of a metabolite, etc, provided that the quantity under consideration can be measured experimentally by a direct or indirect means.

The graph state is a graph for which a numerical value is given for each variable (associated with each vertex). The case in which a non zero numerical value is only given for part of the variables (and associated with the corresponding vertices), another part of the variables (associated with other vertices) being zero, is just a particular case of the graph state. A given graph state is a representation of a real or simulated state of the corresponding molecular interaction network, and by extension a representation of a real or simulated state of the corresponding biological system. As an example, in certain representations of a molecular interaction network in the form of a graph, the fact that a zero value is given to a variable associated with a vertex of the graph may correspond to a representation of the situation in which the molecule corresponding to the vertex is not present in the interaction network (which means that it is not present in the biological system), or a situation in which its biological activity is zero. The fact that a zero value is given to a certain number of variables thus corresponds to the assumption that at a given time, they do not interact with the remainder of the network, but their value may become non zero at another time following modification of the network state. The fact of giving a zero value to a variable thus does not necessarily exclude the corresponding vertex from the network.

In certain particular cases, it is possible to give a constant zero value to a certain number of variables, which then corresponds to excluding the corresponding vertices from the network and thus operating on a sub-network. To work on a sub-network, however, it is preferable to make a conservative hypothesis, i.e. to consider the value of the excluded variables as a constraint, which allows a non-modification to the structure of the network.

The invention also concerns an informatics system for producing a dynamic model of a molecular interaction network in a biological system, and analyzing said molecular interactions when a stimulus is applied to the dynamic model, comprising at least one central data processing unit connected to at least one quantitative experimental database, the informatics system comprising:

A) a module for constructing a static graph the vertices of which represent biological molecules and the arcs of which represent physico-chemical interactions existing between said molecules, each vertex being associated with an experimentally measured quantitative variable and each arc of the graph being associated with a mathematical relationship; and

B) a learning module for computing the parameters of each relationship from quantitative experimental data concerning the vertices of the graph, employing gradient descent learning techniques used for network parameterization.

The informatics system of the invention may also comprise:

C) a simulation module for carrying out a plurality of iterative simulation procedures consisting of imposing a stimulus on an experimentally measured graph state and selected as the “state to be modified”, the stimulus modifying the value of one or more quantitative variables associated with the vertices of the graph, constituting thereby a starting state for the simulation from which a propagation computation is carried out within the graph, to obtain a “final graph state”; and

D) an iteration module for modification of the stimulus.

The informatics system of the invention may also comprise:

E) a module for computing the proximity between the “final graph state” and the “state to be modified” or between the “final graph state” and a desired state, and for hierarchization of the vertices and stimuli imposed on the graph vertices, the hierarchized vertices corresponding to classified therapeutic targets.

The informatics system of the invention forms a tool for analyzing biological experimental data and in particular a tool for hierarchizing biological molecules as regards a biological problem.

Inter alia, the present invention aims to provide technical solutions to the difficulties discussed above, in particular in supplying the possibility of constructing dynamic models which can be used for molecular interaction networks of more than 100, more than 200 molecules or even more in the applications described.

In a first aspect, the invention is a method for producing a dynamic model of a molecular interaction network in a biological system, allowing analysis of said interactions and more precisely allowing analysis of said network of interactions when a stimulus is applied to the dynamic model, in order to hierarchize biological molecules or select therapeutic targets in respect of a given biological problem, in particular to define a therapeutic action to be applied to said molecules, said method being implemented by an informatics system and comprising the following steps:

A) from a static graph the vertices of which represent biological molecules and the arcs of which represent physico-chemical interactions existing between said molecules, associating an experimentally measured quantitative variable Xᵢ with each vertex i, and a mathematical relationship with each arc of the graph, each of said relationships having the following characteristics:
it comprises an inertial term (i) which tends towards a finite limit;
it comprises a term (ii) tending to cause the variables Xᵢ to return their initial state, of opposite sign to the inertial term (i), and for which the variation as a function of time increases in absolute value more slowly than the variation as a function of time of the inertial term (i);
it comprises a weighting factor wij which can take account of the combination of effects which may be exerted on each vertex of the graph;

B) computing the parameters of each relationship from quantitative experimental data concerning the vertices of the graph, by carrying out gradient descent learning techniques used for network parameterization.

The real sign of term (ii) is determined by the result of the computation of its parameter(s). The sign of this term (ii) is opposite to term (i) once the parameters have been computed, but this is not obligatory in its mathematical formulation, which does not a priori set the sign of the associated parameter(s).

In a preferred implementation of the above method, each quantitative variable associated with a vertex represents the relative variation in the quantity of the molecule corresponding to said vertex with respect to a standard state of the biological system. As mentioned above, the “quantity of molecule associated with a vertex” may concern any aspect of that molecule which is directly or otherwise measurable, whether it be concentration, activity, degree of expression, etc. In this variation in which Xᵢ are ratios at a standard state, said standard state is preferably a stable state of the biological system, in which the quantity of each molecule associated with a vertex of the graph is experimentally measurable. As will be reiterated below, in the description of a practical implementation, this standard state may correspond to a given physiological state (for example healthy or sick) which can actually be observed, or to an artificial state of the system, for example the state of a pool of several biological samples taken under different experimental conditions.

The relative variations in the quantity of molecules in the network are thus represented in the form of variables dependant on relative variations in the quantity of molecules interacting together (i.e. interacting together and upstream in the network in terms of propagation of activations/inhibitions). The definition of the variables corresponds directly to available experimental measurements: in the majority of molecular biological technologies (including screening of messenger RNA expression), the absolute quantity of molecules present in the biological system of interest is not measured (and not measurable); only the proportion of their variation with respect to a reference state can be measured.

Let n molecules j(1→n), represented by the n vertices j (1→n) of the network, interact on the molecule i, represented by the vertex i of the network. In the methods for producing a dynamic model of a molecular interaction network in a biological system of the invention, the inertial term (i) and return to the initial state term (ii) allow a computation of the values of Xᵢ and variations in values of Xᵢ through time as a function of the values of Xj(1→n) and variations in values of Xj(1→n) through time.

The expression “inertial term” means:
a resistance to change, in particular initial; and
a delay in arriving at the maximum variation; which can accommodate the complexities of propagations in the network.

In particular, the inertial term (i) is aimed at allowing a resistance of the variables to change to be integrated with a temporal offset between the modifications in the variables upstream and downstream in the network. In particular, it introduces:
time factor integration;
accommodation of differences in the propagation rates in the network as a function of sub-circuits;
accommodation of time delays consecutive upon the influences of feedback loops on propagation in the network; and
it allows the kinetics of the molecular interactions in the network to be computed directly from experimental data, without prior knowledge of the rate constants of said kinetics, and without a priori acting on other possible parameters.

This inertial term (i) tends towards a finite limit, which avoids major divergences during simulations (improved reliability): this avoids the risk of divergence (or “explosion”) of the values of the variables linked to iterative propagations in feedback loops or during simulations over long time periods. The fact of being able, by avoiding such divergences, to obtain satisfactory divergences during simulations over long time periods (which are in agreement, for example, with the periods for pathological processes), is an important characteristic of the invention.

The formulation of this inertial term is preferably of low constraint, and means that many forms of relationships can be accommodated. To this end, it may advantageously be expressed it in the form of a mathematical relationship having one or more inflections, which allows the constraints imposed on models to be limited and allows reliable modeling to be carried out in situations in which the form of the kinetics is not known a priori, which is the norm as soon as a large network (more than a hundred molecules is modeled. Examples of such mathematical sub-relationships which may be used are sigmoid relationships, oscillation relationships and, in general, any mathematical function which tends to one or more finite limit(s) and which can be inflected.

Term (ii) tending to cause the variables to return to their initial state (or prior equilibrium) can accommodate homeostatic phenomena and the existence of equilibrium states in the network, while significantly reducing the risks of divergence during simulations (improvement of reliability). Once the parameters for the mathematical relationships have been computed, it has an opposite real sign to the inertial term (i), and its variation through time increases in absolute terms more slowly (i.e. later) than the variation as a function of time of the inertial term (i).

With the term (i), Xᵢ and the variations in Xᵢ depend on Xj(1→n) and variations in Xj(1→n). The term (i), which causes Xᵢ to tend towards a finite value, is thus expressed as a function of Xj(1→n).

The term (ii) is expressed as a function of Xᵢ (and not of Xj(1→n)). The value of this term can thus only change if the value of Xᵢ changes, this latter changing if the values of Xj((1→n)) change.

Any initial variation in the effect of term (ii) on the computed value of Xᵢ may thus be considered to be consecutive to a prior variation in the effect of term (i) on the computed value of Xᵢ. This is of particular application if it is assumed that a stable state of the network exists; in the stable state, terms (i) and (ii) equilibrate, such that Xᵢ remains constant; from this state, any variation in Xᵢ is consecutive upon a situation in which the effect of term (i) on the variation in Xᵢ is greater in absolute terms than the effect of term (ii) on the variation in Xᵢ.

In fact, once the parameters of terms (i) and (ii) have been computed, the computed term (ii) has the opposite sign to the computed term (i) and, during computation of the values of Xᵢ, tends to reduce the effect of term (i) on variations in the values of Xᵢ.

As a result, Xᵢ only exhibits a variation if, at a given time at least, the variation in Xᵢ with time computed by the term (ii) is less in absolute terms than the variation in Xᵢ in the next time period computed by the term (i).

In other words, Xᵢ can only exhibit a variation starting from a stable state if, over at least a given period of time, the variation in the computed value of term (ii) is less in absolute terms than the variation in the computed value of term (i).

This characteristic is inherent in the fact that term (i) is expressed as a function of Xj(1→n) while term (ii) is expressed as a function of Xᵢ.

Starting from a stable state, the variation in term (ii) is initially less in absolute terms than the variation in term (i).

During an evolution in the value of Xᵢ through time, the effect of term (ii) on the variation in Xᵢ may or may not become greater than the effect of term (i) on the variation in Xᵢ. If this is the case, Xᵢ will tend to return to its initial value.

Depending on the computed values of the parameters for terms (i) and (ii), values of Xj(1→n) and values of Xᵢ, Xᵢ may possibly return to its initial value, in particular if Xj(1→n) return to their initial value.

If a stimulus is applied in a constant manner to one or more vertices of the network, one may however produce a situation in which the Xj(1→n) do not return to their initial value. In this case, Xᵢ may not return to its initial value. If at a given time the effects of terms (i) and (ii) on the variation of Xᵢ equilibrate again, this results in a new stability for Xᵢ at a value which differs from its initial value.

The method can thus accommodate passage of the network from a given stable state to another stable state, which is different. It can also accommodate an evolution of the network during unstable states.

Finally, since the term (i) causes Xᵢ to tend towards a finite limit, and since term (ii) is expressed as a function of Xᵢ, term (ii) is constrained by Xᵢ: by the resultant of terms (i) and (ii) the computed value of Xᵢ cannot leave a finite range. This characteristic (Xᵢ tending towards a finite limit by term (i) and expression of term (ii) as a function of Xᵢ) can accommodate stable states, and constrain the values of Xᵢ to a finite interval.

The fact that the parameters of relationships associated with the arcs of the graph can be computed directly from experimental data without the need for a prior hypothesis or fixing arbitrary values is rendered possible by the use of low constraint relationships, which do not require prior knowledge of the kinetics of the molecular interactions.

As mentioned above, the methods for producing a dynamic model of a molecular interaction network in a biological system of the invention comprise a second step (step B) in which the parameters of relationships associated with each of the arcs of the graph are computed from quantitative experimental data concerning the vertices of the graph. This computation is preferably carried out by using learning techniques. This then produces a dynamic graph, which is entirely deterministic, consisting of a static graph the edges of which are moreover associated with mathematical relationships the parameters of which have all been defined numerically.

This computation step may be carried out using learning procedures employed to parameterize artificial intelligence networks, for example those developed in informnatics under “neural network” methods (including recurrent neural networks) by “simple” gradient descent (taking as the basis of the computation pairs of data (Xᵢ, Xⱼ) provided by the experimental data independently one from the other), or by gradient descent through time (in which these pairs are not considered to be independent). The data pairs (Xᵢ, Xⱼ) provided by the experimental data are defined as follows: let i be a molecule of a network, represented by the subscript i, and let j be any molecule of the network interacting on i, represented by the vertex j. Xᵢ and Xj are variables associated with vertices i and j respectively. The experimental measurements of values Xᵢ and Xj under given experimental conditions and at given experimental times can produce numerical values for Xᵢ and Xⱼ. A pair of experimental data (Xᵢ, Xⱼ) corresponds to values measured for Xᵢ and Xj at a given experimental state (same time, same experimental condition).

The experimental data used to carry out step B) mentioned above have the following characteristics:

Nature of experimental data

These data are quantitative data concerning the molecules (corresponding to the vertices on the graph) and are, for example, the expression levels of genes expressed in the biological system (by measuring the abundance of RNA messenger, for example using the DNA array technique) and/or abundance levels of proteins and/or activity levels of proteins and/or abundance levels of metabolites. As set out above, these data can be expressed in the form of a proportion of the variation of a quantity with respect to a reference situation (standard state).

Compilation of static network data (or static graph) data

identification of j→i interactions and experimental data (measures of values of variables X_{I}). These data may be extracted from the scientific literature in the broad sense, including public or private biological databases (such as the “TRANSFAC” database from the “German Research Centre for Biotechnology” (GBF) accessible via the internet at http://transfac.gbfde/ (Wingender et al, 2001: The TRANSFAC system on gene expression regulation, Nucleic Acids Research, 29 (1), 281-283), or the database “BIOMOLECULAR INTERACTION NETWORK DATABASE” (BIND) at Toronto University, accessible via the internet at http:H/www.bind.ca (Bader et al, 2003, BIND: the biomolecular interaction network database, Nucleic Acids Research 31, 248-250), or the KEGG database (M Kanehisa and S Goto: KEGG: Kyoto Encyclopedia of Genes and Genomes, Nucleic Acids Research 28(1), 27-30, 2000), or be generated by dedicated molecular biological experiments, in particular using large scale screening techniques. Depending on the biological system of interest, molecules forming the molecular interaction network, the biological scientific problem (study of a disease model, study of toxicity of a product, study of a development process, etc), suitable or available experimental paradigms (cell cultures, tissue study, etc), the skilled person will define the type of experimental data of interest. Examples of types of data which can be used as a function of the applications of the invention are given below in the description of the simulation method.

The skilled person will thus use the compilation method or methods which are most suitable to him for carrying out this step, which will be involved upstream of the analysis method constituting the present invention.

Recording experimental data

These experimental data are advantageously recorded in a database of many database systems existing for this purpose and susceptible of being processed and used in a simple manner by any skilled person in the bioinformatics field (commercial databases Oracle, Microsoft SQL Server, FileMaker, free access databases: postgreSQL). These data may also be recorded in the form of a table or spreadsheet.

Indexation of experimental data

These experimental data may be automatically indexed in a graph. The role of this indexing is to connect each experimental datum to the corresponding biological object on the graph (vertex of graph, or edge of graph for data pairs (Xᵢ, Xⱼ) to be able to use these two types of information (experimental data and graph) jointly during operation of the parameter computation system.

Many commercial or free database systems can be used to create this indexing without particular technical difficulty for the skilled person in the field of biology or bioinformatics field (commercial databases Oracle, Microsoft SQL Server, FileMaker, free access databases: postgreSQL). Alternatively, if the data concerning the graph and the experimental results have been recorded in the form of tables or spreadsheets, or a table or common spreadsheet, these data being de facto linked in this case, this indexation step may not be necessary per se.

Form of experimental data

In a preferred implementation, the experimental data for the values of pairs (Xᵢ, Xⱼ) are in the form of expression kinetics. The term “expression kinetics” as used here means a set of series of experimental data sequenced in time, each series of data corresponding to a set of values of pairs (Xᵢ, Xⱼ) measured experimentally at a given time. Each series of data may concern either the set of graph vertices, or simply a sub-set of these vertices. The different times correspond to successive times during observation of a biological process employing the biological system modeled by the graph, whether this method is natural or artificially induced in the laboratory. Such kinetics preferably comprise at least three successive times and, to improve the quality of the computation of the parameters, more than three times.

A plurality of independent kinetics corresponding to different biological processes (i.e. using different sub-sets of the same overall network; said sub-sets may or may not have common portions), may be used simultaneously. This may improve the quality of the parameters computation and thus the quality of the simulations.

As soon as at least one express kinetic is available, it is also possible to simultaneously use experimental data regarding the values of pairs (Xᵢ, Xⱼ) obtained by independent experiments (without describing the kinetics of the evolution of the biological system being studied through time).

The method for computation of the parameters of relationships in step B) of the methods of the invention preferably accommodates the following principles:

Experimental measurement of a stable state of the biological system

The graph is considered to be in a stable reference state at a given time, this stable state being experimentally measurable. The stable reference state in question corresponds to an existing and measurable state of the biological system being studied, which may be considered to be stable through time compared with the modeled biological process. While a biological system is usually being modified because of its interactions with the environment and its own biological rhythms, because of the existence of homeostatic methods, it is possible to define states in which said modifications are at a maximum “oscillating” about homeostatic states, and a priori of small amplitude. In this state, the modeled method is not itself in the course of significant evolution.

This state must not be confused with the standard state. The standard state, which is arbitrarily defined by the biologist, serves to carry out experimental quantitative measurements. The stable reference state corresponds to a real state of a modeled system (i.e. not artificial) and serves as a reference for computation of the parameters of the model. It is considered to be a state of the system in which the processes of activation and inhibition within the network are equilibrated, or have small oscillations about a theoretical equilibrium state. It represents the state towards which the system generally tends to return during simulations. It may be the same or different from the standard state.

The stable reference state is directly experimentally measurable provided that the biological problem being studied can define a reference state of the biological system.

As an example, a cell culture the number of cells of which has reached a plateau (absence of cell divisions) and which is in a stable culture medium, before inducing any stimulus, or a healthy adult animal before inducing any pathological process, may be considered to be stable reference states. In the first case, the cascades of molecular interactions triggered by the stimulus the consequences of which are to be modeled are not activated beyond homeostatic methods. In the second case, the cascades triggered by the pathological process to be modeled are no longer operating: the reference state is stable as regards the modeled biological process. The stable state does not necessarily have to be the initial state of the biological system in the context of the biological process being studied.

In a further example, the healthy state may be considered to be an initial stable reference state if the installation of a pathological process is to be studied from this healthy state.

The measurement of Xᵢ of the set of vertices of the graph in this state is used in computation of the parameters as a stable reference for the graph, in particular for the error minimization procedure.

The stable state is defined mathematically as the vector of the set of experimental values of the variables of each vertex measured at the corresponding biological state (measurements carried out for all vertices of the graph).

In a preferred implementation, the standard state for the measurements is the stable state. In this case, since the variables are defined by (see Example 1): Xᵢ=xᵢₜ/xᵢ₀, in theory, in the stable state, since the network is not modified, regardless of t, xᵢₜ=ᵢ₀, and thus Xᵢ₌1, for any vertex i. It is the fact of inducing a modification in the network by application of stimuli during biological experiments which will “destabilize” the network, resulting in measuring kinetics in which X_{itl ≠}0 and Xᵢ=1.

In this implementation, then, an arbitrary stable state may optionally be defined in which whatever the value of i, Xᵢ=1.

In practice, during the experimental measurement of the kinetics, at a first time (t₀), X values are close to 1 in general (if the standard state for measurement is the time t₀).

However, what it is important is not the fact that the Xᵢ should be equal to 1 in theory and close to 1 during experimental measurements, but the fact that this state should be considered to be stable.

In fact, during the computation of the parameters of the mathematical relationships between Xᵢ and Xⱼ using neural network techniques with error minimization, the fact of defining a state as stable (at least at the start of the kinetics) introduces a strong constraint into the computation of the parameters and thus significantly improves their computation.

So that the model obtained is pertinent as regards the biological process or methods being studied, it is preferable to ensure that this stable state exists biologically, validating it by measuring it experimentally. If the stable state differs from the standard state, the values of Xᵢ in the stable state can only be defined rationally by their experimental measurement.

It is also possible to arbitrarily decide to define it by ∀i, Xᵢ=1, and to introduce (in the sense of “add”) this vector for Xᵢ at the initial time of the kinetics without having measured it. This follows from the assumption that the reference state is arbitrarily stable. This is often possible if the standard state does not correspond to a pool of different biological tissues.

In one preferred implementation, the experimental data are measured during kinetics (see above). In the case in which the biological process of interest is studied during passage from an initial stable state to a final stable state, and in which the experimental measurements are carried out at these two states and at intermediate times, two stable states are defined: the initial state and the final state of the kinetics of the biological process being studied. However, the fact that experimental measurements corresponding to two stable states are available is not a pre-requisite to carrying out the invention.

The fact of defining a stable state is also not a pre-requisite to carrying out the invention.

Smoothing data

If the set of experimental data is very restricted, an experimental data smoothing procedure may be carried out prior to computing the parameters to increase the number of available pairs (Xᵢ, Xⱼ), by computing intermediate values for these pairs from the smoothed curve. This procedure, which is a conventional procedure, does not pose any particular difficulties to the skilled person.

Computation of parameters of relationships

(Xᵢ, Xⱼ) is carried out using learning techniques employed for parameterization of artificial intelligence networks (such as those employed for neural networks) starting from quantitative experimental data concerning the variables of the graph.

As an example, this computation may use numerical algorithms or back-propagation with error computations. Parameters are arbitrarily fixed, a propagation or back propagation is carried out, then the error is computed between the computed results and the experimental results. The parameters are corrected as a consequence, and the propagation and error computation process is repeated in an iterative manner. The choice of error function and the use of this type of computation do not pose any particular difficulties to the skilled person.

In a second aspect, the present invention concerns a method for analyzing a molecular interaction network in a biological system, comprising the following steps:

A′) using a dynamic model of a molecular interaction network, said model being susceptible of being obtained by a method as described above, and constructed from a static graph the vertices of which represent biological molecules of the biological system and the edges of which represent physico-chemical interactions between said molecules, and from experimental data concerning the amounts or activities of said biological molecules;

C) a graph state, measured experimentally, is selected as the “state to be modified” and the duration of the biological process to be stimulated is defined and cut into a series of time steps;

D) a plurality of iterative simulation procedures are carried out, each comprising the following steps:

a) a stimulus is imposed on the state to be modified, i.e. the value of one or more quantitative variables associated with the vertices of the graph is modified, thus constituting a starting state for the simulation;

b) from the starting state of the simulation, a propagation computation is carried out within the graph.

The propagation computation within the graph may be carried out over a number of time steps such that the duration of the simulation does not exceed the duration of the biological process to be simulated defined in step C).

However, it is also possible to let the simulation continue beyond the duration of the biological process to be simulated defined in step C), for example if it is to be investigated whether the network will eventually find a new stable state (equilibrium state) and if it is not known a priori how long that will take. It is important to note that the duration of the simulation defined in step C) may be longer than that of the experimental kinetics used to calculate the parameters (or shorter).

In a variation of the method for analyzing a molecular interaction network described above, only steps C), D)a) and D)b) above are carried out, using (without reconstructing) a dynamic model of the selected molecular interaction network, said model being susceptible of being obtained by a method such as the methods for producing dynamic models of molecular interaction networks described above.

In a further particularly important aspect, the present invention provides a method for selecting therapeutic targets employing a dynamic model of a molecular interaction network in a biological system, by implementing an informatics system, comprising the following steps and characteristics:

A′) using a dynamic model of a molecular interaction network, said model being susceptible of being obtained by a method described above, and constructed from a static graph the vertices of which represent biological molecules of a biological system and the edges of which represent physico-chemical interactions between said molecules, and from experimental data concerning the amounts or activities of said biological molecules;

C) a graph state, measured experimentally, is selected as the “state to be modified” and the duration of the biological process to be simulated is defined and cut into a series of time steps, and a graph state corresponding to a “state to be achieved” of the biological system is selected as the “final graph state” to be achieved;

D) a plurality of iterative simulation methods are carried out, each comprising the following steps:

a) a stimulus is imposed on the state to be modified, i.e. the value of one or more of the quantitative variables associated with the vertices of the graph is modified, thus constituting a starting state for the simulation;

b) from the starting state for the simulation, a propagation computation is carried out within the graph;

c) a computation of the proximity between the “final graph state” obtained after step b) and the state to be modified, or between the “final graph state” and a desired state is carried out;

E) from the set of statistical proximities computed in step D), the vertices and the stimuli imposed on said vertices are hierarchized, the hierarchized vertices corresponding to classified therapeutic targets.

Clearly, and as was the case for the method for analyzing an interaction network, the method for selecting therapeutic targets of the invention may be implemented by carrying out only steps C) to E) above using, without reconstructing it, a dynamic model which may be obtained by methods for producing such models, described above. Similarly, step D)b) may be continued beyond the specified duration of step C).

Step A′) of the above methods may be carried out in the same manner as steps A) and B) of the methods for producing dynamic models of the interaction networks described above.

In these methods, step C) may be carried out by considering the following elements, where appropriate:

Time step

The duration of the biological process to be simulated is cut into a series of time steps which may or may not be regularly spaced; the time steps are defined so that they are preferably shorter than the real experimental intervals separating the series of quantitative experimental data used to compute the parameters of the relationships. Definition of these time steps is rendered necessary by the fact that any dynamic simulation method consists of computing states at discrete times, rendering time discretisation necessary. Thus, a series of consecutive times is obtained on which the simulation will be carried out. The first time of the set is termed the initial time. This initial time corresponds to the starting graph state, defined below.

Graph statesfor simulations

a graph state, experimentally measured, and corresponding to a state of the biological system which is to be modified, is defined (for example a pathological state). This state is termed the “state to be modified”. In certain cases, the skilled person may know that the differences between the state to be modified and the stable reference state essentially concern a sub-set of molecules of the network, and decide only to experimentally measure corresponding values of the variables, the other Xᵢ then, by default, being fixed to the values of the stable reference state. A graph state (experimentally measured or arbitrarily defined) corresponding to a state which is to be achieved of the biological system, is optionally defined (for example a healthy state). This state is termed the “state to be achieved”.

Identification of therapeutic target molecules for a given pathology

In a preferential implementation of the invention, the state to be modified and the state to be achieved are defined as follows:

Simulations of actions are carried out on the vertices of the graph from a state to be modified of a graph identical or similar to its state as observed experimentally in the pathological condition (for example by screening expression of messenger RNA on DNA arrays from pathological tissues).

The state to be achieved is defined as a state close to a non pathological reference state (as measured by experimental observation of the non pathological condition, for example by screening messenger RNA expression on DNA arrays from healthy tissues).

The simulation method then consists of identifying vertices and stimuli on said vertices which, starting from the state to be modified (pathological state), can best cause the graph to evolve (in part or in its entirety) towards a state close to the state to be achieved (non pathological state).

Identification of therapeutic target molecules for existing treatments or treatments in the course of development, and for which none or only some of the targets are known (which is the case with many current drugs).

In this case, the state to be modified is defined as above, and the state to be achieved is defined as the state or state near to that obtained experimentally during administration of that treatment (as measured, for example, by screening the expression of messenger RNA on DNA arrays from pathological tissues which have undergone the treatment concerned).

The simulation method then consists of identifying the vertices and the stimuli on these vertices which, starting from the state to be modified (pathological state), can best cause the graph (in part or in its entirety) to evolve towards a state close to the state to be achieved (pathological state under treatment).

This particular implementation may also be carried out by defining the state to be modified as any possible state E of the biological system being studied (for example the healthy state), and the state to be achieved as the state obtained after administration of the treatment concerned to the biological system in state E.

In the methods for analyzing interaction networks and selecting targets in accordance with the invention, step D) is carried out by considering the following elements:

Stimulus

A stimulus is imposed on the state to be modified. This stimulus is exerted in the form of a variation in the value of one or more variables in the graph (corresponding to one or more vertices, i.e. an increase or reduction in this or these value or values, depending on the desired simulation. The values of all of the other variables remain unchanged. Thus, a new graph state is obtained, which is the “starting state” of the simulation, the starting state and the state to be modified thus only differ in the value of the modified variable or variables, all of the values of all of the other variables being identical. This state is defined as corresponding to the first simulation period. In a particular implementation of the invention, the stimuli bear each time on a single vertex.

Propagation

From the starting state of the simulation, a propagation computation is carried out within the network. This propagation consists of computation of new values for all of the variables in the next time step, resulting in a new graph state, and recommencing the computation from this new state for the next time step, and so on. This propagation is carried out over the number of time steps (and thus the biological duration) defined by the experimenter as a function of the biological question posed. It may optionally be extended to the appearance of a new stable graph state (a new equilibrium state), or it may be stopped prior to this. At the end of this simulation, a new state (“final state ”) of the graph is obtained.

Iteration

The preceding method is repeated with a new stimulus, which acts on one or more other vertices of the graph, or which may act on the same vertex(ices) of the graph with the imposition of a new value on the variable or variables.

This method may be repeated in an iterative manner on all of the vertices individually, optionally by imposing several values (a finite number) per variable to test the activation or inhibition ranges over all the nodes. In this case, the result of step E) is a hierarchization of the vertices, and the stimuli imposed on these vertices. This classification thus corresponds to a classification of the vertices, from that on which a stimulus is the most susceptible of producing the desired state from the state to be modified, to that on which the stimulus is the least likely to have that effect. Each proximity corresponds to one vertex and one alone and to a single stimulation value on said vertex. If the desired effect is improvement of a pathological state, said classification is that of potential therapeutic targets from the most probable to the least probable.

Although presented here in a sequential manner, the set of propagations that is effected may be computed in parallel.

In step D)c), the proximity of each final state obtained at step D)b) may be computed either with respect to the state to be modified selected at step C) or with respect to another state, measured experimentally or determined arbitrarily, and defined as the “state to be achieved” which, for example, may be a healthy state. It may be the reference state defined above.

Once the graph proximity computations have been carried out for all of the simulations, step E) consists of classifying the set of (graph vertex(ices)—stimulus) multiplets into a hierarchical order (increasing or decreasing) directly corresponding to the hierarchical order (increasing or decreasing, respectively) of the proximities associated therewith. The graph vertices correspond directly to the molecules of the biological network, which are thus de facto hierarchized.

This hierarchization does not pose any technical problem to the skilled person, as proximities are positive numerical values which can be directly hierarchized from the largest to the smallest, or the opposite.

The result of this classification may advantageously be produce in the form of a list or table or in any other type of format, and/or stored in a database for subsequent use.

Whatever the levels of proximity of the graphs, a hierarchization of the (graph vertex(ices)—stimulus) multiplets using this method will always be obtained. Thus, the invention can always produce a result as a function of biological knowledge and the experimental measurement techniques used. It does not require extended prior knowledge of the molecular physio-pathological processes employed in the pathological process being analyzed. All of the molecules of the molecular interaction network are considered a priori (before carrying out the invention) as potential therapeutic target molecules without excluding any, the therapeutic target molecules being selected a posteriori (after implementing the invention) on objective statistical criteria (proximity computations). This method can be used systematically and automatically regardless of the pathology being studied, provided that it is possible to define a state to be modified. This renders it particularly suited to use in the context of industrial methods for large scale systematic selection of therapeutic targets, using experimental data provided by large scale molecular screening techniques.

In the case of the identification of therapeutic targets, the hierarchical classification of molecules of the biological network corresponds directly to the hierarchical classification of these molecules considered as therapeutic targets. Thus, the invention can produce a classification of potential therapeutic targets hierarchized in accordance with objective statistical criteria, as a function of experimental data (measurements of Xᵢ) and functional knowledge of the network (existence of molecular interactions). In cases where it is possible to define both a state to be modified and a state to be achieved, the best potential therapeutic targets are considered to be those corresponding to the best proximities to the state to be achieved.

In cases where definition of a state to be achieved is not possible (which should be exceptional, the healthy state being a priori always used by default as the state to be achieved for pathological processes), it is possible to hierarchize the (graph vertex(ices)—stimulus) multiplets by their proximity to the state to be modified, and to classify the molecules of the biological network under consideration as potential therapeutic targets by following a hierarchy which is the direct opposite of that for the proximities: the best potential therapeutic targets are considered to be those corresponding to the worst proximities compared with the state to be modified.

An important point is that this invention can not only identify therapeutic target molecules, but also can predict the direction of therapeutic action which it will be necessary to apply to these molecules (activation or inhibition).

The therapeutic targets are thus selected from data concerning the set of molecules studied, and not just those specifically concerning the target molecules, since the criterion used for hierarchization depends on the evolution of the graph as a whole, thus the set of experimental expression and/or activation measurements for all of the molecules represented in the graph, and not the simple evolution of experimental expression and/or activation measurements of just the target molecules. Thus, it is an integrative method which satisfies current requirements as defined above, in particular as regards diseases with multi-factorial determinism, clearly providing an advance over existing therapeutic target selection methods. The method of identifying targets described above comprises the following advantageous characteristics:
the computations are based on a non probabilistic method, which eliminates any limitation in terms of the time of computation, in contrast to methods involving stochastic equations and Bayes networks;
the invention integrates quantitative experimental data, which differentiates it from qualitative methods (Boolean networks, generalized logical formalisms, rule-based formalisms), allows constraints and hypotheses on the function of the network to be avoided, and can increase the reliability of the simulations;
the fact that the variables are defined as similar to effectively measurable experimental data allows the parameters of the relationships to be computed in an optimized manner (without having to extrapolate the values of the variables);
the fact of establishing, for any graph vertex, a direct relationship between the variable associated therewith and variables associated with the vertices of the graph acting on that vertex allows the direct implementation of methods for computing parameters derived from minimum error computation neural network learning methods, which are compatible with large networks as regards the computation time;
once the parameters have been computed, the simulations are very cheap as regards the computation time, as the network is deterministic. This is also compatible with applying the invention to large networks;
the divergence limitations introduced into the relationships or functions allow simulations to be carried out on long kinetics and large networks with satisfactory reliability;
knowledge of the existence of interactions between the molecules of a network and the orientation of a portion of said interactions are sufficient to implement the invention. Knowledge of the type of interaction (activatory or inhibitory) may advantageously be used when it is available, but it is not indispensable. No other supplementary qualitative knowledge concerning the network is required. For large molecular interactions (more than a hundred molecules), this knowledge is generally all that is currently available.

Thus, the qualification for this method, using the criteria considered in Tables 1 and 2 above, is as follows:

TABLE 3

| | (1) | | | | |
|---|---|---|---|---|---|
| | Integration | | | | |
| | of | | (3) | (4) | (5) |
| | quantitative | (2) | Variables | Continuous | Deterministic |
| Method | data | Formalism | used | functions | model |
| Method of | Yes | Inertia/tendency to | dXᵢ/Xᵢ₀ | Yes | Yes |
| invention | | return to initial state | | | |

It is important to note that the formalism allowing inertia/tendency to return to the initial state to be considered is specific to the invention. In fact, in the method of the present invention, the consequences of interactions are represented as a resultant of a resistance to change the number of molecules following a quantitative modification of the biological activity of at least one molecule interacting with themselves and a tendency to return to the initial state; this representation can avoid making hypotheses on the function of the system (threshold effects, types of chemical reactions, etc), and considering data or variables which may not be known or not measured, inertia and the tendency to return to the initial state representing the resultant of multiple biological phenomena involved in a given interaction (molecule synthesis time, existence of concomitant negative feedback control, transport time for molecules to cellular compartment where they are activated, etc); the formalism of the invention is thus fundamentally different to that of other existing methods (compare with Table 1).

TABLE 4

| | Pre-requisite | | | | |
|---|---|---|---|---|---|
| | (1) | | Applications | | |
| | Required | | | | (5) |
| | level of | | | (4) | Use for |
| | functional | (2) | (3) | Applicable | systematic |
| | knowledge | Growth in amount of | Maximum | to networks | identification |
| | of | computation required | size of | of 1000 to | of |
| | biological | as function of | network | 100000 | therapeutic |
| Method | network | network size | employed | molecules | targets |
| Method of | A | A | >100 | Yes | Yes |
| invention | | | | | |

In a variation of the methods for selecting therapeutic targets described above, a first hierarchized classification of vertices, considered individually, is obtained by carrying out steps A) to E) by imposing, for each of the simulations in step D), stimuli which concern a single vertex; a step D2) is then carried out, corresponding to step D) in which the stimuli imposed at each simulation are exerted on two vertices, either by testing all combinations of two possible vertices, or by limiting these computations to combinations of two vertices from a certain number of vertices which are best classified in step E). Finally, a step E2) for hierarchical classification of associations of two vertices on which stimuli are the most susceptible of having the desired effect is carried out from the set of statistical proximities computed in step D2).

From the above variation, steps D) and E) may be repeated in an iterative manner, each time by increasing the number of vertices on which the stimuli are exerted. Hence, the method may comprise a step D3) following step E2) and corresponding to step D) in which the stimuli imposed at each simulation are exerted on three vertices, either by testing all combinations of three possible vertices or by limiting these computations to combinations of three vertices selected from a certain number of vertices which are the best classified in step E) and combinations of two vertices the best classified in step E2), said step D3) being followed by a step E3) for hierarchical classification of associations of three vertices on which the stimuli are the most susceptible of having the desired effect. Steps D4) and E4), with stimuli on 4 vertices, may then be added, and so on. These methods for selecting therapeutic targets preferably comprise a final step for statistical classification of graph proximities for all of the simulations carried out, integrating the set of classifications obtained above.

In the methods of the invention, when a simulation involves stimuli on a combination of vertices, the stimuli exerted on these different vertices may be applied simultaneously or otherwise, i.e. the simulation may take into account a temporal offset between the stimuli exerted on different vertices.

In one implementation of the invention, the relationship between Xᵢ and Xⱼ is established, for at least part of the physico-chemical interactions between the molecules of the network, by an inertial relationship deriving from that of a harmonic oscillator in physics, associated with a sufficiently high damping factor to limit oscillation to a single cycle.

More precisely, a relationship of this type between Xᵢ and each Xⱼ, taken in pairs, is of the form:

wᵢⱼ·Xⱼ=mᵢ·(d²Xi/dt²)+2·λᵢⱼ·(dXᵢ/dt)+ω²·Xᵢ, in which:

mᵢ·(d²Xᵢ/dt²)+ωᵢⱼ²·Xᵢ correspond to the inertial term (i)

2·λᵢⱼ·(dXᵢ/dt) corresponds to the return to the initial state term (ii);

Xᵢ is a variable associated with the molecule i;

dXᵢ/dt is the derivative of Xᵢ as a function of time;

d²Xi/dt² is the second derivative of Xᵢ as a function of time;

Xⱼ is a variable associated with molecule j;

mᵢ represents the inertia of i;

λhd ijgoverns the return to the equilibrium state of Xᵢ;

the frequency 107ᵢⱼ corresponds to the time for Xᵢ to respond to the variation in Xⱼ; and

wᵢⱼ is a coupling factor representing the interaction force between molecules i and j, corresponding to a weighting of the effect of each molecule j on the molecule i with respect to the resultant of the set of combined effects of all molecules j exerting an effect on i.

In accordance with a further implementation of the methods of the invention, for at least a portion of the physico-chemical interactions between the molecules of the network, the relationship between the variables Xᵢ and Xⱼ taken in pairs is established by a sigmoid relationship comprising a retarding factor associated with a linear decreasing function.

Another type of relationship between the variables Xᵢ and Xⱼ, described in more detail below, which may be used in the methods of the invention to model at least part of the physico-chemical interactions between the molecules of a biological system, is of the form:

(dXᵢ/dt)=K₁ᵢ[1/(1+e^{-Σwij·xj-bi})]−K₂ᵢ·Xᵢ in which:

the sigmoid term K₁ᵢ·[1/(1+e^{-Σwij·Xj·bi})] corresponds to the inertial term (i); and

the term K₂ᵢ·Xᵢ corresponds to the return to the initial state term (ii); in which:

Xᵢ=variable associated with vertex i;

Xⱼ=variable associated with vertex j;

wᵢⱼ=coupling factor representing the interaction force between the molecules i and j, corresponding to a weighting of the effect of each molecule j on molecule i as regards the resultant of the set of the combined effects of all molecules j exerting an effect on i;

bi=retardation factor;

K₁ᵢ=factor limiting the maximum variation of Xᵢ; and

K₂ᵢ=return to equilibrium factor

In the above methods, the relationship between the variables Xᵢ and Xⱼ may also be, for at least a part of the interactions under consideration, a polynomial function of the type:

$$\begin{matrix}{w}_{ij} {X}_{j} = {\sum }_{[ m : 1 -> p - 1 ]} {b}_{m i} \cdot {X}_{i}^{m} \\ = {b}_{( p - 1 ) i} \cdot {X}_{i}^{p - 1} + … + {b}_{3 i} \cdot {X}_{i}^{3} + {b}_{2 i} {X}_{i}^{2} + {b}_{1 i} \cdot {X}_{i} + {b}_{0 i}\end{matrix}$$

with an order strictly lower than the number p of pairs (Xᵢt, Xⱼ t) of experimental values for the amount or activity Xᵢ or Xⱼ of molecules i and j respectively, at different times t, the parameters bmi being computed from p available experimental pairs (Xᵢₜ, Xⱼₜ), and wᵢⱼ being a coupling factor representing the force of the interaction between molecules i and j, corresponding to a weighting of the effect of each molecule j on molecule i as regards the resultant of the set of the combined effects of all molecules j exerting an effect on i. functions of the derivative type:

$${w}_{ij} {X}_{j} = {\sum }_{[ m : 0 -> {p}^{′} - 1 ]} {a}_{mij} \cdot [ {ⅆ}^{m} {X}_{i} / ⅆ {t}^{m} ]$$

p′being a whole number such that 1 <p′>p−, and p being as defined above, may also be used in methods of the invention to model at least a part of the physico-chemical interactions between the molecules of a biological system.

This may in particular be carried out with p′=3.

The overall resultant of n interactions exerted by molecules 1 to n on a molecule i may, in the methods of the invention, and for at least a portion of the molecules of the network, be a weighted sum of the actions of molecules 1 to n on molecule i, of the form:

$${F}_{G} ( {\sum }_{[ j : 1 -> n ]} j -> i ) = {\sum }_{[ j : 1 -> n ]} {a}_{ij} \cdot {f}_{ji} ,$$

in which

fᵢⱼ is the function associated with the arc (ij) for each pair (ij); and

$${a}_{ji} = ( ⅆ {X}_{j} / ⅆ t ) / {\sum }_{[ j : 1 -> n ]} ( ⅆ {X}_{j} / ⅆ t )$$

Such a weighted sum may also be made with:

$${a}_{ij} = ( {ⅆ}^{2} {X}_{j} / ⅆ {t}^{2} ) / {\sum }_{[ j : 1 -> n ]} ( {ⅆ}^{2} {X}_{j} / ⅆ {t}^{2} )$$

The present invention also pertains to a method for determining the mode of action of a xenobiotic, consisting of implementing a method for analysis of a molecular interaction network in a biological system, as described above, under the following conditions:

(i) the biological system in which the molecular interaction network is studied is affected by the action of the xenobiotic;

(ii) the “state to be modified” selected in step C) corresponds to an experimentally observed state before administration of said xenobiotic;

(iii) the modifications to be provided during step D)a) for which the computation carried out in step D)b) shows a change in the evolution of the system towards a state close to the state observed after administration of the xenobiotic are identified.

In a further aspect, the invention provides a method for predicting undesirable effects of treatments applying a dynamic model of a molecular interaction network in a biological system, by implementation of an informatics system.

In this aspect of the invention, the steps and characteristics of the method are the same as before, the only modification consisting in the following adaptation:

Once the target molecules of a treatment have been identified, an analysis is carried out on the parts of the graph representing known physiological functions, by simulations employing the same method as in the previous aspects of the invention (steps A to E, optionally A to Ek when steps D and E are repeated in an iterative manner by applying stimuli to combinations of vertices of up to k vertices), of the consequences of applying the treatment to these target molecules. This analysis consists of identifying any evolutions of these sub-parts of the graphs towards new states close to other pathological reference states (as defined by the experimental observation of said pathological conditions, using methods similar to that described above).

As an example, observation during simulations of the evolution of the apoptosis sub graph towards a final state having close proximity to a reference state of this graph corresponding to activation of this physiological pathway (as defined from data concerning one or more tissues affected by cellular degeneration processes) allows a prediction of a cellular toxic effect of the treatment in the tissue or tissues concerned.

This aspect of the invention thus consists of carrying out an analysis method as described above, under the following conditions:

(i) the biological system in which the molecular interaction network is studied is affected by the treatment;

(ii) the modifications of step D)a) correspond to observed or desired modifications in the amounts or activity of target molecules during application of the treatment;

(iii) step D)b) for computation of the evolution of the biological system is followed by an analysis of sub-parts of the system corresponding to known physiological functions, to identify any evolutions in these sub-parts towards states close to reference pathological states.

The present invention also concerns a method for hierarchizing potential therapeutic targets for a pathology, consisting of identifying therapeutic targets using a method in accordance with the invention, then predicting any undesirable effects of a treatment using said targets, and finally in determining the “therapeutic benefit/undesirable effects” ratio of an action on each of the potential therapeutic targets.

As disclosed above, one of the principal advantages of the present invention in its various aspects is to allow operation on graphs or networks of molecules in interaction comprising a large number of molecules. In the series of methods of the invention described above, the number of variables Xᵢ in the molecular interaction network under consideration is thus preferably more than 100, more than 200, or even more than 300.

The invention also concerns a method for analysis as described above involving the use of the molecular interaction networks of the invention, said networks being associated to form a hypergraph of networks.

In this variation of the implementation of the invention, the number of variables Xᵢ of each molecular interaction network is less than about 100 and the number of networks associated to form the hypergraph is in the range 2 to about 100.

In a further aspect, the invention is a method for extending graphs from the results of experimental screenings of variations in the expression or activity of molecules, applying a dynamic model of a molecular interaction network in a biological system, by using an informatics system.

In this aspect of the invention, the steps and characteristics of the method are the same as above, the only modification consisting in the following adaptation:

In this application, the method is employed to identify novel molecular interactions. This may be achieved by coupling the method of the invention described above with statistical methods for searching for a correlation between points in a n-dimensional space (for example factorial analysis, hierarchical classifications, etc) such as (but not exclusively limited to) those used currently to search for correlations in gene expression from results of screening messenger RNA on DNA arrays (gene clustering). An example of the clustering method which may be cited is shown by Eisen M B, Spellman P T, Brown P O and Botstein D (1998), Cluster analysis and display of genome-wide expression patterns, Proc Nati Acad Sci USA 95, 14863-8. one example of a free access software which can produce clustering analyses which is available on the internet is the “cluster 3.0” software developed by the Laboratory of DNA Information Analysis of Human Genome Center, http://www.ims.u-tokyo.ac.jp/imswww/index-e.html Institute of Medical Science, University of Tokyo, Japan (4-6-1 Shirokanedai, Minato-ku, Tokyo 108-8639 JAPAN). “Cluster 3.0” software is available from the internet site http:/bonsai.ims.u-tokyo.ac.jp/˜mdehoon/software/cluster/. The experimental data used may, for example, be those produced by screening messenger RNA expression on DNA arrays.

This coupling consists of using parameterizations computed by using the invention to re-compute a new matrix of experimental data measuring degrees of expression or activity of molecules, by eliminating matrices of experimental results at the origin of molecular interaction factors included in the parameterized dynamic model (such as the dynamic resistance or inertial component), then carrying out correlation searches. This “cleaning” of matrices of original results consists, in other words, in eliminating the “statistical noise” linked to these factors, these factors then being considered to introduce distortions into actually observed measurements of degrees of expression or activity of molecules, compared with what these measurements would have been from a theoretical viewpoint in the absence of said factors. As an example, the dynamic resistance of expression of a given gene A (thus the inertia for modification of the corresponding amount of messenger RNA) at two distinct stimulations exerted by molecules B and C (which are themselves distinct) may vary, preventing before any “cleaning” of this type a demonstration both of a correlation between expression of A and the activity of molecule B, and a correlation between expression of A and the activity of molecule C.

The invention thus pertains to the use of a dynamic model of a molecular interaction network in a biological system susceptible of being obtained by a method as described above, to extend a static graph the vertices of which represent biological molecules and the arcs of which represent physico-chemical interactions between these molecules.

Other advantages and characteristics of the present invention will become apparent from the following examples of practical implementations of the methods of the invention, which illustrate the methods described above in a non limiting manner.

The following diagrams and figures also illustrate certain aspects of the invention:

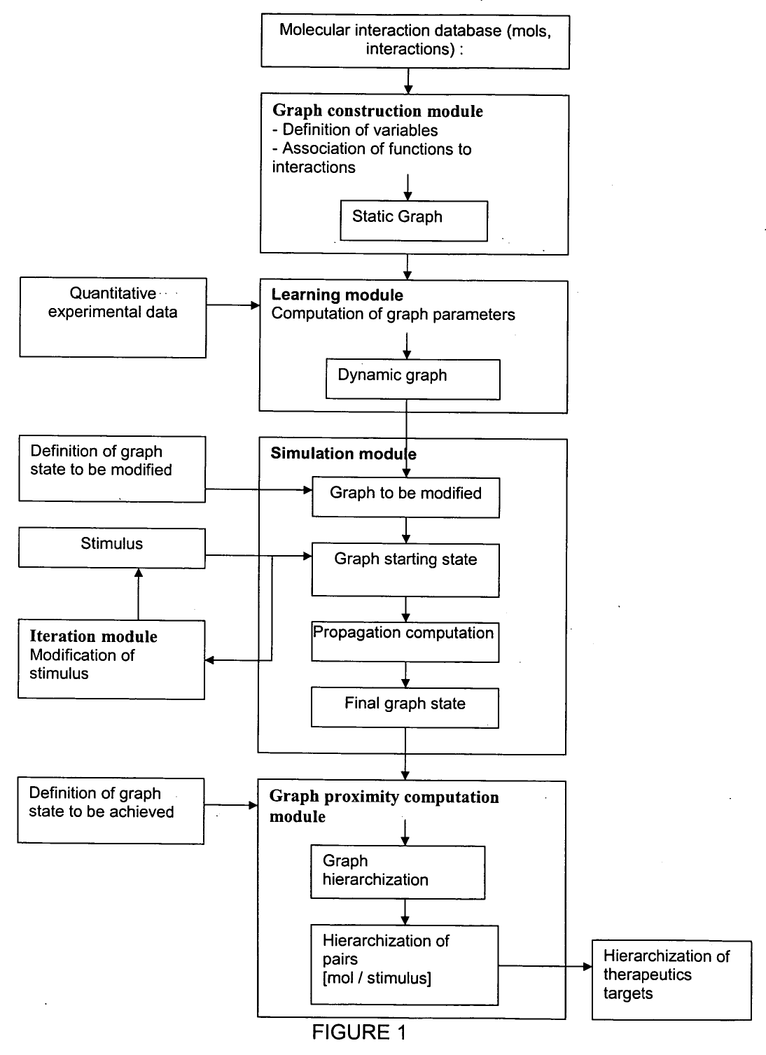

FIG. 1 shows a chart of the various steps of a method for identifying targets in accordance with the present invention;

FIG. 2 shows a chart of the graph constructed in Example 4.

This graph shows 116 molecules in the molecular interaction network (116 vertices) and 329 molecular interactions between these molecules. Each rectangle represents one molecule of the network (=one vertex of the graph). Each arrow represents an interaction between two molecules (=one edge of the graph); the direction of the arrows represents the direction of the interactions: if the arrow passes from molecule A toward molecule B, this means that molecule A has a potential activatory or inhibitory action on molecule B; certain arrows are double headed: bilaterial interaction. The text within each rectangle corresponds to the abbreviation of the name of the protein as described in the text. Computation of the parameters of the relationships between the vertices of the graph and the simulations were carried out on the whole of this graph (Example 4).

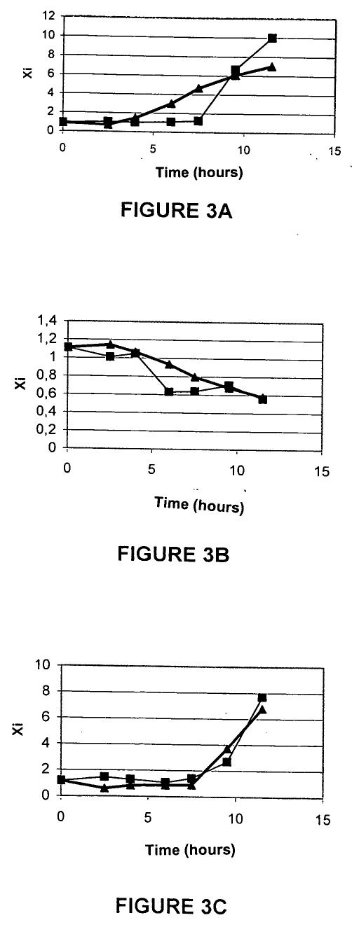

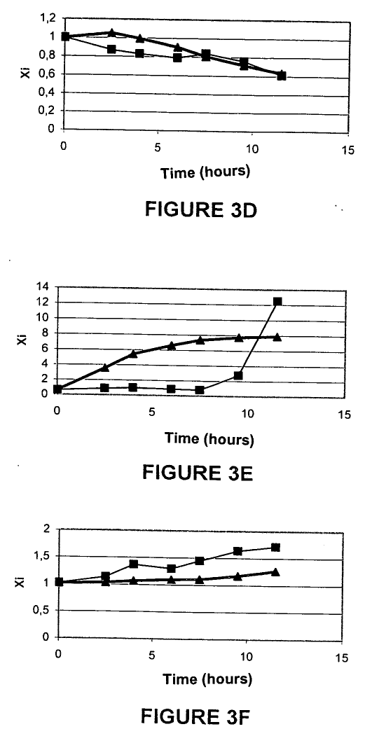

FIG. 3 shows graphical examples of computed (triangles) and observed (squares) kinetics for some genes (Example 4). FIG. 3A: ORF YBL015W (ACHI). FIG. 3B: ORF YMR169C (ALD3). FIG. 3C: ORF YIL125W (KGD1). FIG. 3D: ORF YNL071W (PDA2). FIG. 3E: ORF YAL054C (ACS1). FIG. 3F: ORF YFL018C (LPD1).

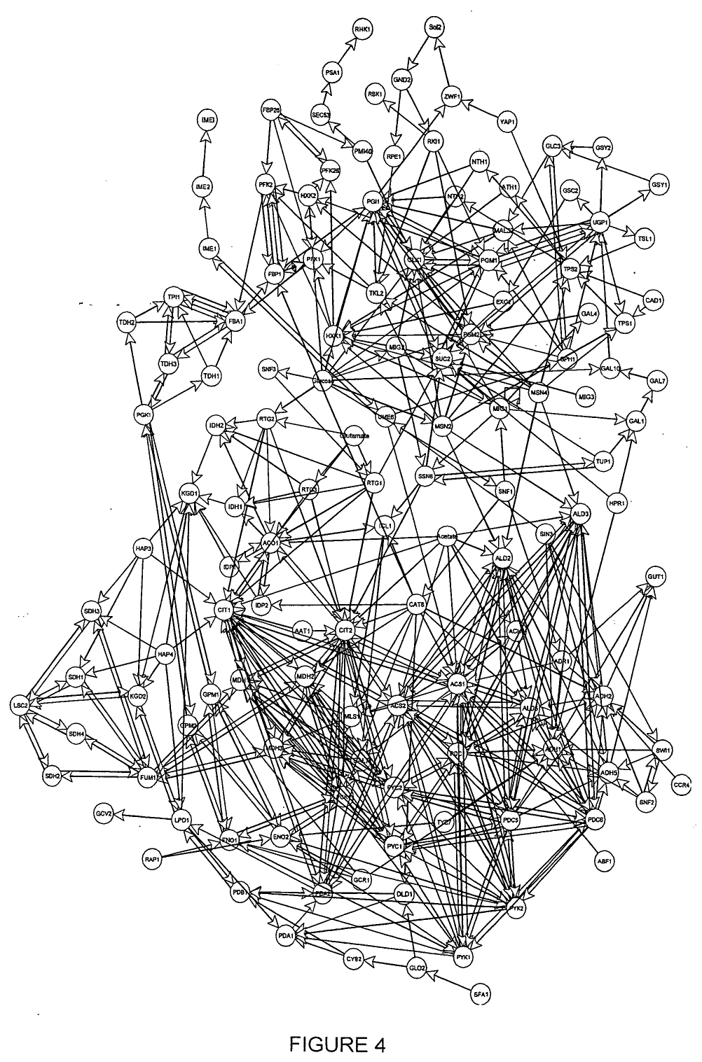

FIG. 4 represents a chart of the graph constructed in Example 5.

This graph includes 133 molecules in the molecular interaction network (133 vertices) and 407 molecular interactions between these molecules.

The meanings of the rectangles, arrows and texts within each rectangle is the same as that described above, made with reference to FIG. 2.

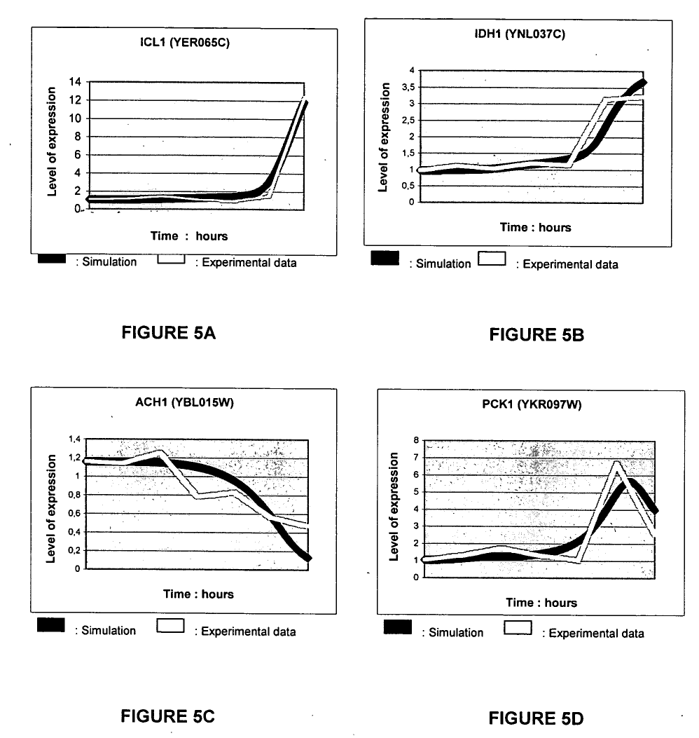

FIG. 5 shows examples of parameterization curves in which the experimentally measured kinetics are represented in white and the kinetics computed by simulation are represented in black for some molecules (Example 5). FIG. 5A: ICL 1 (YER065C). FIG. 5B: IDH1 (YNL037C). FIG. 5C: ACH1(YBL015W). FIG. 5D: PCK1 (YKR097W).

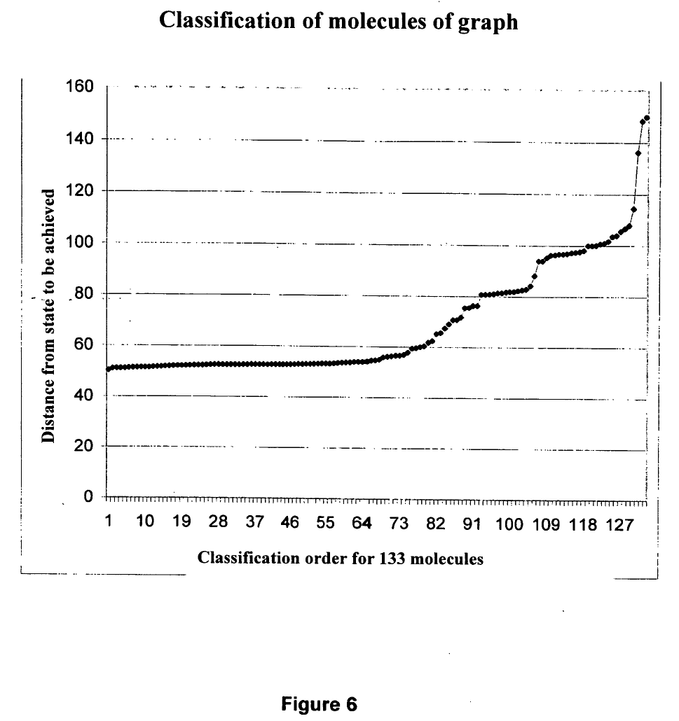

FIG. 6 shows a chart for classification of molecules of a network by hierarchical classification of distances computed between the state to be achieved and the states obtained by simulation (Example 5).

The ordinates correspond to the values of the distance computed. The abscissa shows the 133 molecules of the network classified from left to right from that associated with the shortest distance to that associated with the greatest distance, each point corresponding to one molecule of the network.

### EXAMPLES

EXAMPLE 1: Practical implementation of step A)
Variables associated with the vertices of the graph:

Let i be a given molecule of the network and xi its quantity (or its concentration) in the biological system being studied. Let xᵢ₀ be the experimental measurement carried out for i at a “standard state” of the biological system, used during measurements. Let xᵢₜ be the experimental measurement effectively carried out of i at an instant t. The variable used is:
Xᵢ=(xᵢₜ/xᵢ₀). (1)

The standard state is a measurable state used to carry out biological measurements against which all the other measurements are quantified. It may correspond to an artificial state of the system, for example to a pool of several biological samples removed under different experimental conditions (artificial state) or to a state of the system which is genuinely observable (non artificial).

This variable corresponds well to the type of biological measurements which are effectively carried out. As an example, during measurements of the amount of messenger RNA on DNA arrays; the measurement effectively carried out for each RNA at a given experimental time t is the ratio of the signal emitted by hybridization of the RNA present in the biological sample at time t to the signal emitted by RNA of the same type present in the sample at a standard state of the biological system being studied (for example the initial time of the biological experiment). Only this measurement may be considered to be reliable, the real quantity of RNA molecules not being directly measurable as it depends on experimental parameters which are not directly controlled (yield of marker labeling reactions, yield of hybridizations on arrays, etc, these parameters differing in a manner which is not predictable between two given RNA molecules of different types). The quantity of signal measured in the standard state thus serves as a reference measurement for that at other times, being based on the hypothesis that for a given type of RNA, the experimental parameters influencing the final signal emitted are the same.

Xᵢ thus corresponds directly to the quantitative biological measurements which are genuinely producible in the current state of molecular biological techniques.

The variables Xᵢ, Xⱼ etc are thus equal to (xᵢₜ/xᵢ₀), (xⱼₜ/xⱼ₀) etc.

(2) the relationships associated with the edges of the graph and linking the variables:

let n vertices j₁,j₂, . . . ,jₙ of the graph (corresponding to n molecules of the network) act on a vertex i (orientation of graph from j to i). These relationships define a direct relationship between Xᵢ and Xⱼ (Xⱼ₁, Xⱼ₂, . . . ,Xⱼₙ).

Inertial term of these relationships

This term corresponds to a continuous function of Xⱼ. This term comprises an inertial component. The term “inertia” means the fact that Xᵢ has a resistance to change following a variation in Xⱼ: more precisely, this term of the relationship must be able to accommodate the following behavior of the variables: following a given variation in one or more of Xⱼ, the rate of variation of Xᵢ will initially be low, then accelerate progressively.

This term must also be able to accommodate the following behavior of the variables: following a variation in one or more of Xⱼ, Xᵢ will progressively achieve a new finite value corresponding to the maximum variation in Xᵢ (variation peak); this means that the rate of variation of Xᵢ, after having increased, will reduce and progressively tend towards 0. There is thus an inflexion in the curve of Xᵢ as a function of time.

Comments

The fact of composing an inertial component introduces an expression of a temporal delay in the variation of Xᵢ following the variation in Xⱼ: in the absence of other interactions exerted on i, the variation peak of Xᵢ tends to appear after the peak in the variation of Xⱼ.

The fact of composing an inertial component thus can accommodate the temporal offset in the variations in Xᵢ during propagation of activations/inhibitions in the network. In contrast, the fact of introducing a simple temporal offset by other mathematical methods does not systematically introduce an inertial term.

Term for return to initial state of these relationships

This term tends to return Xᵢ to its initial level.

It corresponds to a continuous function of Xᵢ which is constantly increasing in absolute terms with Xᵢ: the greater the variation in Xᵢ, the more the term increases in absolute terms and tends to return Xᵢ to its starting level.

Coupling these two terms allows a general relationship which can account for variable and non linear kinetics to be identified.

Several mathematical relationships may include these characteristics and be used to establish a relationship between Xᵢ and Xⱼ. The fact of having an inflexion, of being constrained by a maximum finite limit and of tending to return to the initial state may in particular be obtained by the following:

In one aspect of the invention, the relationship between Xᵢ and Xⱼ is established by an inertial relationship derived from that of a harmonic oscillator in physics associated with a sufficiently high damping factor to limit the oscillation to a single cycle.

For more clarity in the description, a relationship of this type between Xᵢ and each Xⱼ taken in pairs is of the form
wᵢⱼ·Xⱼ=mᵢ·(d²Xi/dt²)+2·λᵢⱼ·(dXᵢ/dt)+ωᵢⱼ²·Xᵢ, (1)

The term: mᵢ·(d²Xi/dt²)+ωᵢⱼ²·Xᵢ, correspond to the inertial term;

The term: Mᵢ·(d²Xi/dt²) corresponds to the return to the initial state term;

Xᵢ is a variable associated with the molecule i;

dXᵢ/dt is the derivative of Xᵢwith time;

(d²Xi/dt²) is the second derivative of Xᵢ with time;

Xⱼ is a variable associated with molecule j;

mᵢ represents the inertia of i (resistance to change);

λᵢⱼ=damping (governs the return to the equilibrium state of Xᵢ);

ωᵢⱼ=frequency (response time of Xᵢ to the stimulus represented by Xⱼ); and

wᵢⱼ=coupling factor representing the interaction force between molecules i and j, corresponding to a weighting of the effect of each molecule j on the molecule i with respect to the resultant of the set of combined effects of all molecules j exerting an effect on i.

A formally equivalent variation of this relationship between Xᵢ and Xⱼ which can also be used consists of reverting to a particular case in which mᵢ is considered to be a constant; in this case, the parameter mᵢ can be eliminated from the equation. The formulation of the equation remains the same overall:

wᵢⱼ·Xⱼ=(d²Xⁱ/dt²)+2·λᵢⱼ·(dXᵢ/dt)+ωᵢⱼ²·Xᵢ

In both cases, if |πᵢⱼ |≧1 the damping is such that there is no more than one “oscillation” of Xᵢ. In other words, this relationship causes Xᵢ to vary from its starting level to a maximum variation, then tends to cause it to return to its initial state.

In order to carry out the invention, we thus define a relationship between Xᵢ and the set of Xⱼ:

In one aspect of the invention, this is defined by a weighted sum of the effects of Xⱼ on the resultant over Xᵢ:

$$\begin{matrix}\begin{matrix}{\sum }_{[ j : 1 -> n ]} {w}_{ij} \cdot {X}_{j} + {c}_{i} = {m}_{i} \cdot ( {ⅆ}^{2} {X}_{i} / ⅆ {t}^{2} ) + 2 \cdot {λ}_{ij} \cdot \\ ( ⅆ {X}_{i} / ⅆ t ) + {ω}_{ij}^{2} \cdot {X}_{i}\end{matrix} \\ or : & ( 2 ) \\ \begin{matrix}{\sum }_{[ j : 1 -> n ]} {w}_{ij} \cdot {X}_{j} + {c}_{i} = ( {d}^{2} {X}_{i} / ⅆ {t}^{2} ) + 2 \cdot {λ}_{ij} \cdot \\ ( ⅆ {X}_{i} / ⅆ t ) + {ω}_{ij}^{2} \cdot {X}_{i}\end{matrix} & ( 3 )\end{matrix}$$

wᵢⱼ=weighting factor;

cᵢ=correction factor, due to the possible margins for error in the experimental data, which is not indispensable.

The definition of the other parameters and variations is the same as before.

Xᵢ; dXᵢ/dt; d²Xᵢ/dt² and Xⱼ are data which are provided experimentally or computed directly from these data. As an example, these data may be obtained by mRNA expression screening.

The unknowns in this equation are the parameters (mᵢ; λᵢⱼ; ωᵢⱼ; wᵢⱼ), which have to be fixed to completely define the relationship for the simulations.

We assume that whatever i is and whatever j is, |λ_{ij|≧}1.

In a further aspect of the invention, the relationship between Xᵢ and the set Xⱼ is defined by a sum the weighting of which includes a term which varies through time and explicitly accounts for the respective rates of the modifications of Xⱼ, which rates are represented by the derivatives: dXⱼ(t)/dt, hereinafter denoted dXⱼ/dt. This amounts to assuming that the rates of variation of Xⱼ (molecules j) influence the overall resultant of their actions on the kinetics of Xᵢ (of molecule i).

We define:

$${a}_{ij} = ( ⅆ {X}_{j} / ⅆ t ) / {\sum }_{[ j : 1 -> n ]} ( ⅆ {X}_{j} / ⅆ t ) \qquad ( 4 )$$

aᵢⱼ being a weighting factor. aj can be computed directly from quantitative experimental data for each experimental time. This weighting factor varies as a function of time.

In this case, the relationship between Xᵢ and the set Xⱼ is defined as follows:

$$\begin{matrix}\begin{matrix}{\sum }_{[ j : 1 -> n ]} ( {a}_{ij} \cdot {w}_{ij} \cdot {X}_{j} ) + {c}_{i} = {m}_{i} \cdot ( {ⅆ}^{2} {X}_{i} / ⅆ {t}^{2} ) + 2 \cdot {λ}_{ij} \cdot \\ ( ⅆ {X}_{i} / ⅆ t ) + {ω}_{ij}^{2} \cdot {X}_{i}\end{matrix} \\ or : & ( 5 ) \\ \begin{matrix}{\sum }_{[ j : 1 -> n ]} ( {a}_{ij} \cdot {w}_{ij} \cdot {X}_{j} ) + {c}_{i} = ( {d}^{2} {X}_{i} / ⅆ {t}^{2} ) + 2 \cdot {λ}_{ij} \cdot \\ ( ⅆ {X}_{i} / ⅆ t ) + {ω}_{ij}^{2} \cdot {X}_{i}\end{matrix} & ( 6 )\end{matrix}$$

The definition of the parameters and variations is the same as before.

Equations (2) and (3) amounts to a particular case of equations (5) and (6) where the following is set arbitrarily,
aᵢⱼ=1

In a further aspect of the invention, the relationship between Xᵢ and the set Xⱼ is defined as a sum the weighting of which includes a term which varies with time and explicitly accounts for the respective accelerations of modifications of Xⱼ, the accelerations being represented by the second derivatives: d²Xⱼ(t)/dt² hereinafter denoted d²Xⱼ/dt². This amounts to assuming that the accelerations of variations of Xⱼ (of molecules j) influence the overall resultant of their actions on the kinetics of Xᵢ (of molecule i).

We define:

$${a}_{ij} = ( {ⅆ}^{2} {X}_{j} / ⅆ {t}^{2} ) / {\sum }_{[ j : 1 -> n ]} ( {ⅆ}^{2} {X}_{j} / ⅆ {t}^{2} ) \qquad ( 7 )$$

aᵢⱼ being a weighting factor.

Here again, aᵢⱼ is directly calculatable from experimental quantitative data, for each experimental time. This weighting factor varies with time.

In this case, the relationship between Xᵢ and the set of Xⱼ is defined as before:

$$\begin{matrix}\begin{matrix}{\sum }_{[ j : 1 -> n ]} ( {a}_{ij} \cdot {w}_{ij} \cdot {X}_{j} ) + {c}_{i} = {m}_{i} \cdot ( {ⅆ}^{2} Xi / ⅆ {t}^{2} ) + 2 \cdot {λ}_{ij} \cdot \\ ( ⅆ {X}_{i} / ⅆ t ) + {ω}_{ij}^{2} \cdot {X}_{i}\end{matrix} \\ or : & ( 8 ) \\ \begin{matrix}{\sum }_{[ j : 1 -> n ]} ( {a}_{ij} \cdot {w}_{ij} \cdot {X}_{j} ) + {c}_{i} = ( {d}^{2} {X}_{i} / ⅆ {t}^{2} ) + 2 \cdot {λ}_{ij} \cdot \\ ( ⅆ {X}_{i} / ⅆ t ) + {ω}_{ij}^{2} \cdot {X}_{i}\end{matrix} & ( 9 )\end{matrix}$$

The definition of the parameters and variables is the same as before. Only the definition of parameters aᵢⱼ (and as a result their value and their values computed from other parameters) differs with respect to the preceding aspect of the invention.

Here again, equations (2) and (3) amount to a particular case of equations (8) and (9) where the following is set arbitrarily:

aᵢⱼ=1.

When the times at which the experimental measurements are made are long with respect to the accelerations, it is preferable to define the weightings with respect to rates rather than with respect to accelerations.

(2) In a further aspect of the invention, the relationship between Xᵢ and Xⱼ is established by a sigmoid relationship comprising a retarding factor associated with a linear decreasing relationship.

In this case, in a preferred implementation, the relationship between Xᵢ and Xⱼ will be:
(dXᵢ/dt)=K₁ᵢ·[1/(1+e^{-Σwij·Xj-bi})]−K₂ᵢ·Xᵢ; for the set of vertices j having an action i (denoted vertices j). (10)

In this formulation, the relationship associated with the edges corresponding to an inhibitory molecular interaction could be the reverse of that associated with edges corresponding to an activating interaction (sigmoid decreasing or increasing curve, respectively), said characteristic being obtained directly during computation of the parameters, by their positive or negative signs.

The sigmoid term:
₁ᵢ·[1/(1+e^{-Σwij·Xj-bi})]

Corresponds to the inertial term.

The term:
−₂ᵢ·Xᵢ

corresponds to the return to the initial state term.

Xᵢ=variable associated with vertex i;

Xⱼ=variation associated with vertex j.

wᵢⱼ=weighting regarding the effect of j on i when a plurality of vertices (j₁,j₂, . . . ,jₙ) act on the vertex i;

bi=retardation factor;

K₁ᵢ=factor limiting maximum variation of Xᵢ. it's use is linked to the fact that the sigmoid term varies between 0 (0% variation) and 1 (100% variation). This factor is thus required to accommodate situations in which Xᵢ varies by more than 100%.

K₂ᵢ=return to equilibrium factor.

In this aspect of the invention, the weighted resultant of the combination of the effects of the set of Xⱼ on Xᵢ is included directly. The combined effect of the set Xⱼ is also represented here by a weighted sum, in the inertial term.

In a further aspect of the invention, the relationship between the Xᵢ and the Xⱼ is established in a similar manner to the preceding aspect, but with the introduction of a supplemental weighting factor at as defined by equations (4) or (7) above. In this case, in a preferred implementation, the relationship between the Xᵢ and the Xⱼ will be:
(dXᵢ/dt)=K₁ᵢ·[1/(1+e^{-Σaij·wij·Xj-bi})]−k₂ᵢ·Xᵢ; for the set of vertices j having an action on i (denoted vertices j). (11)

The definition of the parameters and variations is the same as before; the parameter aᵢⱼ is defined either by equation (4) or by equation (7) above. Equation (10) is a particular case of equation (11) where the following is arbitrarily set:
aᵢⱼ =1.

The parameter aᵢⱼ is a term which varies through time and explicitly accounts for the respective rates of modifications of Xᵢ or respective accelerations of Xⱼ, depending on whether aᵢⱼ is defined by equation (4) of equation (7) respectively.

Provided that the times at which the experimental measurements are made are long with respect to the accelerations, it is preferable to define weighting factors aᵢⱼ with respect to the rates (equation (4)) than with respect to the accelerations (equation (7)).

Equation (4)

$${a}_{ij} = ( ⅆ {X}_{j} / ⅆ t ) / {\sum }_{[ j : 1 -> n ]} ( ⅆ {X}_{j} / ⅆ t ) \qquad ( 4 )$$

$${a}_{ij} = ( {ⅆ}^{2} {X}_{j} / ⅆ {t}^{2} ) / {\sum }_{[ j : 1 -> n ]} ( {ⅆ}^{2} {X}_{j} / ⅆ {t}^{2} ) \qquad ( 7 )$$

(3) However, other types of mathematical relationships which are not cited here comprising the characteristics described in the invention could also be used, their use in the context of the invention being then considered to fall within the scope of the present patent.
(4) It should be understood here that the use of mathematical relationships not explained here but which can accommodate all or part of the characteristics described above fall within the scope of the invention. Thus, it is possible, in a non limiting manner, to establish a relationship between Xᵢ and Xⱼ which respects the existence of an inflexion in the curve of Xᵢ as a function of time, and a maximum limit to Xᵢ in the range of experimental data used and in the experimental time steps by a polynomial function or a sine or cosine function, etc.

### EXAMPLE 2

### Practical implementation of step B)

Many techniques for learning procedures, i.e. by gradient descent in graphs, are publicly available to carry out the computation of the parameters (in particular using Laplace transforms, or the method developed by Pearlmutter, “Gradient computations for dynamic recurrent neural networks: a survey”, IEEE transactions on neural networks, 1995). A further example of the computation method consists of implementation of an S order Runge-Kutta adaptive numerical resolution method (which allows the use of a non constant time step in the experimental data) associated with BPTT (back propagation through time) learning.

The choice of the learning procedure is especially linked to the algorithms used to define the relationship between the pairs (Xᵢ, Xⱼ). The skilled person will readily be able to make this choice and implement it.

The choice and implementation of an error function does not pose any particular difficulty. In fact, several error functions may be used, and are available in the literature. Examples of error functions which can be used are:

$$E = {\sum }_{i} {\int }_{t} {[ {X}_{1 i} ( t ) - {X}_{2 i} ( t ) ]}^{2} . ⅆ t$$

in which:

X₁ᵢ(t): value of Xᵢ at time t computed by simulation;

X₂ᵢ(t): value of Xᵢ at time t, measured experimentally.

Or the overall error relative to given trajectories for learning:

$$√ [ {\sum }_{i} {\sum }_{t} {( {X}_{1 i} ( t ) - {X}_{2 i} ( t ) )}^{2} / {\sum }_{i} {\sum }_{t} {( {X}_{2 i} ( t ) )}^{2} ]$$

√=square root of term between brackets: [];

X₁ᵢ(t) and X₂ᵢ(t) are as defined above.

To compute the local relative error (at the trajectory of a graph vertex), it is also possible to use the formula:

$$√ [ {\sum }_{t} {( {X}_{1 i} ( t ) - {X}_{2 i} ( t ) )}^{2} / {\sum }_{t} {( {X}_{2 i} ( t ) )}^{2} ]$$

√=square root of term in brackets [];

X₁ᵢ(t) and X₂ᵢ(t) are as defined above.

In the case in which an inertial type relationship Xᵢ, Xⱼ adapted from a harmonic oscillator is used, and in a preferred implementation, the following constraints will be imposed during computation of the parameters:

A threshold will be introduced by requiring that for any elementary relationship (Xᵢ, Xⱼ), the computed parameters satisfy:

λᵢⱼ>ωⱼⱼ (which means that a large damping is imposed), or mᵢ=the maximum value computed for the set of relationships (Xᵢ, Xⱼ);

these two criteria possibly being associated.

When the parameters have been computed, the graph (or network) is entirely determined by the mathematical relationships associated with the edges of the graph: it is an entirely deterministic network. The corresponding graph is orientated. The network may be represented explicitly by using techniques for representing neural networks used in artificial intelligence. It is a non Boolean network, nor is it a Bayes network, nor organized into layers, which means that circuit redundancy and feedback loops can be represented. This deterministic network allows simulations to be used without major computation costs, even for a very large graph.

EXAMPLE 3

### Practical implementation of step D)

Propagation

Many propagation methods are available in the literature, adapted to neural network techniques developed for artificial intelligence, and their implementation does not pose any particular difficulties to the skilled person, the dynamic graph being entirely deterministic at this stage of the implementation.

Examples of propagation methods which may be cited are the software Neural Network Toolbox 4.0.2, developed in the MATLAB computing environment, available at the internet address http://www.mathtools.net/MATLAB/NeuralNetworks/index.html, sold by The Math Works, Inc. This software for neural networks can in particular carry out propagations in a network. Other examples of propagations are integrated into the Runge Kutta and Pearlmutter methods cited in the present text.

Propagation is inherent to the learning methods cited in Example 2. The simulation step thus consists of using the propagation method employed in step B or any other method for propagation judged by the skilled person to be suitable.

However, several principles are preferentially respected when carrying out simulations:

In a particular implementation of the invention, threshold procedures are associated with the selected propagation method, to reduce divergences (and thus improve convergences, i.e. reliability). They may bear upon:
a lower threshold (i.e. that any value of a variable predicted below 0 is brought to 0 (or to a minimum background value if that may be defined by the experimental data): threshold: for any molecule i, whatever the value of Xᵢ, Xᵢ<0 =>Xᵢ=0.
An upper threshold: by imposing a maximum threshold on values of Xᵢ which can be obtained during simulations (for example by fixing a maximum threshold corresponding to a multiplicative factor (which may be fixed between 1 and 10, but not exclusively) of the maximum values observed experimentally for each Xᵢ;

this factor may optionally be defined during simulations of available real experimental results by testing several values of this factor.
Introduction of constraints into loops during simulations: this may be carried out by several methods, which are not mutually exclusive, this list not being limiting.

All of these methods are aimed at imposing constraints, either on the number of loops made or on the range of values of Xᵢ:
limitation on the number of loops which can be carried out during simulations, the maximum number of loops being able to be defined from an analysis of real experimental data taking into account the duration of the simulations;
use of threshold as described above to avoid “explosion” phenomena in the loops, these then tending to stabilize at the maximum authorized level of the threshold.

Iteration

Iterations are routinely used in informatics. It consists here of repeating the sequence of propagation computations by modifying the stimuli systematically. It may or may not include a parallel computing strategy. It is easy for the skilled person to implement, and does not need to be described in more detail.

By allowing a description of the effect of a modification to the network on the whole network to be described, these simulations aim to analyze the biological system as a whole and thus to rise to the challenges cited above. These simulations thus consist of describing the evolution of the set of the molecules in the molecular interaction network through time following “virtual” initial stimuli including, if this turns out to be biologically important, to a new state of equilibrium of the graph. These “virtual” stimuli may be applied systematically to each vertex of the graph, but it is also possible to carry out several stimuli at the same time, or in sequence, over several vertices.

Proximity of graph states

A statistical proximity computation between each final computed state and the desired state or between each final state and the state to be modified is carried out. For each vertex, it can associate a statistical criterion (proximity obtained) to the vertex on which the stimulus is exerted and to the stimulus exerted on that vertex.

A number of possibilities for statistically comparing the graph states exist, and their choice does not pose any problems to the skilled person.

As an example, the distance between two graph states may be computed as follows:

If X₁ᵢ is the value of the variable Xᵢ in state 1 of the graph;

If X₂ᵢ is the value of the variable Xᵢ in state 2 of the graph, a mathematical distance between states 1 and 2 of the graph may be computed by:

$$D = {\sum }_{i} {( {X}_{1 i} - {X}_{2 i} )}^{2}$$

$$or : \\ D = √ [ {\sum }_{i} {( {X}_{1 i} - {X}_{2 i} )}^{2} / {\sum }_{i} {( {X}_{2 i} )}^{2} ]$$

√=square root of the term between brackets:[]

Other conventional statistical methods are also available, such as population comparisons, etc.

The graph comparison elements are of two orders:
Convergence points for values Xᵢ (end point), for example by comparing populations of final points Xᵢ between graph states by conventional population comparison statistics (mean, variance, etc);
Kinetics of each molecule i (for example by comparing differences in integrals of kinetic curves, and comparison of populations of differences of integrals). It is then possible to compare, for example, the kinetics of Xᵢ during establishment of a pathological process with that following a stimulus as defined above, allowing the vertices and stimuli to be hierarchized by the difference they cause with respect to the pathological process, not limiting itself to points of convergence. In this case it is possible, for example, to estimate the distance between the two kinetics of the graph by the error functions cited above:

$$E = {\sum }_{i} {\int }_{t} {[ {X}_{1 i} ( t ) - {X}_{2 i} ( t ) ]}^{2} . ⅆ t$$

$$or \text{:}$$

$$√ [ {\sum }_{i} {\sum }_{t} {( {X}_{1 i} ( t ) - {X}_{2 i} ( t ) )}^{2} / {\sum }_{i} {\sum }_{t} {( {X}_{2 i} ( t ) )}^{2} ]$$

These two types of comparisons allow a statistical evaluation of the proximity of the graphs in the simulation procedures described above to be determined.
Other types of proximity analysis may be employed: see, for example:

Pearlmutter: “Gradient computations for dynamic recurrent neural networks: a survey”, IEEE transactions on neural networks, 1995.

The choice and implementation of these comparisons will readily be made by the skilled person and does not need to be described further here.

### EXAMPLE 4:

### Modeling and simulations from a static graph of 116 molecules

Biological data used

1) A static graph corresponding to a molecular interaction network in yeast (Saccharomyces cerevisiae, a living eukaryotic organism which may be considered to be a biological system satisfying the complexity criteria cited above) was constructed by manual capture from a txt type spreadsheet (without using a particular automated system), from data in the KEGG database: Kyoto Encyclopedia of Genes and Genomes, freely accessible at http://www.genome.ad.jp/kegg/kegg2.html.

This graph is more particularly centered on the mechanisms of cell respiration (glycolysis, neoglucogenesis, metabolism of pyruvate and acetyl CoA, etc). It comprises 116 molecules, enzymes or transcription factors. It comprises 329 uni- or bi-directional interactions between these molecules.

The static graph corresponding to this molecular interaction network is given here by way of example in two forms:
Scheme (FIG. 2). On this scheme, each rectangle represents a protein. The letters in the rectangle are the usual abbreviations for the protein name, using the KEGG and SGD nomenclature: Saccharomyces Genome Database, developed by the Department of Genetics at the School of Medicine, Stanford University, USA.
Table representing the molecular interactions (Table 5 below).

This table presents the static graph data in a form which is directly usable by an informatics system for modeling and simulating as described in the invention.

TABLE 5
Representation of graph in the form of a table.

| A | A | B | B | |
|---|---|---|---|---|
| ORF code | Abbreviation | ORF code | Abbreviation | Direction |
| YKL106W | AAT1 | YNR001C | CIT1 | A-B |
| YKL106W | AAT1 | YCR005C | CIT2 | A-B |
| YBL015W | ACH1 | YMR170C | ALD2 | A-B |
| YBL015W | ACH1 | YMR169C | ALD3 | A-B |
| YBL015W | ACH1 | YPL061W | ALD6 | A-B |
| YLR304C | ACO1 | YER065C | ICL1 | A-B |
| YLR304C | ACO1 | YNL037C | IDH1 | A-B |
| YLR304C | ACO1 | YOR136W | IDH2 | A-B |
| YLR304C | ACO1 | YDL066W | IDP1 | A<->B |
| YLR304C | ACO1 | YLR174W | IDP2 | A<->B |
| YAL054C | ACS1 | YBL015W | ACH1 | A-B |
| YAL054C | ACS1 | YNR001C | CIT1 | A<->B |
| YAL054C | ACS1 | YCR005C | CIT2 | A<->B |
| YAL054C | ACS1 | YIR031C | DAL7 | A-B |
| YAL054C | ACS1 | YNL117W | MLS1 | A-B |
| YAL054C | ACS1 | YNL071W | PDA2 | A<->B |
| YAL054C | ACS1 | YLR044C | PDC1 | A<->B |
| YAL054C | ACS1 | YLR134W | PDC5 | A<->B |
| YAL054C | ACS1 | YGR087C | PDC6 | A<->B |
| YAL054C | ACS1 | YAL038W | PYK1 | A<->B |
| YAL054C | ACS1 | YOR347C | PYK2 | A<->B |
| YLR153C | ACS2 | YBL015W | ACH1 | A-B |
| YLR153C | ACS2 | YNR001C | CIT1 | A<->B |
| YLR153C | ACS2 | YCR005C | CIT2 | A<->B |
| YLR153C | ACS2 | YIR031C | DAL7 | A-B |
| YLR153C | ACS2 | YNL117W | MLS1 | A-B |
| YLR153C | ACS2 | YNL071W | PDA2 | A<->B |
| YLR153C | ACS2 | YLR044C | PDC1 | A<->B |
| YLR153C | ACS2 | YLR134W | PDC5 | A<->B |
| YLR153C | ACS2 | YGR087C | PDC6 | A<->B |
| YLR153C | ACS2 | YAL038W | PYK1 | A<->B |
| YLR153C | ACS2 | YOR347C | PYK2 | A<->B |
| YOL086C | ADH1 | YMR170C | ALD2 | A-B |
| YOL086C | ADH1 | YMR169C | ALD3 | A-B |
| YOL086C | ADH1 | YPL061W | ALD6 | A-B |
| YOL086C | ADH1 | YHL032C | GUT1 | A-B |
| YMR303C | ADH2 | YMR170C | ALD2 | A-B |
| YMR303C | ADH2 | YMR169C | ALD3 | A-B |
| YMR303C | ADH2 | YPL061W | ALD6 | A-B |
| YMR303C | ADH2 | YHL032C | GUT1 | A-B |
| YBR145W | ADH5 | YMR170C | ALD2 | A-B |
| YBR145W | ADH5 | YMR169C | ALD3 | A-B |
| YBR145W | ADH5 | YPL061W | ALD6 | A-B |
| YBR145W | ADH5 | YHL032C | GUT1 | A-B |
| YDR216W | ADR1 | YOL086C | ADH1 | A-B |
| YDR216W | ADR1 | YMR303C | ADH2 | A-B |
| YMR170C | ALD2 | YAL054C | ACS1 | A<->B |
| YMR170C | ALD2 | YLR153C | ACS2 | A<->B |
| YMR169C | ALD3 | YAL054C | ACS1 | A<->B |
| YMR169C | ALD3 | YLR153C | ACS2 | A<->B |
| YPL061W | ALD6 | YAL054C | ACS1 | A<->B |
| YPL061W | ALD6 | YLR153C | ACS2 | A<->B |
| YPR026W | ATH1 | YCL040W | GLK1 | A-B |
| YDR423C | CAD1 | YBR126C | TPS1 | A-B |
| YDR423C | CAD1 | YDR074W | TPS2 | A-B |
| YAL021C | CCR4 | YMR303C | ADH2 | A-B |
| YNR001C | CIT1 | YLR304C | ACO1 | A<->B |
| YCR005C | CIT2 | YLR304C | ACO1 | A<->B |
| YML054C | CYB2 | YER178W | PDA1 | A-B |
| YML054C | CYB2 | YBR221C | PDB1 | A-B |
| YIR031C | DAL7 | YKL085W | MDH1 | A-B |
| YIR031C | DAL7 | YOL126C | MDH2 | A-B |
| YIR031C | DAL7 | YDL078C | MDH3 | A-B |
| YDL174C | DLD1 | YER178W | PDA1 | A-B |
| YDL174C | DLD1 | YBR221C | PDB1 | A-B |
| YGR254W | ENO1 | YKL152C | GPM1 | A<->B |
| YGR254W | ENO1 | YDL021W | GPM2 | A<->B |
| YGR254W | ENO1 | YAL038W | PYK1 | A-B |
| YGR254W | ENO1 | YOR347C | PYK2 | A-B |
| YHR174W | ENO2 | YKL152C | GPM1 | A<->B |
| YHR174W | ENO2 | YDL021W | GPM2 | A<->B |
| YHR174W | ENO2 | YAL038W | PYK1 | A-B |
| YHR174W | ENO2 | YOR347C | PYK2 | A-B |
| YDR261C | EXG2 | YIL162W | SUC2 | A-B |
| YDR261C | EXG2 | YCL040W | GLK1 | A-B |
| YDR261C | EXG2 | YFR053C | HXK1 | A-B |
| YKL060C | FBA1 | YLR377C | FBP1 | A-B |
| YKL060C | FBA1 | YDR050C | TPI1 | A<->B |
| YLR377C | FBP1 | YGR240C | PFK1 | A<->B |
| YLR377C | FBP1 | YMR205C | PFK2 | A<->B |
| YLR377C | FBP1 | YBR196C | PGI1 | A-B |
| YJL155C | FBP26 | YGR240C | PFK1 | A-B |
| YJL155C | FBP26 | YMR205C | PFK2 | A-B |
| YJL155C | FBP26 | YER003C | PMI40 | A-B |
| YPL262W | FUM1 | YKL085W | MDH1 | A<->B |
| YPL262W | FUM1 | YOL126C | MDH2 | A<->B |
| YPL262W | FUM1 | YDL078C | MDH3 | A<->B |
| YBR020W | GAL1 | YBR018C | GAL7 | A-B |
| YBR019C | GAL10 | YKL035W | UGP1 | A-B |
| YPL248C | GAL4 | YMR105C | PGM2 | A-B |
| YBR018C | GAL7 | YBR019C | GAL10 | A-B |
| YPL075W | GCR1 | YOL086C | ADH1 | A-B |
| YPL075W | GCR1 | YGR254W | ENO1 | A-B |
| YPL075W | GCR1 | YHR174W | ENO2 | A-B |
| YPL075W | GCR1 | YKL152C | GPM1 | A-B |
| YEL011W | GLC3 | YPR160W | GPH1 | A<->B |
| YEL011W | GLC3 | YBR299W | MAL32 | A-B |
| YCL040W | GLK1 | YBR196C | PGI1 | A<->B |
| YDR272W | GLO2 | YML054C | CYB2 | A-B |
| YDR272W | GLO2 | YDL174C | DLD1 | A-B |
| YGR256W | GND2 | YOR095C | RKI1 | A-B |
| YGR256W | GND2 | YJL121C | RPE1 | A-B |
| YPR160W | GPH1 | YKL035W | UGP1 | A-B |
| YPR160W | GPH1 | YBR299W | MAL32 | A-B |
| YPR160W | GPH1 | YKL127W | PGM1 | A-B |
| YPR160W | GPH1 | YMR105C | PGM2 | A-B |
| YKL152C | GPM1 | YCR012W | PGK1 | A<->B |
| YDL021W | GPM2 | YCR012W | PGK1 | A<->B |
| YGR032W | GSC2 | YDR261C | EXG2 | A-B |
| YFR015C | GSY1 | YEL011W | GLC3 | A-B |
| YLR258W | GSY2 | YEL011W | GLC3 | A-B |
| YBL021C | HAP3 | YNR001C | CIT1 | A-B |
| YBL021C | HAP3 | YKL148C | SDH1 | A-B |
| YBL021C | HAP3 | YKL141W | SDH3 | A-B |
| YBL021C | HAP3 | YIL125W | KGD1 | A-B |
| YBL021C | HAP3 | YDR148C | KGD2 | A-B |
| YKL109W | HAP4 | YNR001C | CIT1 | A-B |
| YKL109W | HAP4 | YKL148C | SDH1 | A-B |
| YKL109W | HAP4 | YKL141W | SDH3 | A-B |
| YKL109W | HAP4 | YIL125W | KGD1 | A-B |
| YKL109W | HAP4 | YDR148C | KGD2 | A-B |
| YKL109W | HAP4 | YFL018C | LPD1 | A-B |
| YFR053C | HXK1 | YGR240C | PFK1 | A-B |
| YFR053C | HXK1 | YMR205C | PFK2 | A-B |
| YFR053C | HXK1 | YIL107C | PFK26 | A-B |
| YFR053C | HXK1 | YBR196C | PGI1 | A-B |
| YGL253W | HXK2 | YGR240C | PFK1 | A-B |
| YGL253W | HXK2 | YMR205C | PFK2 | A-B |
| YGL253W | HXK2 | YIL107C | PFK26 | A-B |
| YER065C | ICL1 | YIR031C | DAL7 | A-B |
| YER065C | ICL1 | YNL117W | MLS1 | A-B |
| YNL037C | IDH1 | YIL125W | KGD1 | A-B |
| YOR136W | IDH2 | YIL125W | KGD1 | A-B |
| YDL066W | IDP1 | YIL125W | KGD1 | A-B |
| YLR174W | IDP2 | YIL125W | KGD1 | A-B |
| YIL125W | KGD1 | YDR148C | KGD2 | A-B |
| YDR148C | KGD2 | YFL018C | LPD1 | A<->B |
| YDR148C | KGD2 | YGR244C | LSC2 | A<->B |
| YFL018C | LPD1 | YMR189W | GCV2 | A-B |
| YFL018C | LPD1 | YIL125W | KGD1 | A-B |
| YFL018C | LPD1 | YER178W | PDA1 | A-B |
| YFL018C | LPD1 | YBR221C | PDB1 | A<->B |
| YBR299W | MAL32 | YCL040W | GLK1 | A-B |
| YBR299W | MAL32 | YFR053C | HXK1 | A-B |
| YBR299W | MAL32 | YBR196C | PGI1 | A-B |
| YKL085W | MDH1 | YNR001C | CIT1 | A<->B |
| YKL085W | MDH1 | YCR005C | CIT2 | A<->B |
| YKL085W | MDH1 | YKR097W | PCK1 | A<->B |
| YKL085W | MDH1 | YGL062W | PYC1 | A<->B |
| YKL085W | MDH1 | YBR218C | PYC2 | A<->B |
| YOL126C | MDH2 | YNR001C | CIT1 | A<->B |
| YOL126C | MDH2 | YCR005C | CIT2 | A<->B |
| YOL126C | MDH2 | YKR097W | PCK1 | A<->B |
| YOL126C | MDH2 | YGL062W | PYC1 | A<->B |
| YOL126C | MDH2 | YBR218C | PYC2 | A<->B |
| YDL078C | MDH3 | YNR001C | CIT1 | A<->B |
| YDL078C | MDH3 | YCR005C | CIT2 | A<->B |
| YDL078C | MDH3 | YKR097W | PCK1 | A<->B |
| YDL078C | MDH3 | YGL062W | PYC1 | A<->B |
| YDL078C | MDH3 | YBR218C | PYC2 | A<->B |
| YNL117W | MLS1 | YKL085W | MDH1 | A-B |
| YNL117W | MLS1 | YOL126C | MDH2 | A-B |
| YNL117W | MLS1 | YDL078C | MDH3 | A-B |
| YMR037C | MSN2 | YMR170C | ALD2 | A-B |
| YMR037C | MSN2 | YMR169C | ALD3 | A-B |
| YMR037C | MSN2 | YCL040W | GLK1 | A-B |
| YMR037C | MSN2 | YFR053C | HXK1 | A-B |
| YMR037C | MSN2 | YMR105C | PGM2 | A-B |
| YMR037C | MSN2 | YBR117C | TKL2 | A-B |
| YMR037C | MSN2 | YBR126C | TPS1 | A-B |
| YMR037C | MSN2 | YDR074W | TPS2 | A-B |
| YKL062W | MSN4 | YMR170C | ALD2 | A-B |
| YKL062W | MSN4 | YMR169C | ALD3 | A-B |
| YKL062W | MSN4 | YCL040W | GLK1 | A-B |
| YKL062W | MSN4 | YFR053C | HXK1 | A-B |
| YKL062W | MSN4 | YMR105C | PGM2 | A-B |
| YKL062W | MSN4 | YBR117C | TKL2 | A-B |
| YKL062W | MSN4 | YBR126C | TPS1 | A-B |
| YKL062W | MSN4 | YDR074W | TPS2 | A-B |
| YDR001C | NTH1 | YCL040W | GLK1 | A-B |
| YDR001C | NTH1 | YBR196C | PGI1 | A-B |
| YBR001C | NTH2 | YBR196C | PGI1 | A-B |
| YBR001C | NTH2 | YCL040W | GLK1 | A-B |
| YKR097W | PCK1 | YNR001C | CIT1 | A<->B |
| YKR097W | PCK1 | YCR005C | CIT2 | A<->B |
| YKR097W | PCK1 | YAL038W | PYK1 | A-B |
| YKR097W | PCK1 | YOR347C | PYK2 | A-B |
| YKR097W | PCK1 | YGR254W | ENO1 | A<->B |
| YKR097W | PCK1 | YHR174W | ENO2 | A<->B |
| YER178W | PDA1 | YNL071W | PDA2 | A-B |
| YNL071W | PDA2 | YNR001C | CIT1 | A<->B |
| YNL071W | PDA2 | YCR005C | CIT2 | A<->B |
| YNL071W | PDA2 | YIR031C | DAL7 | A-B |
| YNL071W | PDA2 | YFL018C | LPD1 | A-B |
| YNL071W | PDA2 | YNL117W | MLS1 | A-B |
| YBR221C | PDB1 | YNL071W | PDA2 | A-B |
| YLR044C | PDC1 | YOL086C | ADH1 | A-B |
| YLR044C | PDC1 | YMR303C | ADH2 | A-B |
| YLR044C | PDC1 | YBR145W | ADH5 | A-B |
| YLR044C | PDC1 | YMR170C | ALD2 | A<->B |
| YLR044C | PDC1 | YMR169C | ALD3 | A<->B |
| YLR044C | PDC1 | YPL061W | ALD6 | A<->B |
| YLR134W | PDC5 | YOL086C | ADH1 | A-B |
| YLR134W | PDC5 | YMR303C | ADH2 | A-B |
| YLR134W | PDC5 | YBR145W | ADH5 | A-B |
| YLR134W | PDC5 | YMR170C | ALD2 | A<->B |
| YLR134W | PDC5 | YMR169C | ALD3 | A<->B |
| YLR134W | PDC5 | YPL061W | ALD6 | A<->B |
| YGR087C | PDC6 | YOL086C | ADH1 | A-B |
| YGR087C | PDC6 | YMR303C | ADH2 | A-B |
| YGR087C | PDC6 | YBR145W | ADH5 | A-B |
| YGR087C | PDC6 | YMR170C | ALD2 | A<->B |
| YGR087C | PDC6 | YMR169C | ALD3 | A<->B |
| YGR087C | PDC6 | YPL061W | ALD6 | A<->B |
| YGR240C | PFK1 | YKL060C | FBA1 | A-B |
| YGR240C | PEK1 | YLR377C | FBP1 | A<->B |
| YMR205C | PFK2 | YKL060C | FBA1 | A-B |
| YMR205C | PFK2 | YLR377C | FBP1 | A<->B |
| YIL107C | PFK26 | YJL155C | FBP26 | A<->B |
| YBR196C | PGI1 | YGR240C | PFK1 | A-B |
| YBR196C | PGI1 | YKL127W | PGM1 | A<->B |
| YBR196C | PGI1 | YMR105C | PGM2 | A<->B |
| YBR196C | PGI1 | YNL241C | ZWF1 | A-B |
| YCR012W | PGK1 | YJL052W | TDH1 | A-B |
| YCR012W | PGK1 | YJR009C | TDH2 | A-B |
| YCR012W | PGK1 | YGR192C | TDH3 | A<->B |
| YKL127W | PGM1 | YCL040W | GLK1 | A<->B |
| YKL127W | PGM1 | YFR053C | HXK1 | A-B |
| YKL127W | PGM1 | YGL253W | HXK2 | A-B |
| YKL127W | PGM1 | YKL035W | UGP1 | A<->B |
| YMR105C | PGM2 | YCL040W | GLK1 | A<->B |
| YMR105C | PGM2 | YFR053C | HXK1 | A-B |
| YMR105C | PGM2 | YGL253W | HXK2 | A-B |
| YMR105C | PGM2 | YKL035W | UGP1 | A<->B |
| YER003C | PMI40 | YCL040W | GLK1 | A-B |
| YER003C | PMI40 | YFL045C | SEC53 | A-B |
| YDL055C | PSA1 | YBL082C | RHK1 | A-B |
| YGL062W | PYC1 | YNR001C | CIT1 | A<->B |
| YGL062W | PYC1 | YCR005C | CIT2 | A<->B |
| YGL062W | PYC1 | YLR044C | PDC1 | A<->B |
| YGL062W | PYC1 | YLR134W | PDC5 | A<->B |
| YGL062W | PYC1 | YGR087C | PDC6 | A<->B |
| YBR218C | PYC2 | YNR001C | CIT1 | A<->B |
| YBR218C | PYC2 | YCR005C | CIT2 | A<->B |
| YBR218C | PYC2 | YLR044C | PDC1 | A<->B |
| YBR218C | PYC2 | YLR134W | PDC5 | A<->B |
| YBR218C | PYC2 | YGR087C | PDC6 | A<->B |
| YAL038W | PYK1 | YER178W | PDA1 | A-B |
| YAL038W | PYK1 | YBR221C | PDB1 | A-B |
| YAL038W | PYK1 | YLR044C | PDC1 | A<->B |
| YAL038W | PYK1 | YLR134W | PDC5 | A<->B |
| YAL038W | PYK1 | YGR087C | PDC6 | A<->B |
| YAL038W | PYK1 | YGL062W | PYC1 | A-B |
| YAL038W | PYK1 | YBR218C | PYC2 | A-B |
| YOR347C | PYK2 | YER178W | PDA1 | A-B |
| YOR347C | PYK2 | YBR221C | PDB1 | A-B |
| YOR347C | PYK2 | YLR044C | PDC1 | A<->B |
| YOR347C | PYK2 | YLR134W | PDC5 | A<->B |
| YOR347C | PYK2 | YGR087C | PDC6 | A<->B |
| YOR347C | PYK2 | YGL062W | PYC1 | A-B |
| YOR347C | PYK2 | YBR218C | PYC2 | A-B |
| YNL216W | RAP1 | YGR254W | ENO1 | A-B |
| YNL216W | RAP1 | YHR174W | ENO2 | A-B |
| YOR095C | RKI1 | YKL127W | PGM1 | A-B |
| YOR095C | RKI1 | YMR105C | PGM2 | A-B |
| YOR095C | RKI1 | YCR036W | RBK1 | A-B |
| YOR095C | RKI1 | YBR117C | TKL2 | A-B |
| YJL121C | RPE1 | YBR117C | TKL2 | A-B |
| YOL067C | RTG1 | YLR304C | ACO1 | A-B |
| YOL067C | RTG1 | YNR001C | CIT1 | A-B |
| YOL067C | RTG1 | YCR005C | CIT2 | A-B |
| YOL067C | RTG1 | YNL037C | IDH1 | A-B |
| YOL067C | RTG1 | YOR136W | IDH2 | A-B |
| YBL103C | RTG3 | YLR304C | ACO1 | A-B |
| YBL103C | RTG3 | YNR001C | CIT1 | A-B |
| YBL103C | RTG3 | YCR005C | CIT2 | A-B |
| YBL103C | RTG3 | YNL037C | IDH1 | A-B |
| YBL103C | RTG3 | YOR136W | IDH2 | A-B |
| YFL045C | SEC53 | YDL055C | PSA1 | A-B |
| YDL168W | SFA1 | YDR272W | GLO2 | A-B |
| YOL004W | SIN3 | YOL086C | ADH1 | A-B |
| YOL004W | SIN3 | YMR303C | ADH2 | A-B |
| YOL004W | SIN3 | YBR145W | ADH5 | A-B |
| YOR290C | SNF2 | YOL086C | ADH1 | A-B |
| YOR290C | SNF2 | YMR303C | ADH2 | A-B |
| YOR290C | SNF2 | YBR145W | ADH5 | A-B |
| YCR073W-A | Sol2 | YGR256W | GND2 | A-B |
| YBR112C | SSN6 | YCR005C | CIT2 | A-B |
| YBR112C | SSN6 | YER065C | ICL1 | A-B |
| YBR112C | SSN6 | YIL162W | SUC2 | A-B |
| YIL162W | SUC2 | YBR196C | PGI1 | A<->B |
| YIL162W | SUC2 | YKL127W | PGM1 | A<->B |
| YIL162W | SUC2 | YMR105C | PGM2 | A<->B |
| YPL016W | SWI1 | YOL086C | ADH1 | A-B |
| YPL016W | SWI1 | YMR303C | ADH2 | A-B |
| YPL016W | SWI1 | YBR145W | ADH5 | A-B |
| YJL052W | TDH1 | YKL060C | FBA1 | A-B |
| YJL052W | TDH1 | YDR050C | TPI1 | A-B |
| YJR009C | TDH2 | YKL060C | FBA1 | A-B |
| YJR009C | TDH2 | YDR050C | TPI1 | A-B |
| YGR192C | TDH3 | YKL060C | FBA1 | A<->B |
| YGR192C | TDH3 | YDR050C | TPI1 | A<->B |
| YBR117C | TKL2 | YGR240C | PFK1 | A-B |
| YBR117C | TKL2 | YMR205C | PFK2 | A-B |
| YBR117C | TKL2 | YBR196C | PGI1 | A-B |
| YDR050C | TPI1 | YKL060C | FBA1 | A<->B |
| YBR126C | TPS1 | YDR074W | TPS2 | A-B |
| YDR074W | TPS2 | YPR026W | ATH1 | A-B |
| YDR074W | TPS2 | YDR001C | NTH1 | A-B |
| YDR074W | TPS2 | YBR001C | NTH2 | A-B |
| YML100W | TSL1 | YDR074W | TPS2 | A-B |
| YOR344C | TYE7 | YOL086C | ADH1 | A-B |
| YOR344C | TYE7 | YHR174W | ENO2 | A-B |
| YKL035W | UGP1 | YGR032W | GSC2 | A-B |
| YKL035W | UGP1 | YFR015C | GSY1 | A-B |
| YKL035W | UGP1 | YLR258W | GSY2 | A-B |
| YKL035W | UGP1 | YBR299W | MAL32 | A-B |
| YKL035W | UGP1 | YKL127W | PGM1 | A<->B |
| YKL035W | UGP1 | YBR126C | TPS1 | A-B |
| YKL035W | UGP1 | YML100W | TSL1 | A-B |
| YNL241C | ZWF1 | YCR073W-A | Sol2 | A-B |
| YKL148C | SDH1 | YPL262W | FUM1 | A<->B |
| YLL041C | SDH2 | YPL262W | FUM1 | A<->B |
| YKL141W | SDH3 | YPL262W | FUM1 | A<->B |
| YDR178W | SDH4 | YPL262W | FUM1 | A<->B |
| YGR244C | LSC2 | YKL148C | SDH1 | A<->B |
| YGR244C | LSC2 | YLL041C | SDH2 | A<->B |
| YGR244C | LSC2 | YKL141W | SDH3 | A<->B |
| YGR244C | LSC2 | YDR178W | SDH4 | A<->B |

The graph represents the 329 interactions between the 116 molecules of the network. The interactions are shown between the molecules in pairs.

Columns A: first molecule

Columns B: second molecule

Direction: direction of interaction
A-B: from A to B
B-A: from B to A

A<−>B: interaction in both directions

This table also establishes the correspondence between ORF(open reading frame) codes from the SGD database (Dolinski K, Balakrishnan R, Christie KR, Constanzo MC, Dwight SS, Engel SR, Fisk D G, Hirschman J E, Hong E L, Issel-Tarver L, Sethuraman A, Theesfeld C L, Binkley G, Lane C, Schroeder M, Dong S, Weng S, Andrada R, Botstein D and Cherry J M, “Saccharomyces Genome Database”:http://www.yeastgenome.org/), and the abbreviations for the names of the proteins (also from SGD). The ORF codes are unique for a given protein and can identify it without any ambiguity. They can also establish a non ambiguous link with the results of DNA array screenings (correspondence of nucleic sequences of corresponding messenger RNA). 2) Messenger RNA screening data on DNA arrays concerning the set of these genes were captured from the publication: DeRisi JL, Iyer V R, Brown P O: Exploring the metabolic and genetic control of gene expression on a genomic scale, Science 1997, Oct 24;278(5338):680-6.

This publication describes a yeast culture experiment under conditions in which the glucose concentration in the culture medium reduced progressively (because it was used up by yeasts for fermentation, glucose not being added to the culture at any time of the experiment). Over time, the yeasts exhibited a modification of their metabolism, their respiratory system passing from a fermentation function to an aerobic respiration function.

This yest culture ws studied through time, in particular by carrying out expression screening of almost all of the yeast messenger RNA on DNA arrays. These screenings were carried out at successive times, the results thus producing a kinetic picture of the expression for each messenger RNA. The results show the variations in the expression of a certain number of messenger RNAs over time, these being particular numerous among messenger RNAs for proteins for cellular respiration, a large portion of which is represented in the graph described above. Under these experimental conditions, the graph which is represented by the kinetics of the molecules of the network (i.e. the vertices of the graph).

It will be clear to the reader that the static graph is already too large in size and thus has too many interactions and loops to allow even an expert to correctly predict, from a single static graph, its dynamic evolution as observed experimentally without employing a suitable dynamic modeling method.

The set of experimental data for screening messenger RNA expression on DNA arrays corresponding to this article are available on Stanford University's internet site at the following address: http://cmgm.stanford.edu/pbrown/explore/array.txt.

From these data, experimental data corresponding specifically to messenger RNA of the molecules of the graph were captured manually (copy-and-paste in a txt type spreadsheet) in the following form: each line corresponds to one molecule of the graph, the first column identifying the ORF (open reading frame) by its SGD code, the subsequent columns corresponding to the experimental measurements. Tables 6 to 8 below give examples of data for a few molecules of the graph, which data was extracted from the page at the following address http://cmgm.standord.edu/pbrown/explore/array.txt.

TABLE 6

| ORF | Name | G1-Bkg | G2-Bkg | G3-Bkg | G4-Bkg | G5-Bkg | G6-Bkg | G7-Bkg |
|---|---|---|---|---|---|---|---|---|
| YBR218C | PYC2 | 9361 | 7699 | 11731 | 5304 | 4702 | 6455 | 6056 |
| YCR005c | CIT2 | 1540 | 1244 | 1875 | 1727 | 1241 | 1904 | 1644 |

TABLE 7

| ORF | Name | R1-Bkg | R2-Bkg | R3-Bkg | R4-Bkg | R5-Bkg | R6-Bkg | R7-Bkg |
|---|---|---|---|---|---|---|---|---|
| YBR218C | PYC2 | 11070 | 9483 | 8998 | 3944 | 3739 | 4603 | 16293 |
| YCR005c | CIT2 | 1092 | 1138 | 2007 | 1328 | 695 | 3962 | 7997 |

TABLE 8

| ORF | Name | R1.Ratio | R2.Ratio | R3.Ratio | R4.Ratio | R5.Ratio | R6.Ratio | R7.Ratio |
|---|---|---|---|---|---|---|---|---|
| YBR218C | PYC2 | 1.18 | 1.23 | .77 | .75 | .79 | .71 | 2.7 |
| YCR005c | CIT2 | .71 | .92 | 1.08 | .77 | .56 | 2.08 | 4.76 |

TABLES 6 to 8 : Examples of screening data on DNA arrays for 2 molecules of the graph from results in the article: DERisi J L, Iyer V R, Brown P O: Exploring the metabolic and genetic control of gene expression on a genomic scale, Science, 1997, Oct 24;278(5338): 680-6.

The complete data are available at the following internet address: http://cmgm.standord.edu/pbrown/explore/array.txt. Because of the size of the complete table of data, only part of it has beenshown here. The skilled person could very easily recover data corresponding to other molecules of the graph used in this example, at the internet page which corresponds directly to the table for the whole set of the data.

Messenger RNA expression screening was carried out every two hours, for 12 hours, corresponding to 7 experimental points (the initial time plus the next 6 times). These correspond to notations 1 to 7 . the reader will find all explanations corresponding to obtaining these measurements in the article cited above as a reference.

Name=abbreviation of name of gene (in SGD)

ORF=open reading frame code (in SGD)

G=experimental condition corresponding to the “standard state” of the graph as described in the invention. This standard state, in this series of experiments, corresponds to the initial state of the yeast culture. G1, G2, G3, G4, G5, G6, G7 correspond to the same standard biological sample.

R=graph states at various experimental times.

R1 corresponds to the initial state of the yeast culture (same biological sample as G1), at time T0. R2: T0+2.5 hours, R3: T0+4 hours, R4: T0+6 hours, R5: T0+7.5 hours, R6: T0+9.5 hours, R7: T0+11.5 hours.

The series of values G-Bkg and R-Bkg correspond to absolute measurements of the signal. Compared with the present text, series G-Bkg corresponds to xᵢ₀ and series R-Bkg corresponds to x_{it.}

G1-Bkg=measurement of G1 minus background during experimental measurements.

G2-Bkg=measurement of G2 minus background during experimental measurements.

G3-Bkg=measurement of G3 minus background during experimental measurements.

G4-Bkg=measurement of G4 minus background during experimental measurements.

G5-Bkg=measurement of G5 minus background during experimental measurements.

G6-Bkg=measurement of G6 minus background during experimental measurements.

G7-Bkg=measurement of G7 minus background during experimental measurements.

The variations in the values measured are linked to variations in the yields of the various reactions employed in the measurement method (DNA arrays) and justify the use of a standard state as the reference measurement.

R1-Bkg=measurement of R1 minus background during experimental measurements.

R2-Bkg=measurement of R2 minus background during experimental measurements.

R3-Bkg=measurement of R3 minus background during experimental measurements.

R4-Bkg=measurement of R4 minus background during experimental measurements.

R5-Bkg=measurement of R5 minus background during experimental measurements.

R6-Bkg=measurement of R6 minus background during experimental measurements.

R7-Bkg=measurement of R7 minus background during experimental measurements.

R1.Ratio, R2.Ratio, R3.Ratio, R4.Ratio, R5.Ratio, R6.Ratio, R7.Ratio, correspond to the ratios R-Bkg/G-Bkg at each of the 7 experimental times: they correspond to the variables as defined in the description of the invention: Xᵢ=xᵢₜ/x_{0.}

Thus, two tables were produced in the form of txt type spreadsheets with a mutual link via the ORF code of each molecule. In this example, it was not necessary to use a database system.

Implementation of the method

Steps A and B were carried out as follows:

The experimental data was smoothed to provide more time points.

It was assumed that if the concentration of glucose in the yeast culture medium had remained constant by supplementing the culture medium with glucose, the initial state, which corresponded to the experimental measurements at time TO, would be a stable state. This is in agreement with available experimental data and with the text of the publication from which the data was extracted.

Further, it is known that if the yeast culture is again supplemented with glucose after time 7(+12 hours), it will return to its initial state. A final graph state was thus defined as follows: tendency of biological system being studied to return to its initial state at time T₀ +36 hours, and the experimental data obtained at T₀ were replicated at this time. This was carried out to add a constraint, logical as regards the experiment, during computing of the parameters of the functions. This should not however be considered as an indispensable step in the invention, but as an example of defining stable states of the biological system from the example cited above.

The relationship used between the variables Xᵢ corresponding to molecule i and variables Xⱼ corresponding to molecules j interacting on i was as follows:
(dXᵢ/dt)=K₁ᵢ·[1/(1+e^{-Σwij·Xj-bi})]−K₂ᵢ·Xᵢ

The parameters were computed from experimental data using a conventional method for learning neural networks, more precisely from algorithms from the Runge Kutta back propagation through time method (BPTT). Double-precision computations were carried out.

The remainder of the methods used, which would not pose any particular difficulty to the skilled person, were carried out as described above.

A dynamic graph, entirely deterministic, was then obtained, allowing simulations to be produced.

Results

During simulations, the efficacy of the method was verified. The mean divergence results (overall relative error) of simulations with respect to with experimental data was about 0.30, this divergence essentially being concentrated over 8 vertices (molecules) of the graph for this series of data, while for the remaining 108 vertices (molecules), the divergence was very small.

This overall relative error result shows that the computed kinetics during simulations are close to the actual data, as random kinetics would have produced an error computation of more than 1.

The overall divergence of simulations with respect to experimental data over the whole of the graph and the set of kinetics was estimated by the following relative error computation:

Overall relative error

$$√ [ {\sum }_{i} {\sum }_{t} {( {X}_{1 i} ( t ) - {X}_{2 i} ( t ) )}^{2} / {\sum }_{i} {\sum }_{t} {( {X}_{2 i} ( t ) )}^{2} ]$$

√=square root of term between brackets: [];

X₁ᵢ(t)=value of Xᵢ computed at time t of the simulation;

X₂ᵢ(t)=value of Xᵢ measured experimentally at time t.

$${\sum }_{t} = sum of values at different times$$

This simulation result was satisfactory, even more so if the errors in the measurements are taken into account, since it is slightly smaller than the errors in the measurements during experiments which have served to generate experimental data on DNA arrays.

The degree of non-reproducibility of the experimental data may be estimated by the ratio R1 Ratio of the experimental data (Table 8), and is overall 14% in this example.

This overall divergence result is obtained by a relative error computation allowing a comparison of two kinetics (or trajectories) in their whole. It cannot, of course, be used to estimate the degree of non-reproducibility of the experimental data since only a single experimental kinetic datum was available, for these experimental conditions, for each molecule of the network. Computing this degree of non-reproducibility was thus carried out using the mean of the rations R1.

The fact that these two error computations were different does not allow them to be compared directly in the strict sense. However, it can be seen that the overall relative error of the simulations and the degree of non reproducibility of the experimental measurements are close: 0.3 and 0.14 respectively, 1 being the threshold above which the simulations and the measurements may be considered to be non reliable.

Although it is possible by the method of the invention to drop during simulations to a divergence result which is lower than the non reproducibility ratio of the experimental data, it is clearly useless to drop to a divergence result which is lower than this limit of reproducibility of the experimental data, regardless of what they are. Clearly, since experimental data are used to compute the parameters, this amounts to assuming a risk of divergence as regards the real biological phenomenon being studied, wherein the divergence as regards experimental measurements may be estimated to be equal to the degree of non reproducibility of the measurement experiments, without being able to predict the direction of this divergence (which may also vary as a function of the molecules of the network).

As an example, Table 9 provides details of the divergences of the set of kinetics during simulations for all of the molecules of the network, in the form of a table.

TABLE 9
Table of divergences during simulations for all of the molecules of the network
Relative errors molecule-by-molecule during simulations

| ORF | | ORF | | ORF | | ORF | |
|---|---|---|---|---|---|---|---|
| code | Error | code | Error | code | Error | code | Error |
| YKL106W | 0.439906 | YMR170C | 0.658778 | YDL021W | 0.356443 | YNL241C | 0.238029 |
| YNR001C | 0.557923 | YIR031C | 0.287518 | YNL216W | 0.330334 | YBR299W | 0.223996 |
| YCR005C | 0.603893 | YNL117W | 0.555319 | YOR344C | 0.345711 | YGR240C | 0.656938 |
| YLR304C | 0.611941 | YMR169C | 0.323143 | YMR105C | 0.477063 | YIL107C | 0.440545 |
| YAL054C | 0.719416 | YLR044C | 0.548165 | YDR261C | 0.20506 | YMR205C | 0.45229 |
| YNL071W | 0.322178 | YER178W | 0.171016 | YKL127W | 0.298067 | YER003C | 0.366261 |
| YLR153C | 0.368722 | YBR221C | 0.19549 | YBR196C | 0.376657 | YPR026W | 0.436716 |
| YKL085W | 0.499697 | YFL018C | 0.173079 | YHL032C | 0.450714 | YJL121C | 0.371399 |
| YOL126C | 0.80045 | YPL262W | 0.519434 | YDR216W | 0.434734 | YDR423C | 0.266008 |
| YDL078C | 0.348449 | YKL148C | 0.471327 | YOL004W | 0.104797 | YML100W | 0.411204 |
| YBL021C | 0.137275 | YKL141W | 0.501865 | YOR290C | 0.13138 | YDL168W | 0.144725 |
| YKL109W | 0.558143 | YIL125W | 0.593086 | YPL016W | 0.0833654 | YGR192C | 0.274425 |
| YKR097W | 0.594474 | YDR148C | 0.449052 | YAL021C | 0.104898 | YJR009C | 0.821626 |
| YGL062W | 0.617472 | YHR174W | 0.422694 | YFR053C | 0.563052 | YJL052W | 1.04515 |
| YBR218C | 0.519166 | YGR254W | 0.194786 | YCL040W | 0.330382 | YEL011W | 0.540345 |
| YOL067C | 0.0981591 | YIL162W | 0.58694 | YBR117C | 0.503985 | YCR036W | 0.272221 |
| YBL103C | 0.255736 | YOL086C | 0.310685 | YBR126C | 0.401095 | YGR256W | 0.448943 |
| YBR112C | 0.219397 | YBR145W | 0.156328 | YDR074W | 0.401062 | YFR015C | 0.492893 |
| YER065C | 0.592483 | YMR303C | 0.309401 | YDR272W | 0.568757 | YLR258W | 0.481474 |
| YNL037C | 0.452065 | YMR037C | 0.660788 | YCR012W | 0.612743 | YBR019C | 0.367005 |
| YOR136W | 0.156624 | YKL062W | 0.219838 | YPL248C | 0.176129 | YKL060C | 1.27125 |
| YDL066W | 0.188101 | YDL174C | 0.252933 | YGL253W | 0.461389 | YCR073W-A | 0.383641 |
| YLR174W | 0.559782 | YML054C | 0.596073 | YPR160W | 0.162637 | YJL155C | 0.394901 |
| YBL015W | 0.517625 | YMR189W | 0.0996465 | YOR095C | 0.368831 | YFL045C | 0.474401 |
| YLR134W | 0.526367 | YLL041C | 0.478881 | YKL035W | 0.360385 | YDR050C | 1.05587 |
| YGR087C | 0.553019 | YDR178W | 0.41253 | YGR032W | 0.240247 | YBR018C | 0.395082 |
| YAL038W | 0.60519 | YGR244C | 0.383062 | YLR377C | 0.35616 | YDL055C | 0.436756 |
| YOR347C | 0.296306 | YPL075W | 0.327211 | YDR001C | 0.371987 | YBR020W | 0.163797 |
| YPL061W | 0.547283 | YKL152C | 0.427984 | YBR001C | 0.41725 | YBL082C | 0.217509 |

The divergences were estimated for each molecule of the network by computation of the relative error over the whole of the trajectory of the molecule concerned using the following formula (local relative error):

$$√ [ {\sum }_{t} {( {X}_{1 i} ( t ) - {X}_{2 i} ( t ) )}^{2} / {\sum }_{t} {( {X}_{2 i} ( t ) )}^{2} ]$$

X₁ᵢ(t)=value of Xᵢ computed at time t of the simulation;

X₂ᵢ(t)=value of Xᵢ measured experimentally at time t.

$${\sum }_{t} = sum of values at different times$$

√=square root of term between brackets: [];

This computation leads to a computation of the integral difference between the kinetic curves observed experimentally and the kinetics computed during simulations. It thus also concerns both the whole of the kinetics and the final state.

In a variation of this example, the modeling and simulations were carried out in the same manner as described above, and from the same biological data, with the following single modification during computation of the parameters by back propagation through time:

The variations associated with the vertices of the graph not receiving an arc or edge, i.e. corresponding to molecules not receiving an interaction (inputs on graph) were excluded from the overall error computation during learning, their values thus remaining fixed at the experimental values measured during this procedure. This was carried out:
to avoid simulating kinetics on these vertices during the gradient descent, which risks increasing the errors;
and as these vertices do not themselves receive inputs, their kinetics are de facto independent of the results of the computations of the parameters of the mathematical relationships linking the vertices.

In other words, only molecules receiving at least one interaction (edge orientated towards the vertex of the graph corresponding thereto) were taken into account for the error computation during learning.

In order to avoid any confusion, this variation does not of course consist of removing input vertices from the graph, but of requiring that their kinetics remain the experimentally measured kinetics, only during simulations carried out during the error computations of the procedure for computing parameters by back propagation through time. The parameters of the mathematical relationships linking these vertices to other vertices of the graph are thus computed, like all of the other vertices of the graph, and the dynamic model finally obtained includes these vertices.

In this variation, the simulation results obtained were similar to those shown above, and even slightly better.

FIG. 3 shows by way of example the experimentally measured kinetics and the kinetics computed by simulation for several representative genes of the set of results obtained by carrying out this variation.

### EXAMPLE 5

### Modeling, simulations and validation of predictive capacity from a static graph of 133 molecules

This example shows the use of the whole method (steps A and B or A′, then C, D, E) and its predictive efficacy in an application similar to an identification/selection of therapeutic targets.

Biological data used

1) A static graph corresponding to a molecular interaction network in yeast (Saccharomyces cerevisiae, a living organism which may be considered to be a biological system satisfying the complexity criteria cited above) was constructed using the same principles discussed in Example 4. More particularly, this graph includes the graph of Example 4, but with supplementary molecules and interactions. It comprises 133 molecules, enzymes or transcription factors. It comprises 407 uni- or bi-directional interactions between these molecules.

The static graph corresponding to this molecular interaction network is given here by way of example in two forms:
Chart (FIG. 4). The representation principles and explanatory commentaries are the same as for Example 4 (FIG. 2).

Table representing the additional molecular interactions over the static graph of Example 4 (Table 10 below). The complete table representing the static graph used in this Example 5 is thus the sum of Tables 5 and 10.

TABLE 10
Additional molecular interactions over the static graph of Example 4.

| A | A | B | B | |
|---|---|---|---|---|
| ORF code | Abbreviation | ORF code | Abbreviation | Direction |
| [symbol] | [symbol] | [symbol] | [symbol] | [symbol] |
| YKL112W | ABF1 | YAL054C | ACS1 | A-B |
| Acetate | Acetate | YBL015W | ACH1 | A-B |
| Acetate | Acetate | YLR304C | ACO1 | A-B |
| Acetate | Acetate | YAL054C | ACS1 | A-B |
| Acetate | Acetate | YLR153C | ACS2 | A-B |
| Acetate | Acetate | YMR170C | ALD2 | A-B |
| Acetate | Acetate | YMR169C | ALD3 | A-B |
| Acetate | Acetate | YPL061W | ALD6 | A-B |
| Acetate | Acetate | YNR001C | CIT1 | A-B |
| Acetate | Acetate | YCR005C | CIT2 | A-B |
| YDR216W | ADR1 | YAL054C | ACS1 | A-B |
| YDR216W | ADR1 | YHL032C | GUT1 | A-B |
| YMR280C | CAT8 | YAL054C | ACS1 | A-B |
| YMR280C | CAT8 | YMR303C | ADH2 | A-B |
| YMR280C | CAT8 | YPL061W | ALD6 | A-B |
| YMR280C | CAT8 | YCR005C | CIT2 | A-B |
| YMR280C | CAT8 | YDL174C | DLD1 | A-B |
| YMR280C | CAT8 | YLR377C | FBP1 | A-B |
| YMR280C | CAT8 | YER065C | ICL1 | A-B |
| YMR280C | CAT8 | YLR174W | IDP2 | A-B |
| YMR280C | CAT8 | YOL126C | MDH2 | A-B |
| YMR280C | CAT8 | YNL117W | MLS1 | A-B |
| YMR280C | CAT8 | YKR097W | PCK1 | A-B |
| Glucose | Glucose | YBR019C | GAL10 | A-B |
| Glucose | Glucose | YCL040W | GLK1 | A-B |
| Glucose | Glucose | YFR053C | HXK1 | A-B |
| Glucose | Glucose | YGL253W | HXK2 | A-B |
| Glucose | Glucose | YGL209W | MIG2 | A-B |
| Glucose | Glucose | YMR037C | MSN2 | A-B |
| Glucose | Glucose | YBR196C | PGI1 | A-B |
| Glucose | Glucose | YKL127W | PGM1 | A-B |
| Glucose | Glucose | YMR105C | PGM2 | A-B |
| Glucose | Glucose | YGL252C | RTG2 | A-B |
| Glucose | Glucose | YDR477W | SNF1 | A-B |
| Glucose | Glucose | YDL194W | SNF3 | A-B |
| Glutamate | Glutamate | YLR304C | ACO1 | A-B |
| Glutamate | Glutamate | YOL067C | RTG1 | A-B |
| Glutamate | Glutamate | YGL252C | RTG2 | A-B |
| Glutamate | Glutamate | YBL103C | RTG3 | A-B |
| YDR138W | HPR1 | YOL086C | ADH1 | A-B |
| YDR138W | HPR1 | YBR020W | GAL1 | A-B |
| YDR138W | HPR1 | YIL162W | SUC2 | A-B |
| YJR094C | IME1 | YJL106W | IME2 | A-B |
| YJR094C | IME1 | YDR207C | UME6 | A<->B |
| YJL106W | IME2 | YJR094C | IMEI | A-B |
| YGL035C | MIG1 | YBR020W | GAL1 | A-B |
| YGL035C | MIG1 | YPL248C | GAL4 | A-B |
| YGL035C | MIG1 | YCL040W | GLK1 | A-B |
| YGL035C | MIG1 | YFR053C | HXK1 | A-B |
| YGL035C | MIG1 | YGL035C | MIG1 | A-B |
| YGL035C | MIG1 | YBR112C | SSN6 | A-B |
| YGL035C | MIG1 | YIL162W | SUC2 | A-B |
| YGL209W | MIG2 | YCL040W | GLK1 | A-B |
| YGL209W | MIG2 | YFR053C | HXK1 | A-B |
| YGL209W | MIG2 | YGL035C | MIG1 | A-B |
| YGL209W | MIG2 | YBR112C | SSN6 | A-B |
| YGL209W | MIG2 | YIL162W | SUC2 | A-B |
| YER028C | MIG3 | YIL162W | SUC2 | A-B |
| YOL067C | RTG1 | YIL162W | SUC2 | A-B |
| YGL252C | RTG2 | YLR304C | ACO1 | A-B |
| YGL252C | RTG2 | YNR001C | CIT1 | A-B |
| YGL252C | RTG2 | YCR005C | CIT2 | A-B |
| YGL252C | RTG2 | YNL037C | IDH1 | A-B |
| YGL252C | RTG2 | YOR136W | IDH2 | A-B |
| YOL004W | SIN3 | YPL016W | SWI1 | A-B |
| YOL004W | SIN3 | YDR207C | UME6 | A-B |
| YDR477W | SNF1 | YDR216W | ADR1 | A-B |
| YDR477W | SNF1 | YMR280C | CAT8 | A-B |
| YDR477W | SNF1 | YGL035C | MIG1 | A-B |
| YDL194W | SNF3 | YOL067C | RTG1 | A-B |
| YBR112C | SSN6 | YCR084C | TUP1 | A<->B |
| YPL016W | SWI1 | YOR290C | SNF2 | A<->B |
| YCR084C | TUP1 | YBR020W | GAL1 | A-B |
| YCR084C | TUP1 | YIL162W | SUC2 | A-B |
| YDR207C | UME6 | YAL054C | ACS1 | A-B |
| YDR207C | UME6 | YPR160W | GPH1 | A-B |
| YML007W | YAP1 | YDR074W | TPS2 | A-B |
| YML007W | YAP1 | YNL241C | ZWF1 | A-B |
| [symbol] | [symbol] | [symbol] | [symbol] | [symbol] |

The comments regarding Table 10 are similar to those of Table 5. 2) RNA messenger screening data on DNA arrays concerning the set of these genes were captured from the publication described in Example 4 using the same principles: DeRisi J L, Iyer V R, Brown P O: Exploring the metabolic and genetic control of gene expression on a genomic scale, Science 1997, Oct 24; 278 (5338): 680-6.

Further, 3 metabolites were introduced into the 133 molecules of the network. In contrast to the other molecules of the network, these metabolites naturally did not have any corresponding messenger RNA. Their values are defined as follows:

Glucose

Its concentrations over time were measured by the authors of the publication, at the same times as those at which the messenger RNA expression measurements were made. The corresponding concentrations are shown graphically in FIG. 4 of the article cited above. T₀ express these values in the form of a ratio, each value of the glucose concentration in the culture medium at a given time was divided by the concentration of glucose at the initial time of the experiment (to measure the ratios with respect to the same reference as for the messenger RNA measurements, the ratios of which are expressed as the ratio of the measurement at time t divided by the measurement at the initial time). This variable associated with glucose corresponds well to the variables defined in the description of the invention: Xᵢ=x₁ₜ/x₀.

TABLE 11
Values for variable associated with a molecule in the graph: glucose
Molecule in network: Glucose

| | Experimental | | | | | | |
|---|---|---|---|---|---|---|---|
| | time (hours) | | | | | | |
| | 0 | 2.5 | 4 | 6 | 7.5 | 9.5 | 11.5 |
| Value | 1 | 0.97368 | 0.92105 | 0.73684 | 0.39473 | 0.01053 | 0.00052 |
| of ratio | | | | | | | |

The following values are obtained for the glucose variable:

Acetate and glutamate: the concentrations of these molecules were not measured by the authors. Thus it was decided to extrapolate values for these molecules from a knowledge of the biological system being studied and the description of the experiments in the article. Provided that this experiment is essentially founded on the progressive drop in the concentration of glucose in the culture medium and where the other parameters of the culture medium were to a first approximation considered to be constants, it was considered that the concentrations of glutamate and acetate, respectively, were constant during the experiment.

Operating with ratios thus allowed their values to be fixed using the same principles as with glucose:
Xᵢ=xᵢₜ/x₀,

Thus at the initial time (T0=0), Xᵢ₀=xᵢ₀/xᵢ₀=1

And, since the value of Xᵢ is considered to be constant over time, it remains equal to 1.

This produces the following table of values:

TABLE 12
Values of variables respectively associated with the graph molecule:
glutamate and graph molecule: acetate

| Experimental | | | | | | |
|---|---|---|---|---|---|---|
| time (hours) | | | | | | |
| 0 | 2.5 | 4 | 6 | 7.5 | 9.5 | 11.5 |

Molecule in network: Glutamate

| | | | | | | | |
|---|---|---|---|---|---|---|---|
| Value of | 1 | 1 | 1 | 1 | 1 | 1 | 1 |
| ratio | | | | | | | |

Molecule in network: Acetate

| | | | | | | | |
|---|---|---|---|---|---|---|---|
| Value of | 1 | 1 | 1 | 1 | 1 | 1 | 1 |
| ratio | | | | | | | |

Thus, two tables were produced in the form of txt type spreadsheets with a mutual link via the ORF code of each molecule (concerning proteins/messenger RNA) or the name of the molecule (concerning glucose, glutamate and acetate). In this example, it was not necessary to use the database.

Implementation of method

Steps A and B or step A′were carried out in a manner similar to Example 4:

The data were smoothed by linear extrapolation.

The initial state, which corresponds to the experimental measurements at time T0, was assumed to be a stable state if the culture medium was maintained constant by supplementing it with glucose.

In contrast to Example 4, a final graph state which would have corresponded to a return to the initial state following addition of glucose after time 7 (T0 +12 hours) was not defined. The only experimental data that had been used for the parameter computation were thus the data described in the article and presented at Stanford University's internet site at: http://cmgm.stanford.edu/pbrown/explore/array.txt and corresponding to the molecules of the network, with no extrapolation apart from that concerning the glucose, glutamate and acetate molecules described above.

As in Example 4, the relationship used between the variables Xᵢ corresponding to molecule i and the variables Xⱼ corresponding to molecules j interacting on i was as follows:
(dXᵢ/dt)=K₁ᵢ·[(1+eΣwij·Xj−bi)]−K₂ᵢ−Xᵢ

The learning step for the parameter computation was fixed at 16 minutes.

The parameter computation and the remainder of the methods were implemented as described in Example 4, resulting in the production of a dynamic graph, entirely deterministic, allowing simulations to be carried out.

Step C was carried out as follows:

The aim was to show the capacity of the method to predict a new result not used for the construction of a dynamic graph.

In the same article: DeRisi J L, Iyer V R, Brown P O: Exploring the metabolic and genetic control of gene expression on a genomic scale, Science 1997, Oct 24; 278 (5338): 680-6, the authors also carried out a messenger RNA expression screening of a genetically modified yeast strain in which the TUP 1 gene had been knocked out (deleted) (code of TUP 1 gene's ORF in SGD database: YCR084C) present in the 133 molecule static graph. These data were not used for the construction of the dynamic graph during steps A and B.

The conditions for culture and screening of this strain are amply described in the article, but for more clarity in the description of this example, the following points should be noted regarding the screening: the genetically modified strain was cultivated under the same culture conditions as the wild strain used for the remainder of the experiments, in the presence of glucose, which corresponded for the wild type strain to the initial time culture conditions for the other screenings carried out and described in Example 4 (T=T0). Said screening was carried out by measuring the ratios between the level of expression of each gene in the strain having a deletion of the TUP1 gene with respect to the level of expression of the same gene in the strain not having a deletion (wild type stain). These data are thus expressed with respect to the same reference measurement as those describing the kinetics during glucose privation (see Example 4), said reference corresponding to the initial time for other screenings carried out and described in Example 4 (T=T0).

To show the capacity of the method to select in a pertinent manner target molecules on which a biological or pharmacological action can make the biological system under study evolve towards a given state, the dynamic graph obtained by carrying out steps A and B was thus used to ask the following question: “Where should the network of 133 molecules be acted upon to cause this network to evolve towards a state which is as close as possible to the state described by expression screening of the strain having a deletion of the TUP1 gene?”. This question is of exactly the same type as those posed in the description for implementation of the method with a view to selecting therapeutic targets.

Provided that the yeast strain having a deletion of the TUP1 gene does not initially differ from the “wild type” strain except in this deletion, the “state to be modified” of the graph has thus been defined as being the reference state of the wild type strain cultivated in the presence of glucose, i.e. its state at the initial time of the other screenings carried out, described in Example 4 (T=T0) and the results of which for 130 molecules of the network (other than glucose, glutamate and acetate) are available at Stanford University's internet site at: http://cmgm.stanford.edu/pbrown/explore/array.txt.

The messenger RNA expression screening data corresponding to this state were thus those for the initial time used to construct the dynamic graph. These data allowed a numerical definition of the state to be modified to be defined: a numerical value of the expression ratio is associated with each molecule of the network; concerning the three metabolites glucose, glutamate and acetate, their value in the state to be modified was also their value at time 0, as described above. This definition of the state to be modified is given here by way of example. Another state to be modified could have been defined by the skilled person in the light of the invention for other applications.

Step D was carried out as follows:

This step consists of carrying out iterative simulations as described in the invention.

The question which the simulations had to answer was: “Where should the network of 133 molecules be acted upon to cause this network to evolve towards a state as close as possible to the state described by the expression screening of the strain having a deletion of the TUP1 gene?”.

The yeast strain having a deletion of the TUP1 gene initially only differs from the “wild type” gene in this deletion. Since this deletion amounts to a constant inhibition of the expression of the TUP1 gene, the simulations consisted of simulating, in an iterative manner, constant inhibition of each of the 133 molecules of the network, and carrying out a propagation through time computation of this inhibition in the network. For each simulation, a single molecule of the network was inhibited, since the state to be achieved corresponds to an evolution of the modeled biological system (yeast strain) following a single inhibition (deletion of TUP1 gene). Thus, 133 simulations were carried out.

According to the author's notes, the experimental data from the article and the messenger RNA expression screening data concerning the strain having a deletion of the TUP1 gene (accessible at Stanford University's internet site at: http://cmgm.stanford.edu/pbrown/explore/tupsearch.html), deletion of the gene was incomplete in this biological experiment, the ratio: [level of expression of TUP1 gene in deleted strain]/[level of expression of TUP1 gene in wild type strain] being 0.1 in one measurement and 0.45 during a repeat of the measurement (mean: 0.28). In the case of complete deletion, this ratio should in theory have been equal to 0, and in practice to the experimental noise of the measurement.

To carry out the simulations to be able to reproduce a deletion type inhibition, a numerical inhibition was thus defined for each molecule of the graph such as multiplication by a factor of 0.1 of the expression level of this molecule at the initial time (state to be modified as defined above), this factor corresponding to the highest inhibition value measured experimentally for said gene.

Thus, for each of the 133 simulations carried out, the simulation consisted of imposing a constant value Xᵢ through time such that Xᵢ=[0.1·Xᵢ₀] to a single molecule i of the graph (Xᵢ₀=value of expression (ratio) of molecule i at initial experimental time T=T0), the values of Xᵢ of other molecules being initially fixed at their value in the state to be modified defined above, and free to evolve in the dynamic graph as a function of the propagation computations. For each of the 133 simulations, the molecule i was different: the effect of each inhibition of a factor of 0.1 on each molecule of the graph was tested in a systematic manner.

In this example, the inhibition was imposed as a constant through time during simulations: hence, during the propagation computations, a possible back propagation on inhibited molecule i (feedback) was without effect on this inhibition (Xᵢ remaining stable at its initial simulation value). This was carried out to reproduce the effect of gene deletion, which is itself constant through time. This is, however, not a pre-requisite for the invention. In the implementation of the invention for other applications, the skilled person may decide to simulate non constant activations or inhibitions through time, or at different times.

The propagation computation in the graph following each of 133 inhibitions was continued for a simulated time period of 12 hours.

Once these elements were positioned, step D was carried out as described in the invention, without any special features, and without presenting any particular difficulty to the skilled person. The simulation computations, consisting of propagating the initial inhibition through time, were carried out using the same principles and the same tools as the simulations forming part of the procedure for computing parameters.

Each of the 133 simulations of step D had then resulted, at a time of 12 hours (duration of simulated propagation), in computation of a new numerical value associated with each molecule of the network, defining a graph state: “state obtained by simulation”. Thus, 133 different “states obtained by simulation” were obtained.

Step E was carried out as follows:

This step consisted of hierarchizing the molecules of the graph, and the effects exerted on said molecules during simulations, with reference to the magnitude of the proximity of the resultant of these effects with a graph state to be achieved.

In this example, the state to be achieved was the state of the yeast strain having a deletion of the TUP1 gene described above.

These messenger RNA expression screening data under conditions of deletion of the TUP1 gene are available at Stanford University's internet site at: http://cmgm.stanford.edu/pbrown/explore/tupsearch.html). They were captured manually for each molecule of the graph by a request concerning the ORF of each molecule at this address and inserted into a txt type spreadsheet in the following form (for example for the CIT1 gene):

TABLE 13
Example of DNA array screening datum for a graph molecule
under TUP1 gene deletion conditions, from the results in the
following article: DeRisi J L, Iyer V R, Brown P O: Exploring
the metabolic and genetic control of gene expression on a
genomic scale, Science 1997, Oct 24; 278 (5338): 680-6.
For each molecule i, the experimentally measured value of
X_{i corresponds to the column “Avg. R/G” in the}
experimental data accessible on internet site:
http://cmgm.stanford.edu/pbrown/expore/tupsearch.html.

| ORF | NAME | VALUE |
|---|---|---|
| YNR001C | CIT1 | 0.85 |

The value of Xᵢ corresponding to glucose for the strain having a deletion of the TUP1 gene was fixed at I since screening was carried out on a culture in the presence of glucose. The values of Xᵢ corresponding to glutamate and acetate for the strain having the deletion of the TUP1 gene were fixed at I since screening was carried out on a strain in a culture medium identical to that of the wild type strain at time 0 (between the two cultures, the ratios of the metabolites in the culture medium were thus equal to 1).

TABLE 14
Complete list of values of state to be achieved as defined above

| ORF | NAME | VALUE | ORF | NAME | VALUE | ORF | NAME | VALUE |
|---|---|---|---|---|---|---|---|---|
| ORF | NOM | Valeur | ORF | NOM | Valeur | ORF | NOM | Valeur |
| YKL106W | AAT1 | 0.64 | YDL021W | GPM2 | 0.99 | YCR012W | PGK1 | 1.74 |
| YKL112W | ABF1 | 0.87 | YGR032W | GSC2 | 1.69 | YKL127W | PGM1 | 1.19 |
| YBL015W | ACH1 | 0.85 | YFR015C | GSY1 | 4.26 | YMR105C | PGM2 | 0.54 |
| YLR304C | ACO1 | 1.26 | YLR258W | GSY2 | 1.02 | YER003C | PMI40 | 0.92 |
| YAL054C | ACS1 | 0.84 | YHL032C | GUT1 | 1.06 | YDL055C | PSA1 | 1.24 |
| YLR153C | ACS2 | 1.28 | YBL021C | HAP3 | 0.65 | YGL062W | PYC1 | 0.74 |
| YOL086C | ADH1 | 0.97 | YKL109W | HAP4 | 1.37 | YBR218C | PYC2 | 1.25 |
| YMR303C | ADH2 | 1.48 | YDR138W | HPR1 | 0.60 | YAL038W | PYK1 | 1.74 |
| YBR145W | ADH5 | 0.89 | YFR053C | HXK1 | 1.13 | YOR347C | PYK2 | 1.25 |
| YDR216W | ADR1 | 1.55 | YGL253W | HXK2 | 2.00 | YNL216W | RAP1 | 1.00 |
| YMR170C | ALD2 | 0.61 | YER065C | ICL1 | 0.96 | YCR036W | RBK1 | 1.00 |
| YMR169C | ALD3 | 0.69 | YNL037C | IDH1 | 0.74 | YBL082C | RHK1 | 1.17 |
| YPL061W | ALD6 | 1.69 | YOR136W | IDH2 | 0.80 | YOR095C | RKI1 | 1.22 |
| YPR026W | ATH1 | 1.23 | YDL066W | IDP1 | 0.75 | YJL121C | RPE1 | 1.21 |
| YDR423C | CAD1 | 1.08 | YLR174W | IDP2 | 0.75 | YOL067C | RTG1 | 0.84 |
| YMR280C | CAT8 | 0.79 | YJR094C | IME1 | 1.14 | YGL252C | RTG2 | 0.76 |
| YAL021C | CCR4 | 0.92 | YJL106W | IME2 | 1.44 | YBL103C | RTG3 | 0.71 |
| YNR001C | CIT1 | 0.85 | YIL125W | KGD1 | 0.99 | YKL148C | SDH1 | 0.81 |
| YCR005C | CIT2 | 0.93 | YDR148C | KGD2 | 0.86 | YLL041C | SDH2 | 0.70 |
| YML054C | CYB2 | 0.70 | YFL018C | LPD1 | 0.90 | YKL141W | SDH3 | 1.12 |
| YIR031C | DAL7 | 0.86 | YGR244C | LSC2 | 1.73 | YDR178W | SDH4 | 1.10 |
| YDL174C | DLD1 | 0.68 | YBR299W | MAL32 | 7.23 | YFL045C | SEC53 | 1.69 |
| YGR254W | ENO1 | 1.77 | YKL085W | MDH1 | 0.85 | YDL168W | SFA1 | 0.76 |
| YHR174W | ENO2 | 1.61 | YOL126C | MDH2 | 0.95 | YOL004W | SIN3 | 1.05 |
| YDR261C | EXG2 | 1.29 | YDL078C | MDH3 | 0.92 | YDR477W | SNF1 | 1.41 |
| YKL060C | FBA1 | 1.47 | YGL035C | MIG1 | 0.95 | YOR290C | SNF2 | 0.82 |
| YLR377C | FBP1 | 1.13 | YGL209W | MIG2 | 1.33 | YDL194W | SNF3 | 0.71 |
| YJL155C | FBP26 | 1.47 | YER028C | MIG3 | 0.90 | YCR073W-A | Sol2 | 0.79 |
| YPL262W | FUM1 | 0.79 | YNL117W | MLS1 | 0.68 | YBR112C | SSN6 | 0.93 |
| YBR020W | GAL1 | 1.14 | YMR037C | MSN2 | 0.44 | YIL162W | SUC2 | 8.71 |
| YBR019C | GAL10 | 0.63 | YKL062W | MSN4 | 3.66 | YPL016W | SWI1 | 1.04 |
| YPL248C | GAL4 | 0.75 | YDR001C | NTH1 | 0.83 | YJL052W | TDH1 | 1.91 |
| YBR018C | GAL7 | 0.67 | YBR001C | NTH2 | 0.87 | YJR009C | TDH2 | 1.72 |
| YPL075W | GCR1 | 1.02 | YKR097W | PCK1 | 1.15 | YGR192C | TDH3 | 1.64 |
| YMR189W | GCV2 | 0.97 | YER178W | PDA1 | 1.35 | YBR117C | TKL2 | 1.32 |
| YEL011W | GLC3 | 1.10 | YNL071W | PDA2 | 0.92 | YDR050C | TPI1 | 1.32 |
| YCL040W | GLK1 | 0.83 | YBR221C | PDB1 | 1.04 | YBR126C | TPS1 | 0.61 |
| YDR272W | GLO2 | 0.81 | YLR044C | PDC1 | 1.19 | YDR074W | TPS2 | 0.72 |
| YGR256W | GND2 | 1.01 | YLR134W | PDC5 | 1.55 | YML100W | TSL1 | 0.34 |
| YPR160W | GPH1 | 1.11 | YGR087C | PDC6 | 1.13 | YCR084C | TUP1 | 0.1 |
| YKL152C | GPM1 | 1.34 | YGR240C | PFK1 | 2.06 | YOR344C | TYE7 | 0.97 |
| YNL241C | ZWF1 | 0.65 | YMR205C | PFK2 | 0.67 | YKL035W | UGP1 | 2.16 |
| YIL107C | PFK26 | 1.17 | YML007W | YAP1 | 0.43 | NAME | NAME | Value |
| YBR196C | PGI1 | 2.48 | NAME | NAME | Value | Glutamate | Glutamate | 1 |
| YDR207C | UME6 | 0.99 | Glucose | Glucose | 1 | Acetate | Acetate | 1 |

The set of values thus numerically defines a “state to be achieved” graph state. Step E then consists of computing the distance between the “state to be achieved” of the graph and each of the 133 “states obtained by simulation” of the graph obtained in step D.

This distance computation was described above (proximity of graph states) and does not pose any particular difficulty to the skilled person. It consists of comparing two graph states by comparing in pairs the set of values Xᵢ associated with each molecule i of the graph.

In this example, the distance computation used was made in two steps:

Step 1 consisted of carrying out a first classification by conventional distance computations:

Distance order 1

sum of absolute values of differences between the values of Xᵢ measured experimentally during deletion of the TUP1 gene (Xᵢ₂in the formula below) and the values of Xᵢ measured by simulation (Xᵢ in the formula below)

$${\sum }_{i} \vert {X}_{i 1} - {X}_{i 2} \vert$$

Thus, 133 distance computations were obtained, each corresponding to the distance between the state obtained by simulation of a propagation of 12 hours following inhibition of one of the molecules of the graph by a factor of 0.1 and between the state to be achieved.

These 133 computed distances were then classified into an order of increasing value (from the greatest proximity with the state to be achieved towards the largest distance from the state to be achieved). This classification corresponds directly to the classification of molecules of the graph from that for which inhibition causes the graph to evolve towards a state which is closest to the state to be achieved to that for which inhibition causes the graph to evolve towards a state which is furthest from the state to be achieved: this results in a direct classification, and thus hierarchization of target molecules which act by inhibition to cause the graph to evolve towards the state it exhibits when the TUP1 gene is deleted.

Step 2 consisted, following said first classification, of refining it. Molecules which were better classified than the “output” molecules of the graph during the preceding classification (smallest distances) were classified again between them by a second, more qualitative distance computation: the difference between the “sensitivity” and “specificity” of the simulations: distance=sensitivity—specificity. This classification step is given by way of example but is not indispensable to carrying out step E.

The sensitivity and specificity of the simulations were computed as follows:

From experimental data measured during messenger RNA expression screening of the yeast strain having a deletion of the TUP1 gene, all the molecules of the graph having a variation in expression greater than a factor of 2 with respect to the reference state (wild type yeast strain at initial time T=T0in the presence of glucose), i.e. a group A of molecules, were identified.

Similarly, for each “state obtained by simulation”, all of the molecules of the graph having a variation in expression of more than a factor of 2 with respect to the reference state (wild type yeast strain at initial time T=T0in the presence of glucose) were identified, i.e. a group Bᵢof molecules. Bᵢ=group of all molecules of the graph having a variation in expression of more than a factor of 2 with respect to the reference state following simulation of inhibition of the molecule i of the graph.

The sensitivity was then defined, for each of the 133 simulations, as the number of molecules of group Bᵢeffectively present in group A. This amounted to an evaluation, for quantitatively large variations in molecule expression (by a factor of 2) as to whether the simulation effectively induced the variations present in the experimental data of the state to be achieved. The greater the value for the sensitivity, the smaller the distance between the two states of the graph which are compared.

The specificity was then defined, for each of the 133 simulations, as the number of molecules of group Bᵢabsent from group A. This amounted to an evaluation, for quantitatively large variations in molecule expression (by a factor of 2) as to whether the simulation effectively did not induce variations in expression absent from the experimental data of the state to be achieved. The lower the value for the specificity, the shorter the distance between the two states of the graph which are compared.

The sensitivity-specificity difference thus amounts to evaluating the distance in terms of the combined criteria of induction by simulation of the variations in expression present in the state to be achieved and non-induction by simulation of variations in expression absent from the state to be achieved.

These two computations (sensitivity and specificity) simply amount to a computation for each graph state of the number of variables Xᵢ for which the value is greater than 2 or less than 0.5 and does not pose any difficulties to the skilled person. They can even be made manually.

The difference between the two values, sensitivity -specificity, is also very simple and may, for example, be computed manually, or automatically using a spreadsheet Excel (Microsoft) or any other equivalent software.

Results

Results of carrying out steps A and B or step A′:

During simulations, the efficacy of the method was verified.

In the example shown here, the computation of the relative overall error of learning was 25.90%, which was satisfactory. This overall relative error result shows that the kinetics computed during simulations are close to the real data: random kinetics would have given an error computation of more than 1.

Examples of parameterization curves

FIG. 5 shows, by way of example, the kinetics measured experimentally (in white) and the kinetics computed by simulation (in black) for some molecules representative of the set of results obtained by carrying out this variation of steps A and B or of step A′.

It will be seen that this result is highly satisfactory, all the more so if the measurement errors are taken into account. The considerations of Example 4 in this regard are pertinent here in this case as well. The computations of parameters carried out in step B thus allowed a dynamic graph to be obtained which took into account the experimental data used for the computation.

Results of carrying out steps C, D and E (predictive capacity of invention):

These three steps result in a hierarchized classification of molecules by hierarchical classification of distances computed between the state to be achieved (deletion of TUP1 gene) and the 133 states obtained by simulation.

During implementation of these three simulation steps, the effectiveness of the method was verified.

The result of the first classification step is summarized by way of example in the following table, in the form of a summarizing table. Each molecule of the network is classified by the distance between the state to be achieved and the graph state obtained by simulation of the constant inhibition of this molecule by a factor of 0.1.

TABLE 16
Distances between state to be achieved of graph and graph state obtained
by simulation and constant inhibition by a factor of 0.1 of each molecule.

| | | | Classif'n |
|---|---|---|---|
| ORF code | | | of mol as |
| of | Abb'n of | | potential |
| Molecule | mol name | Distance | target |
| YCR084C | TUP1 | 50.3092 | 1 |
| YOL004W | SIN3 | 51.0063 | 2 |
| YMR170C | ALD2 | 51.1074 | 3 |
| YPL075W | GCR1 | 51.1082 | 4 |
| YKL112W | ABF1 | 51.123 | 5 |
| YAL021C | CCR4 | 51.2694 | 6 |
| YBL015W | ACH1 | 51.3413 | 7 |
| YBR221C | PDB1 | 51.3865 | 8 |
| YDR423C | CAD1 | 51.4556 | 9 |
| YDL194W | SNF3 | 51.4749 | 10 |
| YDR138W | HPR1 | 51.4885 | 11 |
| Acetate | Acetate | 51.62 | 12 |
| YML100W | TSL1 | 51.6658 | 13 |
| YKL152C | GPM1 | 51.7442 | 14 |
| YER028C | MIG3 | 51.8852 | 15 |
| YPL016W | SWI1 | 51.9315 | 16 |
| YBR019C | GAL10 | 52.0985 | 17 |
| YNL037C | IDH1 | 52.1043 | 18 |
| YNL241C | ZWF1 | 52.1554 | 19 |
| YLR174W | IDP2 | 52.1854 | 20 |
| YER003C | PMI40 | 52.2747 | 21 |
| YOR347C | PYK2 | 52.3131 | 22 |
| YLR377C | FBP1 | 52.3222 | 23 |
| YBR018C | GAL7 | 52.3309 | 24 |
| YIL125W | KGD1 | 52.4157 | 25 |
| YBR020W | GAL1 | 52.5322 | 26 |
| YMR189W | GCV2 | 52.56 | 27 |
| YPR026W | ATH1 | 52.5602 | 28 |
| YJR094C | IME1 | 52.618 | 29 |
| YHL032C | GUT1 | 52.62 | 30 |
| YCR036W | RBK1 | 52.62 | 30 |
| YBL082C | RHK1 | 52.62 | 30 |
| YJL106W | IME2 | 52.6245 | 33 |
| YGR032W | GSC2 | 52.6668 | 34 |
| YJL155C | FBP26 | 52.68 | 35 |
| YDR178W | SDH4 | 52.6912 | 36 |
| YOR136W | IDH2 | 52.7061 | 37 |
| YBR126C | TPS1 | 52.7066 | 38 |
| YNL117W | MLS1 | 52.7305 | 39 |
| YJR009C | TDH2 | 52.7425 | 40 |
| YLR304C | ACO1 | 52.7686 | 41 |
| YLR258W | GSY2 | 52.7862 | 42 |
| YJL052W | TDH1 | 52.7919 | 43 |
| YEL011W | GLC3 | 52.8148 | 44 |
| YCL040W | GLK1 | 52.8468 | 45 |
| YFR015C | GSY1 | 52.8532 | 46 |
| YDL055C | PSA1 | 52.9355 | 47 |
| YAL054C | ACS1 | 52.9521 | 48 |
| YIL162W | SUC2 | 53.0002 | 49 |
| YCR005C | CIT2 | 53.0367 | 50 |
| YFL045C | SEC53 | 53.0406 | 51 |
| YDR074W | TPS2 | 53.095 | 52 |
| YBR001C | NTH2 | 53.195 | 53 |
| YIL107C | PFK26 | 53.2135 | 54 |
| YDR272W | GLO2 | 53.226 | 55 |
| YGL209W | MIG2 | 53.2267 | 56 |
| YKR097W | PCK1 | 53.4032 | 57 |
| YER065C | ICL1 | 53.4752 | 58 |
| YGL035C | MIG1 | 53.6206 | 59 |
| YKL141W | SDH3 | 53.699 | 60 |
| YFR053C | HXK1 | 53.7431 | 61 |
| YBR299W | MAL32 | 53.9375 | 62 |
| YNR001C | CIT1 | 54.0067 | 63 |
| Glutamate | Glutamate | 54.0199 | 64 |
| YMR105C | PGM2 | 54.1341 | 65 |
| YKL109W | HAP4 | 54.604 | 66 |
| YDR148C | KGD2 | 54.6906 | 67 |
| YDL174C | DLD1 | 54.9756 | 68 |
| YDL066W | IDP1 | 55.8663 | 69 |
| YML054C | CYB2 | 56.1055 | 70 |
| YJL121C | RPE1 | 56.3212 | 71 |
| YDR477W | SNF1 | 56.5615 | 72 |
| YML007W | YAP1 | 56.6074 | 73 |
| YPR160W | GPH1 | 56.891 | 74 |
| YGR192C | TDH3 | 57.8555 | 75 |
| YGR244C | LSC2 | 59.3904 | 76 |
| YKL148C | SDH1 | 59.6111 | 77 |
| YOR095C | RKI1 | 60.0122 | 78 |
| YKL085W | MDH1 | 60.3188 | 79 |
| YDR261C | EXG2 | 61.7682 | 80 |
| YCR073W | Sol2 | 62.4253 | 81 |
| YLL041C | SDH2 | 65.1279 | 82 |
| YFL018C | LPD1 | 65.5293 | 83 |
| YDL168W | SFA1 | 67.3791 | 84 |
| YPL248C | GAL4 | 69.0277 | 85 |
| YDR001C | NTH1 | 70.6656 | 86 |
| YKL035W | UGP1 | 70.7331 | 87 |
| YDR216W | ADR1 | 71.6661 | 88 |
| YOR290C | SNF2 | 75.3998 | 89 |
| YOR344C | TYE7 | 75.558 | 90 |
| YMR303C | ADH2 | 76.3043 | 91 |
| YKL127W | PGM1 | 76.3669 | 92 |
| YGR240C | PFK1 | 80.7948 | 93 |
| YMR205C | PFK2 | 80.8638 | 94 |
| YKL062W | MSN4 | 80.9234 | 95 |
| YBR112C | SSN6 | 81.0249 | 96 |
| YOL126C | MDH2 | 81.3972 | 97 |
| YGL253W | HXK2 | 81.4105 | 98 |
| YDR207C | UME6 | 81.7283 | 99 |
| YBR117C | TKL2 | 81.8707 | 100 |
| YDR050C | TPI1 | 81.9934 | 101 |
| YGR256W | GND2 | 82.2732 | 102 |
| YKL060C | FBA1 | 82.6368 | 103 |
| YCR012W | PGK1 | 82.914 | 104 |
| YPL262W | FUM1 | 84.2271 | 105 |
| YNL216W | RAP1 | 88.1744 | 106 |
| YER178W | PDA1 | 93.9945 | 107 |
| YPL061W | ALD6 | 94.028 | 108 |
| YIR031C | DAL7 | 95.3142 | 109 |
| YBR145W | ADH5 | 96.306 | 110 |
| YGL062W | PYC1 | 96.4488 | 111 |
| YMR169C | ALD3 | 96.6949 | 112 |
| YAL038W | PYK1 | 96.757 | 113 |
| YOL086C | ADH1 | 96.8929 | 114 |
| YLR134W | PDC5 | 97.253 | 115 |
| YLR044C | PDC1 | 97.4796 | 116 |
| YBL103C | RTG3 | 97.6865 | 117 |
| YLR153C | ACS2 | 98.144 | 118 |
| YGR087C | PDC6 | 99.9862 | 119 |
| YKL106W | AAT1 | 99.9904 | 120 |
| YGR254W | ENO1 | 100.173 | 121 |
| YOL067C | RTG1 | 100.764 | 122 |
| YGL252C | RTG2 | 100.985 | 123 |
| YBR218C | PYC2 | 101.788 | 124 |
| YHR174W | ENO2 | 103.602 | 125 |
| YBL021C | HAP3 | 104.029 | 126 |
| YNL071W | PDA2 | 105.661 | 127 |
| YDL078C | MDH3 | 106.786 | 128 |
| YDL021W | GPM2 | 107.919 | 129 |
| YMR280C | CAT8 | 114.496 | 130 |
| YMR037C | MSN2 | 136.244 | 131 |
| Glucose | Glucose | 148.301 | 132 |
| YBR196C | PGI1 | 149.879 | 133 |

Classification in increasing order of distances directly produced the classification of molecules from that for which inhibition is the most susceptible of provoking the state to be achieved of the graph to that for which inhibition is the least susceptible of provoking it. It will be seen that the TUP1 molecule is classified in first position, which is the expected result. The method is thus validated.

FIG. 6 gives, by way of example, a diagrammatic representation of this result of classification of the molecules of a network. Each point corresponds to one molecule of the network. The ordinates correspond to computed distance values. Along the abscissa, the 133 molecules of the network are classified from left to right from that associated with the shortest distance to that associated with the longest distance.

It is clear that a classification of the molecules of the graph has been obtained directly. This is of the same nature and was obtained using the same methods as that which would be obtained in an application of the invention to the search for therapeutic targets.

In this classification, the TUP1 molecule was classified into first position. This result is entirely satisfactory. As an example, the experimental test of the 5 first molecules as classified here would thus give a 100% degree of success for selection of the pertinent molecule.

This classification also demonstrates the advantage of being able to define a “limitation” of the set of selected target molecules. In fact, certain molecules of the graph do not send any interaction towards another molecule (these are thus the “outputs” of the graph: “output molecules” in the remainder of the text); simulation of the inhibition of these molecules thus does not cause propagation of the inhibition in the graph, which thus remains stable overall (since the initial state was considered to be stable). For this reason, these molecules were classified elsewhere into a contiguous group, from the 27^{th} position to the 30^{th} position. Molecules with a poorer classification than the output molecules are thus of no interest as target molecules.

In other words, the classification may be interpreted as follows: the molecule which is best placed is that for which the inhibition simulation results in the graph state which is closest to the state to be achieved. For the subsequent molecules, we progressively draw away from the state to be achieved, directing ourselves towards the state to be modified which is achieved when arriving at the output molecules (this state not being modified during simulation of the inhibition of output molecules, except for the output molecule). Beyond the output molecules, the inhibition simulations result in graph states which progressively distance themselves both from the state to be achieved and from the state to be modified.

This led to the selection of a limited number of target molecules (those which were better classified than the outputs, in this case 26 molecules) which are themselves hierarchized as regards priority. This classification of the TUP1 molecule shows that this hierarchization is satisfactory.

Step 2 of the classification (sensitivity-specificity computation), although not indispensable having regard to the preceding result, was then carried out to improve the classification of the targets. It was only applied to molecules of the graph which were better classified than the output molecules in the preceding. step (26 molecules). The classification obtained is shown in Table 17.

TABLE 17
Final hierarchy of selected target molecules (the 26 molecules before
the outputs)
Step E: Second type of classification of molecules: qualitative
classification
Difference: [sensitivity − specificity]

| ORF code | Abbreviation | Sensitivity − specificity |
|---|---|---|
| YCR084C | TUP1 | 1 |
| Acetate | Acetate | 0 |
| YOL004W | SIN3 | 0 |
| YAL021C | CCR4 | 0 |
| YPL075W | GCR1 | 0 |
| YDR138W | HPR1 | 0 |
| YER028C | MIG3 | 0 |
| YDR423C | CAD1 | 0 |
| YML100W | TSL1 | 0 |
| YMR170C | ALD2 | −1 |
| YLR174W | IDP2 | −1 |
| YNL037C | IDH1 | −1 |
| YBR221C | PDB1 | −1 |
| YLR377C | FBP1 | −1 |
| YDL194W | SNF3 | −1 |
| YIL125W | KGD1 | −1 |
| YPL016W | SWI1 | −1 |
| YBR019C | GAL10 | −1 |
| YBR020W | GAL1 | −1 |
| YNL241C | ZWF1 | −1 |
| YBR018C | GAL7 | −1 |
| YKL112W | ABF1 | −2 |
| YBL015W | ACH1 | −2 |
| YER003C | PMI40 | −2 |
| YKL152C | GPM1 | −3 |
| YOR347C | PYK2 | −5 |

The molecules were classified in decreasing order of the arithmetical difference (sensitivity − specificity]. It can be seen that TUP1 is the only molecule of the graph for which the sensitivity is greater than the specificity. This separates it from the others on qualitative criteria. Here again, TUP1 is in the first position in the hierarchy of potential targets.

The target molecule TUP1 is classified into the first position. This is the molecule of the graph the inhibition of which by gene deletion induces the evolution of the biological system being studied towards the state to be achieved. The efficacy of the method is thus verified: selection of a restricted number of target molecules and pertinence of the hierarchical classification of said targets.

The series of steps A and B, or A′, then C, D and E was implemented more than ten times and systematically produced similar results each time (with the classification of TUP1 always in the first 5 molecules using the first classification mode). This shows without ambiguity the reproducibility of the method and its efficacy.

If the molecules were classified in a random manner, the probability of classifying the molecule TUP1 into the first position would only be 0.0075 (=1/133), and the probability of repeating this classification 10 times of the order of 5×10⁻³²(=0.0075¹⁰). Clearly, the result obtained in this example was not random and is extremely significant.

This shows the capacity of the method to predict the target which has to acted upon, and the type of action (in this case inhibition) to achieve a given state, i.e. the capacity of the method to identify/select/classify therapeutic targets.

1. A method for producing a dynamic model of a molecular interaction network in a biological system, allowing analysis of said network of interactions when a stimulus is applied to the dynamic model, in order to hierarchize biological molecules or select therapeutic targets in respect of a given biological problem, in particular to define- a therapeutic action to be applied to said molecules, said method being implemented by an informatics system and comprising the following steps:
A) from a static graph the vertices of which represent biological molecules and the arcs of which represent physico-chemical interactions existing between said molecules, associating an experimentally measured quantitative variable Xᵢ with each vertex i, and a mathematical relationship with each arc of the graph, each of said relationships having the following characteristics:
it comprises an inertial term (i) which tends towards a finite limit;
it comprises a term (ii) tending to cause the variables Xᵢ to return to their initial state, of opposite sign to the inertial term (i), and for which the variation as a fimction of time increases in absolute value more slowly than the variation as a ftnction of time of the inertial term (i);
it comprises a weighting factor wᵢⱼ which can take account of the combination of effects which may be exerted on each vertex of the graph;
B) computing the parameters of each relationship from quantitative experimental data concerning the vertices of the graph, by carrying out gradient descent learning techniques used for network parameterization.

2. A method for obtaining a dynamic model of a molecular interaction network in a biological system according to claim 1, in which the mathematical relationships associated with the arcs are continuous.

3. A method for obtaining a dynamic model of a molecular interaction network in a biological system according to claim 1, in which each quantitative variable Xᵢ associated with a vertex represents the relative variation in the quantity of the molecule corresponding to said vertex with respect to the quantity of the same molecule in a standard state of the biological system.

4. A method for obtaining a dynamic model of a molecular interaction network in a biological system according to, in which the inertial term (i) is expressed in the form of a mathematical relationship having one or more inflections.

5. A method for obtaining a dynamic model of a molecular interaction network in a biological system according to claim 4, in which the inertial term (i) is expressed in the form of a sigmoid relationship or an oscillation relationship.

6. A method for obtaining a dynamic model of a molecular interaction network in a biological system according to, in which step B) is carried out by simple gradient descent, taking as the computation basis pairs of data (Xᵢ, Xⱼ) provided by the experimental data, independent of each other, or by gradient descent through time, the pairs (Xᵢ, Xⱼ) then not being considered to be independent of each other.

7. A method for obtaining a dynamic model of a molecular interaction network in a biological system according to, in which the quantitative experimental data concerning the graph vertices are obtained by using large scale screening techniques.

8. A method for obtaining a dynamic model of a molecular interaction network in a biological system according to, in which the standard state is a stable state of the biological system, in which the quantity of each molecule associated with a graph vertex is measured experimentally.

9. A method for analyzing a molecular interaction network in a biological system by implementing an informatics system, comprising the following steps:
A′) using a dynamic model of a molecular interaction network, said model being constructed from a static graph the vertices of which represent biological molecules of the biological system and the edges of which represent physico-chemical interactions between said molecules, and from experimental data concerning the amounts or activities of said biological molecules and susceptible of being obtained by a method according to
C) a graph state, measured experimentally, is selected as the “state to be modified” and the duration of the biological process to be stimulated is defined and cut into a series of time steps;
D) a plurality of iterative simulation procedures are carried out, each comprising the following steps:
a) a stimulus is imposed on the state to be modified, i.e. the value of one or more quantitative variables associated with the vertices of the graph is modified, thus constituting a starting state for the simulation;
b) from the starting state of the simulation, a propagation computation is carried out within the graph.

10. A method for selecting therapeutic targets employing a dynamic model of a molecular interaction network in a biological system, by implementing an informatics system, comprising the following steps and characteristics:
A′) using a dynamic model of a molecular interaction network, said model being constructed from a static graph the vertices of which represent biological molecules of a biological system and the edges of which represent physico-chemical interactions between said molecules, and from experimental data concerning the amounts or activities of said biological molecules and susceptible of being obtained by a method according to claim 1;
C) a graph state, measured experimentally, is selected as the “state to be modified” and the duration of the biological process to be simulated is defined and cut into a series of time steps, and a graph state corresponding to a “state to be achieved” of the biological system is selected as the “final graph state” to be achieved;
D) a plurality of iterative simulation methods are carried out, each comprising the following steps:
a) a stimulus is imposed on the state to be modified, i.e. the value of one or more of the quantitative variables associated with the vertices of the graph is modified, thus constituting a starting state for the simulation;
b) from the starting state for the simulation, a propagation computation is carried out within the graph;
c) a computation of the proximity between the “final graph state” obtained after step
b) and the state to be modified, or between the “final graph state” and a desired state is carried out;
E) from the set of statistical proximities computed in step D), the vertices and the stimuli imposed on said vertices are hierarchized, the hierarchized vertices corresponding to classified therapeutic targets.

11. A method according to claim 9 or claim 10, in which the mathematical relationships associated with the arcs of the graph in step A′) are continuous.

12. A method according to claim 9 or claim 10, in which the propagation computation carried out in step D)b) is carried out over a number of time steps such that the duration of the simulation does not exceed the duration of the biological process to be simulated defined in step C).

13. A method according to claim 9 or claim 10 in which the time steps defined in step C) are an order of magnitude lower than that of the real experimental durations separating the quantitative experimental data series used to compute the parameters of the relationships, at step B) of a method according to claim 1.

14. A method for selecting therapeutic targets according to claim 10, in which the stimuli imposed in step D)a) concern, for each of the simulations, a single vertex, and in which the result of step E) is a classification of vertices from that on which a stimulus is the most susceptible of producing the desired state to that on which a stimulus is least susceptible of having said effect.

15. A method for selecting therapeutic targets according to claim 10, comprising the following steps:
a first hierarchical classification of vertices is obtained by carrying out steps A′), C), D) and E) by imposing, for each of the simulations of step D), stimuli which concern a single vertex;
a supplemental step D2) is then carried out, corresponding to step D) in which the stimuli imposed at each simulation are exerted on two vertices, either by testing all possible combinations of two vertices, or by limiting said computations to combinations of two vertices from a certain number of vertices which are the best classified in step E);
from the set of statistical proximities computed in step D2), a supplemental step E2) for hierarchical classification of associations of two vertices on which the stimuli are the most susceptible of having the desired effect is carried out.

16. A method for selecting therapeutic targets according to claim 15, further comprising a step D3) corresponding to step D) in which the stimuli imposed at each simulation are exerted on three vertices, either by testing all possible combinations of three vertices, or by limiting said computations to combinations of three vertices selected from a certain number of vertices which are the best classified in step E) and combinations of two vertices which are the best classified in step E2), said step D3) being followed by a step E3) for hierarchical classification of associations of three vertices on which the stimuli are the most susceptible of having the desired effect.

17. A method for selecting therapeutic targets according to claim 16, further comprising a step D4) corresponding to step D) in which the stimuli imposed at each simulation are exerted on four vertices, either by testing all combinations of four possible vertices, or by limiting said computations to combinations of four vertices selected from a certain number of vertices which are the best classified in steps E), E2) and E3), said step D4) being followed by a step E4) for hierarchical classification of associations of four vertices on which stimuli are the most susceptible of having the desired effect.

18. A method for selecting therapeutic targets according to claim 17, in which steps D) and E) are repeated in an iterative manner by increasing the number of vertices on which the imposed stimuli are exerted for the simulations.

19. A method for selecting therapeutic targets according to claim 10 in which, for simulations involving stimuli on several vertices, the stimuli are exerted on said different vertices simultaneously or otherwise.

20. A method for selecting therapeutic targets according to claim 15, further comprising a step for statistical classification of the proximities of graphs of all the simulations carried out, integrating the set of classifications obtained previously.

21. A method according to claim 9 or claim 10, in which step A′) substantially corresponds to steps A) and/or B) of claim 1.

22. A method according to claim 1, in which for at least part of the physico-chemical interactions between the molecules of the biological system, the relationship between variables Xᵢ and Xⱼ, taken in pairs, is of the form:
w_{ij·X}ⱼ=mᵢ·(d²Xi/dt²)+2·Σᵢⱼ·(dXᵢ/dt)+ᵢⱼ²·Xᵢⱼ, in which:
mᵢ·(d²Xi/dt²)+ωᵢⱼ²·Xᵢ correspond to the inertial term (i);
2·λᵢⱼ19 (dXᵢ/dt) corresponds to the return to the initial state term (ii);
Xᵢ is a variable associated with the molecule i;
dXᵢ/dt is the derivative of Xᵢ as a finction of time;
d²Xi/dt² is the second derivative of Xᵢ as a function of time;
Xⱼ is a variable associated with molecule j;
mᵢ represents the inertia of i;
λᵢⱼ governs the return to the equilibrium state of Xᵢ;
the frequency ωᵢⱼ corresponds to the response time of Xᵢ to the variation in Xⱼ; and
wᵢⱼ is a coupling factor representing the interaction force between molecules i and j, corresponding to a weighting of the effect of each molecule j on the molecule i as regards the resultant of the set of combined effects of all molecules j exerting an effect on i.

23. A method according to claim 1, in which for at least a portion of the physico-chemical interactions between the molecules of the biological system, the relationship between the variables Xᵢ and Xⱼ taken in pairs is established by a sigmoid relationship comprising a retarding factor associated with a linear decreasing function.

24. A method according to claim 23, in which for at least a portion of the physico-chemical interactions between the molecules of the biological system, the relationship between the variables Xᵢ and Xⱼ is of the form:
(dXᵢ/dt) =Kₗᵢ·[1/(1+e^{Σwij·Xj-bi})]−K₂ᵢ·Xᵢ, in which:
the sigmoid term K₁j·[1/(1+e^{-Σwij·Xj-bi})] corresponds to the inertial term (i); and
the term K₂ᵢ·Xᵢ corresponds to the return to the initial state term (ii); in which:
Xᵢ=variable associated with vertex i;
Xⱼ=variable associated with vertex j; wᵢⱼ=coupling factor representing the interaction force between the molecules i and j, corresponding to a weighting of the effect of each molecule j on molecule i as regards the resultant of the set of the combined effects of all molecules j exerting an effect on i;
bi=retardation factor;
Kₗᵢ=factor limiting the maximum variation of Xᵢ; and
K₂ᵢ=return to equilibrium factor.

25. A method according to claim 1, in which for at least a part of the physico-chemical interactions between the molecules of the biological system, the relationship between the variables Xᵢ and Xⱼ is a polynomial function of the type:
wᵢⱼXⱼ=Σb_{(p-1)i·}Xᵢ^{p-1}+. . . +b_{3i·}Xᵢ³+b_{2i·}Xᵢ²+b_{1i·}Xᵢ+b₀ᵢ
[m:1→p−1] with an order strictly lower than the number p of pairs (Xᵢₜ, Xⱼₜ) of experimental values for the amount or activity Xᵢ or Xⱼ of molecules i and j respectively, at different times t, the parameters bmi being computed from p available experimental pairs (Xᵢₜ, Xⱼₜ), and wᵢⱼ being a coupling factor representing the force of the interaction between molecules i and j, corresponding to a weighting of the effect of each molecule j on molecule i as regards the resultant of the set of the combined effects of all molecules j exerting an effect on i.

26. A method according to claim 1,in which for at least a portion of the physico-chemical interactions between the molecules of the biological system, the relationship between the variables Xᵢ and Xⱼ is of the polynomial derivative type:
$${w}_{ij} {X}_{j} = Σ {a}_{mij} \cdot [ {ⅆ}^{m} {X}_{i} / ⅆ {t}^{m} ] \\ [ m \text{:} 0 -> {p}^{′} - 1 ]$$
in which 1 <p′<p-1, p being the number of available experimental pairs (Xᵢₜ, xᵢₜ).

27. A method according to claim 26, in which p′=3.

28. A method according to claim 1, in which for at least a portion of the molecules of the biological system, the overall resultant of n interactions exerted by molecules 1 to n on a molecule i is a weighted sum of the actions of molecules 1 to n on molecule i, of the form:
$${F}_{G} ( Σ j -> i ) = Σ {a}_{ij} \cdot {f}_{ji} , in which \\ [ j \text{:} 1 -> n ] [ j \text{:} 1 -> n ]$$
fᵢⱼ is the relationship associated with the arc (ij) for each pair (ij); and
$${a}_{ij} = ( ⅆ {X}_{j} / ⅆ t ) / Σ ( ⅆ {X}_{j} / ⅆ t ) \\ [ j \text{:} 1 -> n ] .$$

29. A method according to claim 1, in which for at least a portion of the molecules of the biological system, the overall resultant of n interactions exerted by molecules 1 to n on a molecule i is a weighted sum of the actions of molecules 1 to n on molecule i, of the form:
$${F}_{G} ( Σ j -> i ) = Σ {a}_{ij} \cdot {f}_{ji} , in which \\ [ j \text{:} 1 -> n ] [ j \text{:} 1 -> n ]$$
fᵢⱼ is the finction associated with the arc (ij) for each pair (i,j); and
$${a}_{ij} = ( {ⅆ}^{2} {X}_{j} / ⅆ {t}^{2} ) / Σ ( {ⅆ}^{2} {X}_{j} / ⅆ {t}^{2} ) \\ [ j \text{:} 1 -> n ] .$$

30. A method for determining the mode of action of a xenobiotic, consisting of carrying out a method according to claim 9 or claim 10 under the following conditions:
(i) the biological system in which the molecular interaction network is studied is affected by the action of the xenobiotic;
(ii) the “state to be modified” selected in step C) corresponds to an experimentally observed state before administration of said xenobiotic;
(iii) the modifications to be provided during step D)a) for which the computation carried out in step D)b) shows an evolution of the system towards a state close to the state observed after administration of the xenobiotic are identified.

31. A method for predicting possible undesirable effects of a treatment, consisting of carrying out a method according to claim 9 or claim 10 under the following conditions:
(i) the biological system in which the molecular interaction network is studied is affected by the treatment;
(ii) the modifications of step D)a) correspond to observed or desired modifications in the rates or activity of target molecules during application of the treatment;
(iii) step D)b) for computation of the evolution of the biological system is followed by an analysis of sub-parts of the system corresponding to known physiological functions, to identify any evolutions in these sub-parts towards states close to reference pathological states.

32. A method for hierarchization of potential therapeutic targets for a pathology, consisting of carrying out a method according to claim 9 or claim 10, then determining a “therapeutic benefit/undesirable effects” ratio of an action on each of the potential therapeutic targets.

33. A method according to claim 1, in which the number of variables Xᵢ of the molecular interaction network under consideration is more than about 100, more than about 200 or more than about 300.

34. A method according to claim 1, in which the number of variables Xᵢ of the molecular interaction network under consideration is less than about 100 and in that said molecular interaction networks are associated to form an association of networks.

35. A method according to claim 34, in which the number of associated networks is in the range 2 to about 100.

36. Use of a dynamic model of a molecular interaction network in a biological system that is susceptible of being obtained by a method according to claim 1, to extend a static graph the vertices of which represent biological molecules and the arcs of which represent physico-chemical interactions between said molecules, to identify novel molecular interactions.

37. An informatics system for producing a dynamic model of a molecular interaction network in a biological system, and analyzing said molecular interactions when a stimulus is applied to the dynamic model, comprising at least one central data processing unit connected to at least one quantitative experimental database, the informatics system comprising:
A) a module for constructing a static graph the vertices of which represent biological molecules and the arcs of which represent physico-chemical interactions existing between said molecules, each vertex being associated with an experimentally measured quantitative variable and each arc of the graph being associated with a mathematical relationship; and
B) a learning module for computing the parameters of each relationship from quantitative experimental data concerting the vertices of the graph, employing gradient descent learning techniques used for network parameterization.

38. An informatics system according to claim 37, characterized in that it also comprises:
C) a simulation module for carrying out a plurality of iterative simulation procedures consisting of imposing a stimulus on an experimentally measured graph state and selected as the “state to be modified”, the stimulus modifying the value of one or more quantitative variables associated with the vertices of the graph, constituting thereby a starting state for the simulation from which a propagation computation is carried out within the graph, to obtain a “final graph state”; and
D) an iteration module for modification of the stimulus.

39. An informatics system according to claim 38, characterized in that it also comprises:
E) a module for computing the proximity between the “final graph state” and the “state to be modified” or between the “final graph state” and a desired state, and for hierarchization of the vertices and stimuli imposed on the graph vertices, the hierarchized vertices corresponding to classified therapeutic targets.
